(19) United States
(12) Patent Application Publication
(10) Pub. No.: US 2015/0107788 A1
(43) Pub. Date: Apr. 23, 2015

(54) METHOD AND APPARATUS FOR LINKED HORIZONTAL DRAPERY PANELS HAVING VARYING CHARACTERISTICS TO BE MOVED INDEPENDENTLY BY A COMMON DRIVE SYSTEM

(71) Applicant: QMotion Incorporated, Pensacola, FL (US)

(72) Inventors: Willis Jay Mullet, Gulf Breeze, FL (US); Daniel T. Matthews, Pensacola, FL (US); Michael D. Fox, Pensacola, FL (US); Richard Scott Hand, Pace, FL (US)

(21) Appl. No.: 14/535,987

(22) Filed: Nov. 7, 2014

Related U.S. Application Data
(63) Continuation-in-part of application No. 13/842,586, filed on Mar. 15, 2013.
Application No. 13/842,586 is a continuation-in-part of application No. 14/029,210, filed on Sep. 17, 2013.
(60) Provisional application No. 61/901,985, filed on Nov. 8, 2013.
(60) Provisional application No. 61/702,093, filed on Sep. 17, 2012.
(60) Provisional application No. 61/702,093, filed on Sep. 17, 2012.

(51) Int. Cl. E06B 9/36; E06B 9/388; E06B 9/24; E06B 9/266; E06B 7/082; E06B 7/10

(52) U.S. Cl. CPC E06B 9/368; E06B 7/082; E06B 7/10; E06B 9/24; E06B 9/266; E06B 9/362; E06B 9/388
USPC 160/405; 160/7

(57) ABSTRACT

A curtain assembly comprises a rotatable drive element wherein at least one helical guide structure is formed on, or into, the outer surface of the drive element. A drive attachment element having a structure that communicates with the helical guide structure to move the drive attachment element axially along the drive element when the drive element is rotated. Specific embodiments incorporate either a manual or motor-driven rotation assembly for rotating the drive element. Further specific embodiments involve a helical guide structure that comprises a helical groove and a structure that comprises a tooth that engages with the helical groove. Further specific embodiments include a sensor, such as an accelerometer, that detects a disturbance or vibration on the drive element, such as a tug, slide or tap, and activating the motor in response to the disturbance.

### CROSS REFERENCE TO RELATED APPLICATION

This application is a non-provisional of U.S. Provisional Patent Application No. 61/901,985, entitled, Method And Apparatus For Linked Horizontal Drapery Panels Having Varying Characteristics To Be Moved Independently By A Common Drive System, filed Nov. 8, 2013. This application also is a continuation-in-part of pending U.S. patent application Ser. No. 13/842,586, entitled, Rotatable Drive Element For Moving Window Covering, filed Mar. 15, 2013, which claims priority to expired provisional application No. 61/702,093, entitled, Drapery Tube Incorporating Batteries Within The Drapery Tube, With A Stop For Facilitating The Loading And Unloading Of The Batteries, filed Sep. 17, 2012. This Application also is a continuation-in-part of U.S. patent application Ser. No. 14/029,210, entitled Rotatable Drive Element For Moving Window Covering, filed Sep. 17, 2013, which claims priority to expired provisional application No. 61/702,093, entitled, Rotatable Drive Element For Moving Window Covering, filed Sep. 17, 2012. This application claims priority to each of the above-referenced applications and the disclosures of each of the above-referenced applications are hereby incorporated by reference in their entirety.

### FIELD OF THE INVENTION

Embodiments of the present invention relate generally to a window covering assembly used to cover windows. Specific embodiments of the invention relate to a window covering assembly with a rotatable drive element that has a structure formed into or on the outer surface of the rotatable drive element such that a window covering moves axially along the rotatable drive element when the rotatable drive element rotates. Further specific embodiments relate to a window covering assembly in which two different curtains are operated by the same rotating drive element such that the user is able to independently move each curtain. Further specific embodiments relate to a rotatable drive element that is operated by a tug, slide or tap.

### BACKGROUND OF THE INVENTION

Window coverings, such as curtains, are frequently used to provide privacy and to limit the amount of light that is permitted to pass through a window and into a room.

There are numerous types of window coverings known in the art. Curtains can be composed of panel(s) of fabric. For example, a curtain may be a single panel curtain that opens and closes from left to right. There is also a center closing curtain that is composed of two fabric panels that meet in the center of the window to close and cover the window.

Many different types of fabrics may be used depending on the user's needs and preferences. For example, sometimes it is necessary not only to cover but to also fully blackout the window such that no light passes through. In this instance, a blackout curtain composed of opaque fabric that completely darkens the window may be useful. There may also be other situations, however, where some light is desired and some visibility is desired. A sheer curtain composed of a translucent fabric may be useful in this instance.

The curtain panels are attached to and suspended from a transverse curtain rod that is hung above the window. The panels are usually joined to the curtain rod by hooks or rings. The curtains are able to be moved manually across the curtain rod(s) as desired by a pull rod or the like to either cover or uncover the window.

There are various mechanisms, both electrical and manual, to mechanically move a curtain back and forth across an opening. Typical designs use a curtain guide track where the curtains are suspended. Some curtain assemblies use a series of pulleys, cables, and belts to move the curtain. In some cases these mechanisms are motorized. In these cases, the number of components used adds complexity to the assembly and also increases the cost of the assembly.

A sheer curtain is often hung with a blackout curtain on the same window to accommodate different preferences for light and visibility at different times. For example, a blackout curtain may be used to block out unwanted early morning sun. The blackout curtain may then be opened to allow the sun to filter through the sheer curtain later in the day. When a blackout curtain is hung with a sheer curtain, utility bills may also be lowered by using the different curtains to keep a home cool or warm, depending on the weather.

Hanging two different curtains, however, requires the installation of two different curtain guide tracks, one guide track for each curtain. If two curtains are hung from the same curtain guide track, there is not the ability to move one curtain without moving the other curtain and it prevents both curtains from being in the deployed position simultaneously.

U.S. Pat. No. 4,131,831 (Bochenek et al.) teaches a drapery opening and closing system for draw draperies which are movable over a traverse member between an open and closed position by use of a drapery drive system. The opening and closing system has limit switches positioned to be activated when the draperies are opened and closed. A manually settable timer connected to a power source applies power at preset times to a reversible motor via a control circuit. The control circuit is comprised of a relay activated by the timer and a series connected two-section switch. Outputs of the two-section switch are connected to the reversible motor through the limit switches. When the timer is triggered at a preset time, the draperies automatically open or closes. Via the two-section switch, the draperies may be manually activated to open or close at times other than the preset times on the timer.

U.S. Pat. No. 4,492,262 (Comeau) teaches a telescoping drapery traverse rod with a motor drive without sacrificing any of the simple consumer installation and adjustment features of conventional draw-cord operated traverse rods. It employs a positive-drive perforated-plastic tape and sprocket combination with the tape being releasably secured to the master carriers in a manner analogous to that of the conventional draw cord arrangement.

U.S. Pat. No. 4,773,464 (Kobayashi) teaches an actuator for actuating a vertical blind or curtain of electric type to be mounted on a mounting support face. The actuator is enabled to eliminate the deformations such as torsions of rotating rods thereto to ensure their rotations by driving the two ends of each of the rotating rods with the torques of a pair of motors. The tension to be applied to a traverse rod can be easily adjusted to an appropriate value by fastening a nut on a tensing threaded rod connected to the traverse rod to tense the traverse rod. Rotation transmitting unit can be held in position in a pivotal state even if the tension is applied to the traverse rod. Since the traverse rod is fitted in a bearing by the face contact between ridges and corners, moreover, the rotating torque is dispersed to enhance the breaking stress at the fitted connection.

U.S. Pat. No. 4,827,199 (Kaucic et al.) teaches a traverse rod having a reversible torque responsive motor-drive assembly for operating the traverse rod. The motor-drive assembly includes a stationary casing fixed to the rod and a movable casing mounted in the stationary casing for angular movement relative thereto about a turn axis. A reversible DC motor in the movable casing is connected through a planetary gear speed reducer to a traverse cord drive wheel for applying driving torque thereto. The movable casing is arranged to turn about the turn axis in opposition to the torque applied to the drive wheel and is yieldable urged angularly about the turn axis toward a preselected neutral position relative to the stationary casing. The motor-drive assembly has a torque responsive motor control including stationary brush contacts fixed on the stationary casing and adapted for connection to a power supply and movable electrically conductive segments fixed on the movable casing and electrically connected to the motor. The movable electrically conductive segments include primary segments arranged to engage the brush contacts when the movable casing is in the neutral position and auxiliary segments spaced angularly about the turn axis from the primary segment to engage the brush contacts when the movable casing is turned through a preselected angle in either direction from the neutral position.

U.S. Pat. No. 4,878,528 (Kobayashi) teaches an electric blind of the type, in which a traverse rod drive motor, a tilt rod drive motor and their drive transmitting means are arranged at one end side of a casing frame so that the casing frame can be easily cut at the other end side without removing those motors and the drive transmitting means to leave a new casing from of a desired length. The traverse rod and the tilt rod can be cut together with the casing frame to improve the workability of the electric blind. This blind has its slats offset from the center line of the casing frame so that a shield cover can be extended to below the casing frame to prevent the light from breaking therethrough. In this blind, moreover, the positions of the clamping portions of brackets for supporting the two sides of the casing frame can be adjusted independently of one another so that the blind can be mounted on the wall or the like without any difficulty.

U.S. Pat. No. 5,301,733 (Toti) teaches a cover system suitable for windows including a tape support for maintaining the orientation of the cover and for opening and closing the cover.

U.S. Pat. No. 5,467,808 (Bell) teaches an automatic blind or curtain suspension system comprising a blind headrail 10 or curtain pole carrying at least one suspension device 28 arranged for movement relative to the headrail 10 or pole towards and away from a stop 48 to open and close the blind or curtain. An electric motor 44a is coupled to the suspension device 28 and operable to cause it to move relative to the headrail 10 or pole. The system includes compression springs 50 adapted to take up additional drive from the motor once motion of the suspension device 28 is retarded by the stop 48. An automatic controller 12 is provided which detects a monotonic increase in current to the motor 44a associated with drive from the motor 44a being taken up by the springs 50 and interrupts current to the electric motor 44a when the increase in motor current is detected. The controller may also keep track of the position of the suspension device 28 and store its position when the increase in current is detected. Drive to the electric motor 44a during subsequent operation of the system may then be regulated in dependence upon the stored value to interrupt current to the motor before the suspension device 28 hits the stop 48 again.

U.S. Pat. No. 6,152,205 (Toti) teaches window cover systems including window cover material in the form of pleated panels or slats. The window cover material is suspended from a traverse track and is traversed along the track for opening and closing the window system. Arrangements for maintaining spacing and alignment of pleats or slats are provided. The alignment maintaining arrangements include traverse tapes which are substantially rigid in longitudinal and lateral directions in the plane of the tape, and are flexible in a direction perpendicular to the tape. The arrangements also include attaching the window cover material to vertical edge members and providing foldable spacer-members between adjacent edge-members. In one arrangement, a box-pleated panel of window cover fabric is suspended from a traverse track on slide-members. The slide-members are each attached to a spacer-tape at regular intervals along the spacer-tape. The spacer-tape is substantially rigid in the traverse direction and in a vertical direction perpendicular to the traverse direction. The window cover system is opened and closed by rolling and unrolling the panel and the spacer-tape around a roller located at one end of a window frame. Other arrangements include combined, tape-supported vertical slat blinds and vertical pleated draperies in which the tape(s) are supported by sprockets or wheels/pulleys.

U.S. Pat. No. 6,533,017 (Toti) teaches window cover systems including window cover material in the form of pleated panels or slats. The window cover material is suspended from a traverse track and is traversed along the track for opening and closing the window system. Arrangements for maintaining spacing and alignment of pleats or slats are provided. The alignment maintaining arrangements include traverse tapes which are substantially rigid in longitudinal and lateral directions in the plane of the tape, and are flexible in a direction perpendicular to the tape. The arrangements also include attaching the window cover material to vertical edge members and providing foldable spacer-members between adjacent edge-members. In one arrangement, a box-pleated panel of window cover fabric is suspended from a traverse track on slide-members. The slide-members are each attached to a spacer-tape at regular intervals along the spacer-tape. The spacer-tape is substantially rigid in the traverse direction and in a vertical direction perpendicular to the traverse direction. The window cover system is opened and closed by rolling and unrolling the panel and the spacer-tape around a roller located at one end of a window frame. Other arrangements include combined, tape-supported vertical slat blinds and vertical pleated draperies in which the tape(s) are supported by sprockets or wheels/pulleys.

U.S. Pat. No. 7,222,655 (Toti) teaches window cover systems include window cover material in the form of pleated panels or slats. The window cover material is suspended from a traverse track and is traversed along the track for opening and closing the window system. Arrangements for maintaining spacing and alignment of pleats or slats are provided. The alignment maintaining arrangements include traverse tapes which are substantially rigid in longitudinal and lateral directions in the plane of the tape, and are flexible in a direction perpendicular to the tape. The arrangements also include attaching the window cover material to vertical edge members and providing foldable spacer-members between adjacent edge-members. In one arrangement, a box-pleated panel of window cover fabric is suspended from a traverse track on slide-members. The slide-members are each attached to a spacer-tape at regular intervals along the spacer-tape. The spacer-tape is substantially rigid in the traverse direction and in a vertical direction perpendicular to the traverse direction. The window cover system is opened and closed by rolling and unrolling the panel and the spacer-tape around a roller located at one end of a window frame. Other arrangements include combined, tape-supported vertical slat blinds and vertical pleated draperies in which the tape(s) are supported by sprockets or wheels/pulleys.

Therefore, it would be advantageous to have a simple curtain assembly that will move a curtain from the deployed position to the stored position with the minimum number of components that can be motorized as well as manually operated.

### SUMMARY OF THE INVENTION

Embodiments of the present invention relate to a window covering assembly. For convenience, various embodiments will be described with respect to curtains with the understanding that the description applies to other window coverings as well. Embodiments of the curtain assembly include a drive element wherein at least one guide structure is formed on or into the outer surface of the drive element; a drive attachment element having a corresponding structure that communicates with the at least one guide structure to move the drive attachment element axially along the drive element when the drive element is rotated; and a rotation assembly for rotating the drive element. In some embodiments of the invention, the guide structure forms a helical pattern on the rotatable drive element and the corresponding structure is a tooth that is moved by the groove when the drive element is rotated. The guide structure can also be a ridge or other structure that can cause the corresponding structure to move axially along the drive element when the drive rotates.

In specific embodiments the drive element can be a tube.

In specific embodiments according to the present invention, the curtain assembly includes a rotatable drive element having a clockwise helical guide structure and a counter clockwise helical guide structure formed on, or into, the outer surface of the drive element; a first drive attachment element having a structure that communicates with the clockwise helical guide structure to move the first drive attachment element axially along the drive element when the drive element is rotated; and a second drive attachment element having a structure that communicates with the counterclockwise helical guide structure to move the second drive attachment element axially along the drive element when the drive element is rotated; and a rotation assembly for rotating the drive element.

In accordance with some embodiments of the present invention, a dual curtain assembly is provided. A specific embodiment of dual curtain assembly includes a rotatable drive element having at least one guide structure formed on, or into, the outer surface of the drive element; at least two drive attachment elements having a corresponding at least two structures that communicate with the at least one guide structure to move the at least two drive attachment elements axially along the drive element when the drive tube is rotated Further specific embodiments can also incorporate a rotation assembly for rotating the drive element. The rotation assembly can be manual or motorized.

In accordance with some embodiments of the invention, a dual curtain assembly includes a drive element having at least one guide structure formed on, or into, the outer surface of the drive element; at least one outer drive attachment element having a corresponding at least one outer structure that communicates with the at least one guide structure to move the at least one drive attachment element axially along the drive element when the drive element is rotated; at least one inner drive attachment element having a corresponding at least one feature that communicates with the at least one guide structure to move the at least one inner drive attachment element axially along the drive element when the drive element is rotated; and a rotation assembly for rotating the drive element.

In accordance with yet other embodiments of the invention, applicable, for example, to a center closing curtain system, the curtain assembly may include a drive element having at least one guide structure formed on, or into, the outer surface of the drive element; a left outer drive attachment element having a corresponding left outer structure that communicates with the at least one guide structure to move the left outer drive attachment element axially along the drive element when the drive element rotates; a right outer drive attachment element having a right outer structure that communicates with the at least one guide structure to move the right outer drive attachment element axially along the drive element when the drive element rotates; a left inner drive attachment element having a corresponding left inner structure that communicates with the at least one guide structure to move the left inner drive attachment element axially along the drive element when the drive element is rotated; a right inner drive attachment element having a corresponding right inner structure that communicates with the at least one guide structure to move the right inner drive attachment element axially along the drive element when the drive element is rotated; and a rotation assembly for rotating the drive element, wherein the rotation of the drive element moves the left and right outer drive attachment elements axially along the drive element when the drive element is rotated and independently moves the left and right inner drive attachment elements along the drive element when the drive element is rotated.

In accordance with some embodiments of the invention, a motor is positioned within a rotatable drive element that is used to drive the rotatable drive element to open and close curtains. An accelerometer or other sensor is connected to the rotatable drive element and electrically connected and senses a user generated disturbance or vibration on the rotatable drive element. The accelerometer or sensor transmits these sensed signals to a motor controller which activates or deactivates the motor in response to the sensed signals. These user generated disturbances or vibrations can be generated by a tug on a curtain or wand, a slide of idler rings over the rotatable drive element, or a tap on the rotatable drive element by a wand, ring or other device.

### BRIEF DESCRIPTION OF THE DRAWINGS

These features and aspects of the invention as well as its advantages are understood by referring to the following description, appended claims, and accompanying drawings, in which:

FIG. 1 is a perspective view of one embodiment of the curtain assembly showing a curtain in the deployed position and the window is covered.

FIG. 2 is a perspective view of one embodiment of the curtain assembly showing the curtain in the stored position and the window is not covered.

FIG. 3 is a perspective view of one embodiment of the curtain assembly showing a left hand curtain in the stored position.

FIG. 4 is an enlarged perspective view of one embodiment of the curtain assembly showing a center closing curtain in the deployed position covering the window.

FIG. 5 is an enlarged perspective view of the components of the rotatable drive element according to one embodiment of the curtain assembly in which the rotation of the drive element is powered by a battery operated motor.

FIG. 6 is an enlarged perspective view of the components of the rotatable drive element according to one embodiment of the curtain assembly in which the power supply to the motor is external to the drive element.

FIG. 7 is an enlarged perspective view of one embodiment of the curtain assembly showing the rotatable drive element with a clockwise helical groove.

FIG. 8 is an enlarged perspective view of one embodiment of the curtain assembly showing the rotatable drive element with a counter clockwise helical groove.

FIG. 9 is an enlarged perspective view of one embodiment of the curtain assembly showing the rotatable drive element with a clockwise helical groove and a counter clockwise helical groove.

FIG. 10 is an enlarged perspective view of the drive attachment element according to one embodiment.

FIG. 11 is an enlarged side view of the drive attachment element 36 showing the structure 62 as a tooth according to one embodiment.

FIG. 12 is an enlarged cross-sectional view of the drive attachment element 36 showing the angle of the drive tooth 62 according to one embodiment.

FIG. 13 is an enlarged perspective view of the drive attachment element having a first drive tooth and a second drive tooth according to one embodiment.

FIG. 14 is an enlarged side view of the drive attachment element 36 having a first drive tooth and a second drive tooth according to one embodiment.

FIG. 15 is an enlarged cross-sectional view of the drive attachment element 36 showing the angle of the second drive tooth 90 according to one embodiment.

FIG. 16 is an enlarged cross-sectional view of the drive attachment element 36 showing the angle of the first drive tooth 88 according to one embodiment.

FIG. 17 is a section view of the tube 26 and the drive attachment element 36 showing the engagement of the first drive tooth 88 in the first helical groove 38.

FIG. 18 is an enlarged end view of a motor drive adapter according to one embodiment of the curtain assembly.

FIG. 19 is an enlarged perspective view of a motor drive adapter according to one embodiment of the curtain assembly.

FIG. 20 is an enlarged perspective view of the rotatable drive element according to one embodiment.

FIG. 21 is an enlarged end view of the rotatable drive element according to one embodiment.

FIG. 22 is an enlarged perspective view of the preferred tube embodiment with the position a section was taken to reflect the two clockwise helical grooves 38 and two counter clockwise grooves 40 in the tube 26.

FIG. 23 is an end view of the drive element assembly of the preferred embodiment showing the starting points of the clockwise helical grooves 38 and the counter clockwise grooves 40.

FIG. 24 is the cross section view taken from FIG. 22.

FIG. 25 is the preferred embodiment curtain assembly.

FIG. 26 is a drawing of the functional relationship of the helical grooves 38 and 40 to the midpoint of the drive element to assure the drive attachment elements meet in the midpoint of the drive element on center close draperies.

FIG. 27 is a perspective view of one embodiment of the curtain assembly when the outer curtain is a blackout curtain in the deployed position and the inner curtain is a sheer curtain in the deployed position.

FIG. 28 is a perspective view of one embodiment of the curtain assembly when the outer curtain is a blackout curtain in the stored position and the inner curtain is a sheer curtain in the deployed position.

FIG. 29 is a perspective view of the embodiment of the curtain assembly when both the outer and inner curtains are in the stored position.

FIG. 30 is a perspective view of the preferred embodiment with the outer curtain is a blackout curtain with a portion cut away to show the position of the external battery pack from FIG. 6.

FIG. 31 is an enlarged perspective view of the components of the rotatable drive element according to one embodiment of the curtain assembly showing an internal battery power supply.

FIG. 32 is an enlarged perspective view of the components of the rotatable drive element according to one embodiment of the curtain assembly show an external power supply.

FIG. 33 is a cross-sectional view of the drive section of the rotatable drive element showing the helical groove and a non-driving groove according to one embodiment of the curtain assembly.

FIG. 34 is an enlarged perspective view of one embodiment of the curtain assembly non-driving groove.

FIG. 35 is an enlarged perspective view of one distal end of the rotatable drive element showing the inner drive attachment element and the inner driver stall area according to the same embodiment of the curtain assembly shown in FIG. 34.

FIG. 36 is an enlarged side view of the inner drive attachment element according to one embodiment of the curtain assembly.

FIG. 37 is an enlarged perspective view of the inner drive attachment element according to one embodiment of the curtain assembly.

FIG. 38 is an enlarged sectioned view of the inner drive attachment element according to one embodiment of the curtain assembly.

FIG. 39 is an enlarged side view of the inner drive attachment element according to one embodiment of the curtain assembly.

FIG. 40 is an enlarged perspective view of the inner drive attachment element according to one embodiment of the curtain assembly.

FIG. 41 is an enlarged sectioned view of the inner drive attachment element according to one embodiment of the curtain assembly.

FIG. 42 is an enlarged perspective view of an outer idler attachment element according to one embodiment of the curtain assembly.

FIG. 43 is an enlarged sectioned view of an outer idler attachment element according to one embodiment of the curtain assembly.

FIG. 44 is an enlarged side view of an outer idler attachment element according to one embodiment of the curtain assembly.

FIG. 45 is an enlarged side view of an outer drive attachment element according to one embodiment of the curtain assembly.

FIG. 46 is an enlarged sectioned view of an outer drive attachment element according to one embodiment of the curtain assembly.

FIG. 47 is an enlarged perspective view of an outer drive attachment element according to one embodiment of the curtain assembly.

FIG. 48 is an end view of the curtain assembly showing the guide track, guides, attachment elements, and the position of the inter-curtain engager.

FIG. 49 is a is a perspective view of a curtain assembly according to one embodiment when the outer curtains are center closing blackout curtains in the stored position and the inner curtains are center closing sheer curtains in the deployed position.

FIG. 50 is a perspective view of a curtain assembly according to one embodiment when the outer curtains are center closing blackout curtains in the deployed position and the inner curtains are center closing sheer curtains in the stored position.

FIG. 51 is a perspective view of the tube end with the inner driver stall area.

FIG. 52 is a top view of the curtain assembly with the guide track removed to see the position of the guides and attachment elements with the inner and outer curtains deployed and the outer drive attachment element can stop the tube from rotation when it stalls against the inner attachment element in the stall area.

FIG. 53 is a top view of the curtain assembly with the guide track removed to see the position of the guides and attachment elements with the inner curtains deployed and the inter-curtain engager is in the engage-outer-drive-attachment-element position and the inner drive attachment element is in the stall area.

FIG. 54 is a top view of the curtain assembly with the guide track removed to see the position of the guides and attachment elements with the inner and outer curtains in the stored position and the outer simple attachment elements and the outer drive attachment element are in the non-driving or stall area. The inner curtain drive attachment element can stop the tube from rotation when it contacts the outer curtain drive attachment element.

FIG. 55 is a perspective view of the area where the outer attachments are stored with the tube, inner and outer curtains removed to show the position of the inter-curtain engager and the carrier tracks.

FIG. 56 is a perspective view of the inner curtain carrier and S-hook.

FIG. 57 is a perspective view of the inner curtain carrier with the inner curtain engager.

FIG. 58 is three views of the preferred tube embodiment with an outer driver stall area and two helical grooves spaced 180 degrees apart.

FIG. 59 is another tube embodiment with four helical grooves, two are counter clockwise spaced 180 degrees apart and two are clockwise spaced 180 degrees apart.

FIG. 60 is another embodiment of a tri-lobed tube, drive element, and internal tube driver.

FIG. 61 shows four views of the inner curtain carrier and S-hook.

FIG. 62 shows four views of the inter-curtain engager.

FIGS. 63A-63L show flowcharts for the control system for specific embodiments of the invention.

FIG. 64 shows a perspective view of the drapery movement assembly in accordance with an embodiment of the invention, without the draperies.

FIG. 65 shows a front or plan view of the assembly of FIG. 64.

FIG. 66 shows an end or side view of the assembly of FIG. 64.

FIG. 67 shows an end view of the assembly of FIG. 64 with the end plate 112 removed.

FIG. 68 shows a bottom-up perspective view of the assembly of FIG. 64.

FIG. 69 shows a section view of the center mounting of the drive elements 114 and 115.

FIG. 70 shows a top view of the inner curtain driver 123 with a portion of the cover track 111 cut away showing the swivel magnet 124 and stationary magnet 135 having the same poles proximate to and repelling each other and the outer driver 121 physically separation the magnets 124 and 135.

FIG. 71 shows a top view of the inner curtain driver 123 with a portion of the cover track 111 cut away showing the inner driver 123 disengaged from the outer driver element 121 allowing the drapery to be moved by hand.

FIG. 72 shows a top view of the inner curtain driver 123 with a portion of the cover track 111 cut away showing the swivel magnet 124 and stationary magnet 135 having opposite poles proximate to and attracting each other.

FIG. 73 shows a top view of the inner curtain driver 123 with a portion of the cover track 111 cut away showing the magnets 124 and 135 no longer attached and the outer driver 121 engaged with the inner curtain driver 123.

FIG. 74 shows a top view of the inner curtain driver 123 with a larger portion of the cover track 111 cut away showing the swivel magnet 124 and stationary magnet 135 having opposite poles proximate to and attracting each other, the outer driver 121 engaged with the drapery driven hanger 117 and the inner curtain driver hanger 116.

FIG. 75 shows a section view taken from the area where the outer driver 121 is engaged with the drive element 114.

FIG. 76 shows an exploded parts view of the assembly of FIG. 64.

FIG. 77 shows an enlarged view of the center mounting components of FIG. 76.

FIG. 78 shows a front view of a curtain (drapery) system in accordance with an embodiment of the subject invention, having a baton connected in an innermost ring on each side of a center closing set-up.

FIG. 79 shows a perspective view of the embodiment of FIG. 78.

FIG. 80 shows an enlarged view of the view of FIG. 79.

FIG. 81 shows an enlarged view of the view of FIG. 80 showing a vibration sensor or accelerometer (in hidden lines) positioned within the rotatable drive element.

FIG. 82 shows an end view of inward idler attachment element 150 having a ring 154, which has a collar 156 and a drive tooth 62.

### DETAILED DESCRIPTION OF THE PREFERRED EMBODIMENT

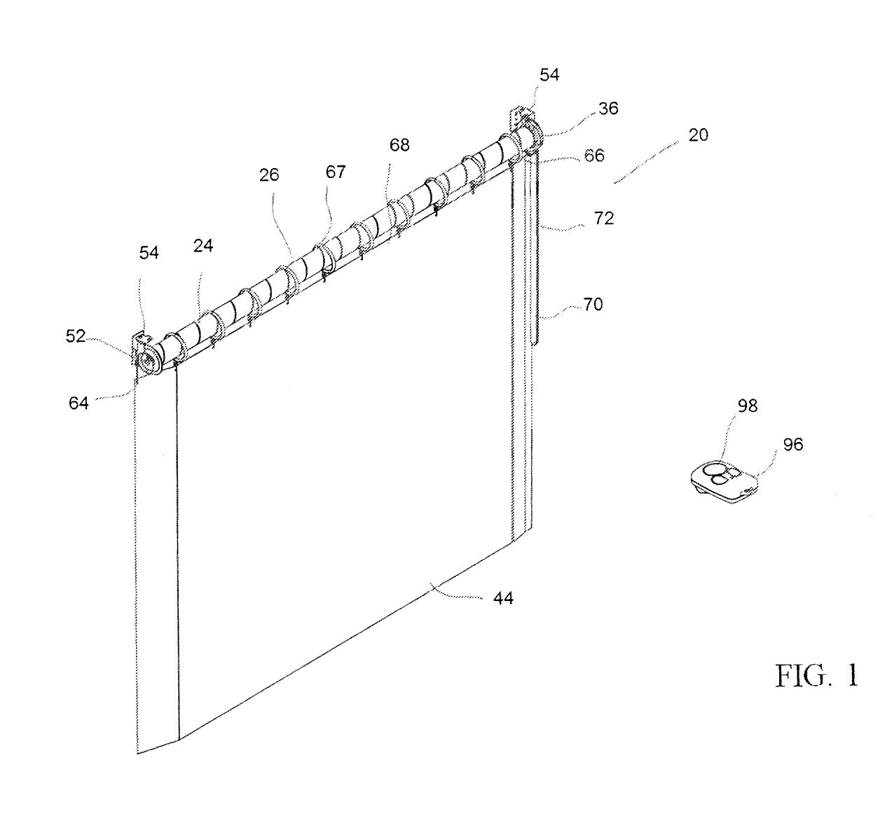

Referring to FIG. 1, a curtain assembly 20 according to one embodiment of the invention is shown. The curtain assembly 20 comprises a rotatable drive element 22 wherein a helical guide structure 24 is formed into the outer surface 26 of the drive element 22, a drive attachment element 36 having a corresponding structure 62 that communicates with the helical guide structure 24 to move the drive attachment element 36 axially along the drive element 22 when the drive element 22 is rotated and a rotation assembly 32 (not shown) for rotating the drive element 22. In some embodiments of the invention, the helical guide structure 24 is a helical groove 24 and the corresponding structure 62 is a tooth. While the helical guide structure 24 is shown in FIGS. 1-3 as a helical groove, the helical guide structure 24 is not limited to a groove. Similarly, the corresponding structure 36 discussed in the embodiments below is a tooth 62 but is not limited to being a tooth. In some embodiments, one or more curtain supports 67 supported by the rotatable drive element 22 can also be utilized to support the curtain. The drive attachment element 36, as shown in FIGS. 1-3 will be explained further below.

### Description of Curtains

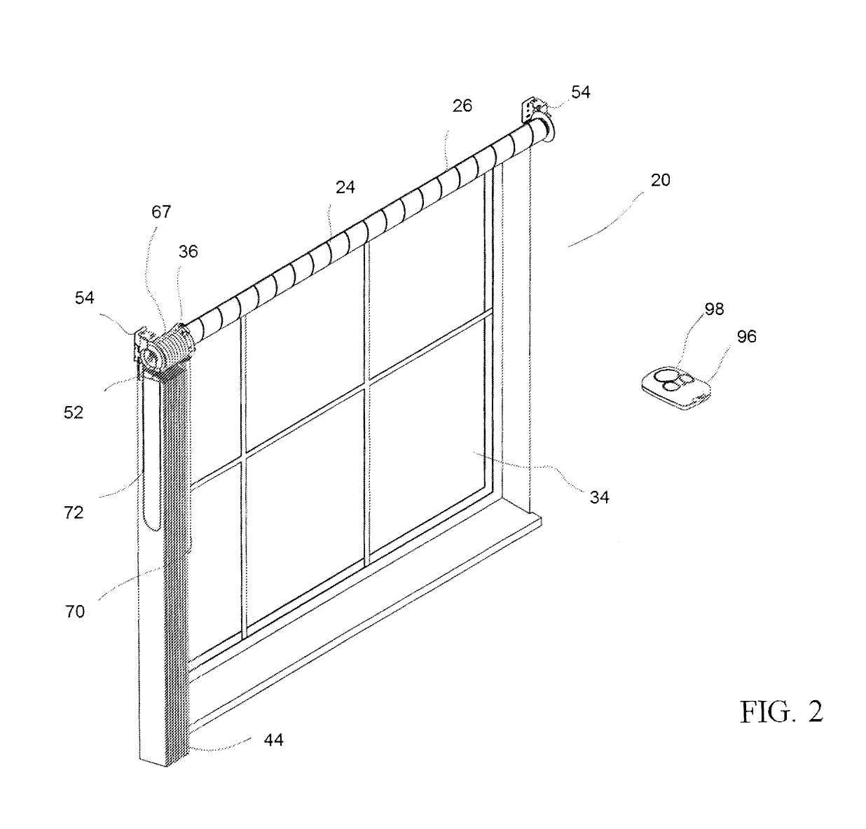

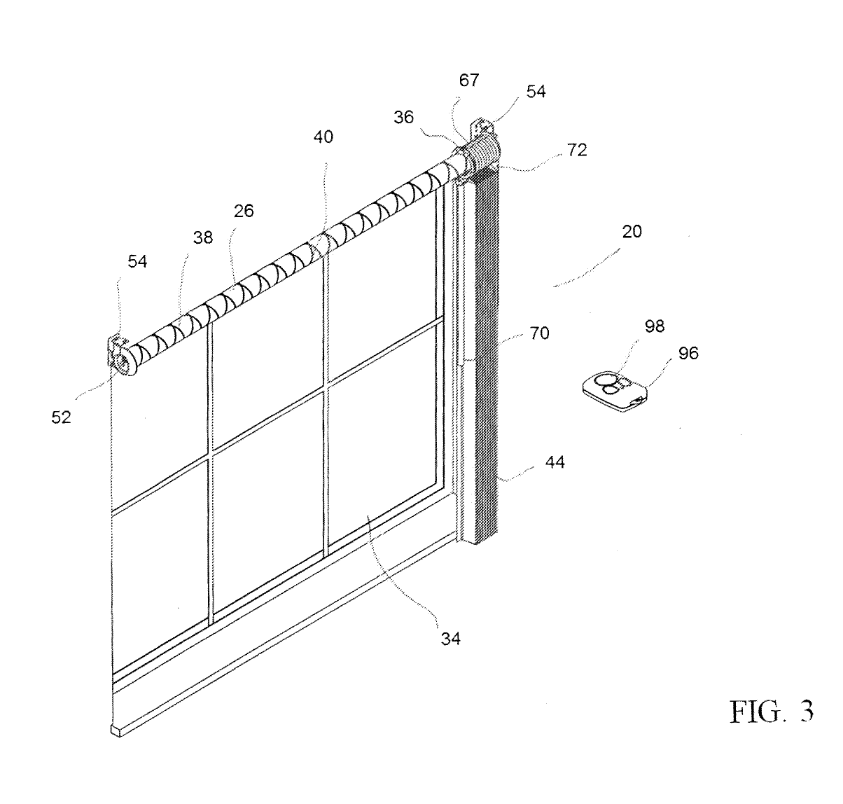

As shown in FIG. 1, the curtain 44 used is composed of a single continuous panel of fabric that moves back and forth across the drive element 22 to the deployed position (covering the window) and to the stored position (not covering the window 34). The curtain 44 may extend to the right to the deployed position (covering the window 34) and then gather to the left to the stored position, uncovering the window 34. This is shown in FIGS. 1 and 2. For example, FIG. 1 shows that a curtain 44 extended to the right (deployed position) to cover the window 34 and FIG. 2 shows the curtain 44 gathered to the left (stored position) to uncover the window 34. In other embodiments, the curtain 44 may extend to the left to the deployed position (covering the window 34) and then gather to the right to the stored position (uncovering the window 34). For example, FIG. 3 shows a curtain assembly 20 wherein the curtain 44 is gathered to the right (stored position) to uncover the window 34. Although not shown, the curtain 44 in FIG. 3 would extend to the left to the deployed position to cover the window 34.

Again, although curtain is used to describe a preferred embodiment of the invention, other embodiments utilize other window coverings, such as verticals and draperies.

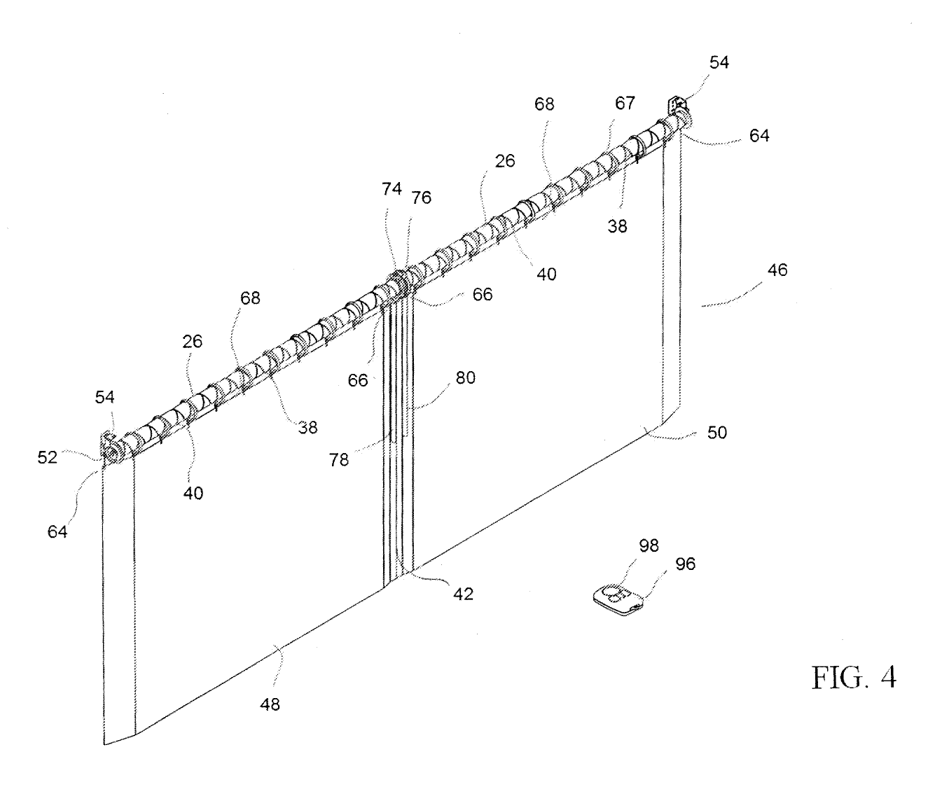

In some embodiments, the curtain 44 may be a center closing curtain 46. A center closing curtain 46 is composed of two fabric panels, a right panel 50 and a left panel 48 that meet in the center 42 of the window 34 to close and cover the window 34. FIG. 4 shows a curtain assembly 20 where a center closing curtain 46 is used and is in the deployed position. The window 34 is covered in this instance. For example, the right panel 50 extends to the left to the center of the window 42. The left panel 48 extends to the right to the center of the window 42.

### Drive Element

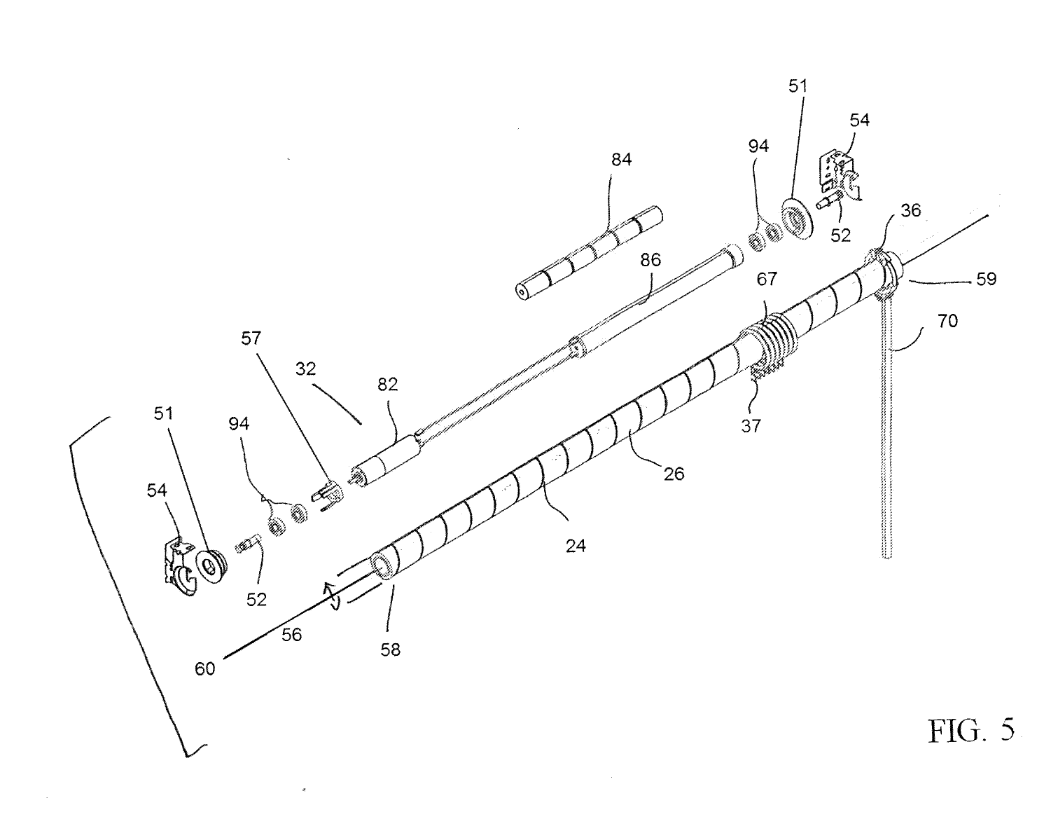

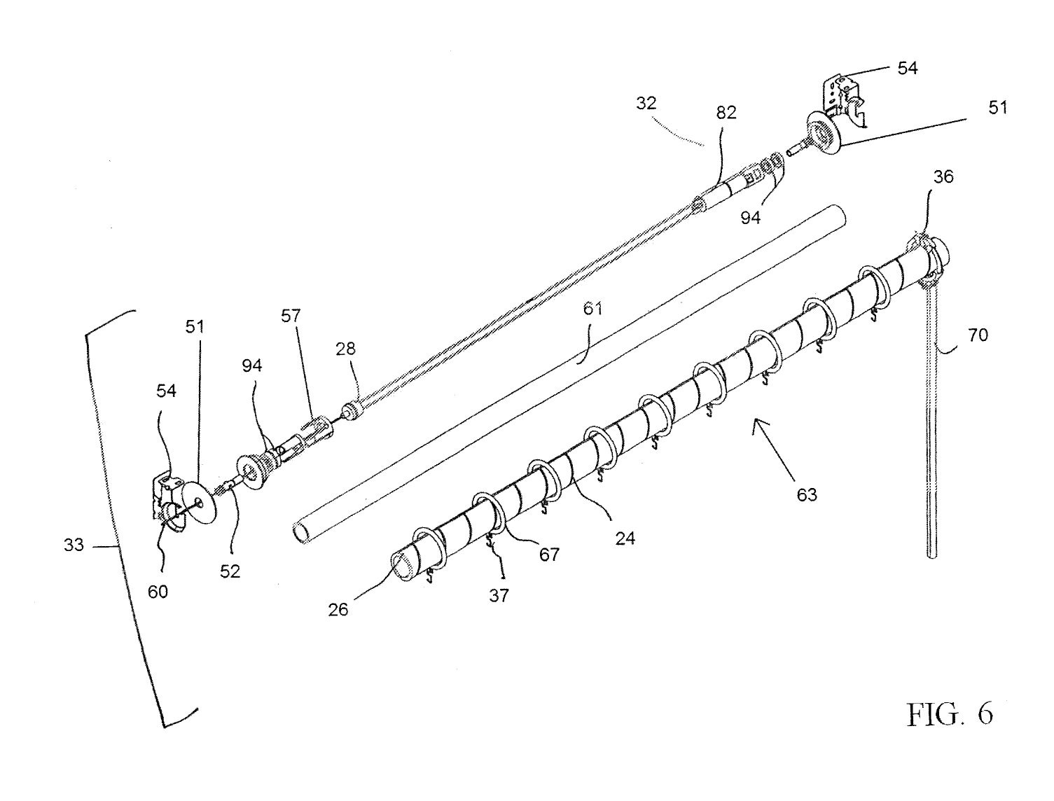

The curtain assembly 20 includes a drive element 22. FIGS. 5 and 6 show one embodiment of the drive element 22 in detail. A curtain 44 can be connected to the drive element 22 by one or more curtain supports 36 and 67 as explained below. Alternatively, at least a portion of the curtain can be supported by another structure adjacent to the rotatable drive element 22, such as a support guide (not shown).

The rotatable drive element 22 is designed to be installed above a window 34, or near the top of the window 34, similar to a traditional curtain rod. For example, as shown in FIG. 1, drive element 22 is mounted on axles 52 that are located and secured in the end brackets 54. The end brackets 54 are adapted for connection with, for example, a window frame, sash, or wall. The end brackets 54 may also include a rubber mounting disk 13, not shown, that is compressed, and, optionally, inserted into a finial 95 or other structure to create friction, when the drive element 22 is installed, to hold the drive element 22 firmly in place and minimize noise.

The drive element 22 may vary in size. For example, the drive element 22 may be the width of the window 34, narrower than the window 34, or wider than the window 34. The outer diameter 56 of the drive element 22 may similarly vary. In specific embodiments, the drive element has an outer diameter of the drive element that is 1 inch, 1¼ inches, 1½ inches, 2 inches, 1-2 inches, 1-1½ inches, 1½-2 inches, less than 1 inch, and/or greater than 2 inches. In some embodiments, the drive element 22 has a hollow portion that is sized to mount a motor 82 inside the hollow portion of the drive element 22 rather than mounting the motor 82 outside the drive element 22. Using the inside of the drive element 22 to conceal the motor 82 may give a more aesthetically pleasing design for a curtain assembly 20. Any number of materials, such as aluminum, other metals or alloys, plastics, wood, and ceramics, may be used to fabricate the drive element 22 provided the drive element 22 can support the weight of the curtain 44.

Although the FIGS. 5 and 6 show the outer surface of the drive element 22 as cylindrical in shape, the cross-sectional shape of the drive element 22 is not limited and may be non-circular. In an alternative embodiment, as shown in FIGS. 20 and 21, the rotatable drive element 22 may be tri-lobed.

### Guide Structure

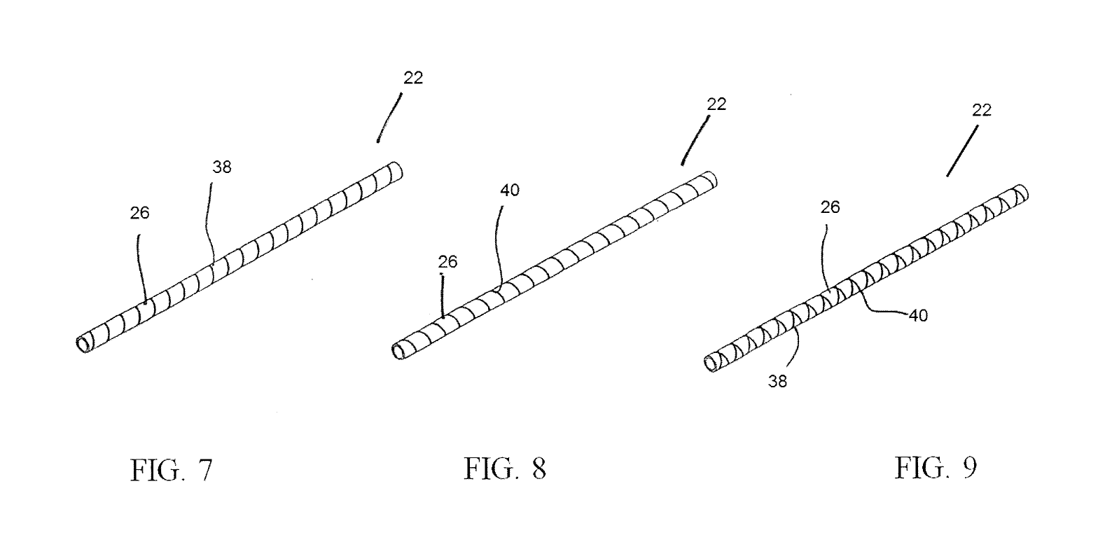

The drive element 22 has at least one guide structure 24 formed, for example, on, or into, the outer surface 26 of the drive element 22. For convenience, as a preferred embodiment employs a one or more helical guide structure, it is understood that descriptions of embodiments of the invention having helical guide structures also applies to embodiments having guide structures with other patterns. A preferred guide structure 24 is a helical guide structure 24. Such a guide structure may be a groove in some embodiments, as shown in FIGS. 7-9. The helical guide structure 24, however, is not limited to being a helical groove. For example, the guide structure 24 may be a ridge, protrusion, or other structure that can communicate with the corresponding structure of the drive attachment element to axially move the drive attachment element along the drive element when the drive element is rotated.

The helical groove 24 can extend along a portion of, or the entirety of, the drive element 22. In a preferred embodiment, the helical groove extends from one distal end portion, referred to as the motor end 58, to the opposing distal end portion, referred to as the bearings end 59, of the drive element 22. Alternatively, the helical guide structure 24 can begin and end at any desired point along the longitudinal axis of the drive element 22, and/or stop and start over various portions of the drive element, depending on the application. The length of the helical groove 24 is a factor in determining how far a curtain 44 will travel across the drive element, i.e., the entire length of the drive element 22 as opposed to some shorter section of the drive element 22. The angle of the helical groove determines how far the drive attachment element will move along the drive element for a given amount of rotation of the drive element.

In an embodiment, the helical groove 24 is formed in either a clockwise direction or a counterclockwise direction. FIG. 7 illustrates a drive element 22 having a counterclockwise helical groove 38. FIG. 8 illustrates a drive element 22 having a clockwise helical groove 40.

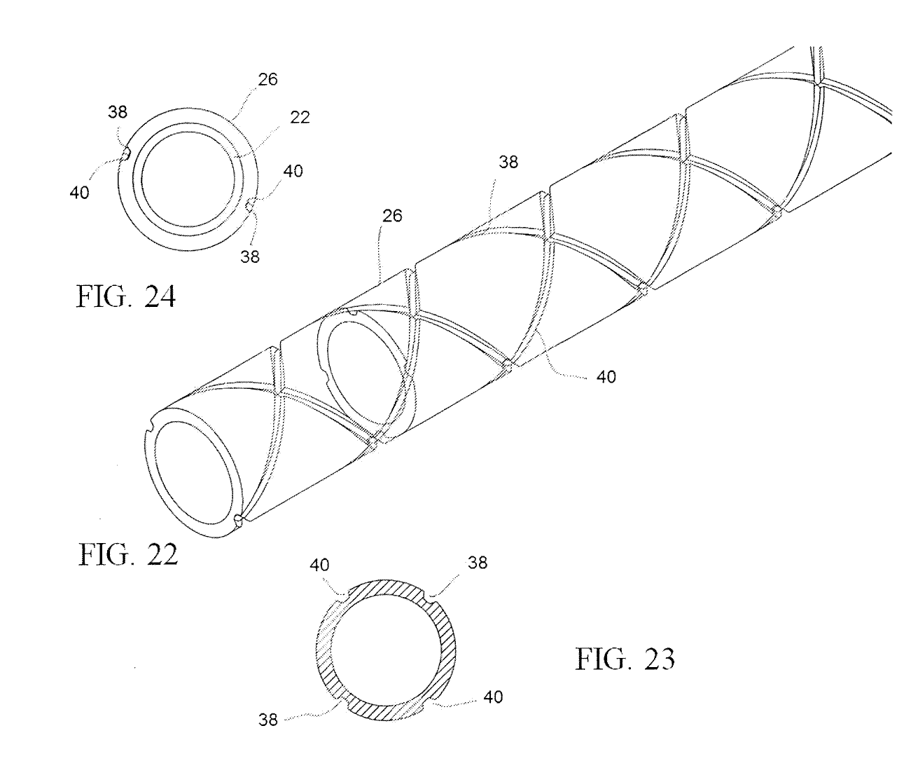

In one embodiment, the drive element 22 has two helical grooves 24, one formed in the clockwise direction and one formed in the counterclockwise direction. FIG. 9 illustrates a drive element 22 in which there are a counter clockwise helical groove 38 and a clockwise helical groove 40. In yet other embodiments, the drive element 22 may have four helical grooves, two clockwise helical grooves 38 and two counter clockwise helical grooves 40 as shown in FIGS. 22-24.

When two clockwise helical grooves 38 or two counter-clockwise helical grooves 40 are utilized, the two clockwise helical grooves 38, or the two counter-clockwise helical grooves 40 are preferably spaced approximately 180 degrees apart. Other spacings can also be utilized. The clockwise helical grooves 38 and the counterclockwise helical grooves 40 preferably form the same angle with the longitudinal axis. The profile of the helical grooves 38, 40 can be self-centering to allow the drive tooth 62 to traverse the intersection of the clockwise helical groove 38 and the counter clockwise helical groove 40 without binding. A beveled groove, which allows such self-centering, is shown in FIG. 17.

The helical grooves 24 may be formed by forming grooves into the outer surface 26 of the drive element 22 such that the grooves 24 are recessed from the outer surface 26 of the drive element 22. Alternatively, the helical guide structures 24 may be formed as one or more protrusions that project or bulge from the outer surface 26 of the drive element 22. The protrusions may be formed in a variety of manners, for example, by winding material around the outer surface 26 of the drive element 22, forming, e.g., extruding the drive element in a manner that creates indentations in and/or projections from the outer surface of the drive element, or forming the drive element so as to have an outer surface able to apply a force in the longitudinal direction to a structure 62 of the corresponding drive attachment element 36 when the corresponding structure is engaged with the structure 24 upon rotation of the drive element about the longitudinal axis.

In an alternative embodiment, a sleeve, or outer tube 63, having helical guide structure 24 and sized to fit around a portion of the drive element 22 may be used. In this case, the drive sleeve has at least one helical groove 24 in a clockwise or counter clockwise direction formed on the outer surface of the sleeve. The sleeve/outer tube can be interconnected to an inner tube 61, or other inner drive element 9 (e.g., rod), that is rotated so as to cause the rotation of the sleeve/outer tube. The inner drive element 9 can provide sufficient stiffness to keep the sleeve from bending too much along the longitudinal axis of the sleeve from the weight of the curtains, so that the sleeve need not be sufficiently stiff to keep from bending too much along the longitudinal axis of the sleeve from the weight of the curtains. The drive element 22, which then comprises the inner drive element 9 and the outer tube or sleeve, again translates the torque from the rotation assembly to axially movement of the curtain support 67 or drive attachment element 36 across the drive element 22. In an embodiment, the drive sleeve is secured to the inner drive element to form the drive element 22 such that the sleeve does not slide up or down the inner drive element or rotate around the inner drive element 9. It may also be desired to remove the sleeve from the inner drive element 9 and replace it with another sleeve. Using a drive sleeve has the advantage that the geometry of the helical groove 24 including its length may be easily changed by removing the sleeve and replacing it without fabricating a new drive element 22.

The helical grooves 24 may also vary in angle and therefore, may differ in the amount of time (rotations of the drive element) that it takes to travel across the drive element 22. For example, a helical groove 24 with a larger angle, with respect to a plane through a cross-section of the drive element, may create a shorter path for the structure to travel and lead to a faster moving curtain 44 for a certain rotation speed of the drive element. In some embodiments, the angle of the helical grooves 24, with respect to a cross-sectional plane of the drive element, may vary along the drive element in the direction of the longitudinal axis 60 of the drive element 22 such that the curtain 44 may move at different speeds along the drive element 22, for a given rotational speed of the drive element, if desired. The angle of the helical groove 24, with respect to a cross-sectional plane of the drive element, varies from greater than 0 degrees and less than 90 degrees, preferably varies from 10 degrees to 80 degrees, more preferably varies from 20 degrees to 70 degrees, even more preferably varies from 30 degrees to 60 degrees, and is most preferably 45 degrees. Specific embodiments can have an angle of the helical groove in the range 30-45 degrees, 40-45 degrees, 40-50 degrees, 35-45 degrees, 42-48 degrees, or other angle that facilitates the desired speed of the curtain with respect to the rotation of the drive element and efficient transfer of force from drive element to drive attachment element.

### Rotation Assembly

The drive element 22 can be connected to a rotation assembly 33 for rotating the drive element 22, where the rotation of the drive element 22 moves the drive attachment element 36 along the drive element via the helical groove 24 of the drive element 22.

The rotation assembly 33 may be a pull cord 72 connected to the drive element 22 or a motor assembly 32. The drive element 22 may be rotated manually. For example, a pull cord 72 as shown in FIGS. 1-3 may be connected to the drive element 22 such that the drive element 22 can be manipulated manually to rotate when it is desired to deploy or store the curtain 44. The use of pull cords 72 is well known in the art.

A motor assembly 32 may be used to rotate the drive element 22. The motor 82 may be mounted either inside or outside the drive element 22. In one embodiment, the motor 82 is mounted inside the drive element 22 and generally concealed from plain view. Components including axles 52 and bearings 94 may also be located inside the rotatable drive element 22.

A slip ring 28 may be used to transfer current from the power supply external to the drive element 22 to the motor 82 in the drive element 22 as shown in FIG. 6. Alternatively, batteries 84 in a battery tube 86 may be used as shown in FIG. 5 to power the motor 82. The batteries 84 in the battery tube 86 may be in a spring loaded sleeve to assist with loading and unloading the batteries 84 from the battery tube. In some embodiments, a motor drive adapter 92 as shown in FIG. 6 may also be used to securely attach or connect the motor 82 to the drive element 22. In other embodiments, the motor housing fits tightly against the drive element 22 and turns the drive element 22 when the motor output shaft is held in end bracket 54 to prevent it from turning. FIG. 5 shows the interconnection of end caps 51, axles 52, bearings 94, bearing housings 57 (note the bearing housing 57 is shown on the motor end in FIG. 5, but the bearing housing 57 on the battery end is not shown), motor 82, and battery tube 86. FIG. 6 shows a slip ring 28, which is optional, and allows the circuit to be completed while rotating.

In a motorized operation, the user may push a button 98 on a remote control 96 to turn on the motor 82 to rotate the drive element 22 such that the curtain 44 moves across the drive element 22 between a stored position and a deployed position depending on the user's preference. The remote control 96 and button 98 are shown in FIGS. 1-3. In other embodiments, the motor 82 may respond to a signal from the remote control 96 that is initiated by a voice command to the remote control, which then causes the motor 82 to rotate the drive element 22.

The curtain assembly 20 may also include a remote control 96 having a control board that generates a signal when the user makes a selection on the remote control 96. The control board has a transmitter that can wirelessly communicate with a receiver that is remotely located from the transmitter. For example, the receiver may be located in the motor 82 in the drive element 22. The receiver receives the transmitted signal from the transmitter and transmits it to the motor 82, which will cause the motor 16 to turn on, rotate the drive element 22, and moves the curtain 44.

As the drive element rotates, either manually or by a motor 82, the curtain 44 is engaged on the drive element 22 and moves axially along the drive element 22 to either a deployed or stored position.

### Curtain Support, Drive Attachment Element and Structure

The curtain assembly 20 can include a drive attachment element 36 having a structure 62 that communicates with the guide structure 24 to move the drive attachment element 36 axially along the drive element 22 when the drive element 22 is rotated. The curtain assembly can also include one or more idler attachment elements 67 that interconnect with the drive element to support the window covering, e.g. curtain. In specific embodiments, the drive attachment element 36 has a corresponding feature 62 that is a tooth 62 as described below.

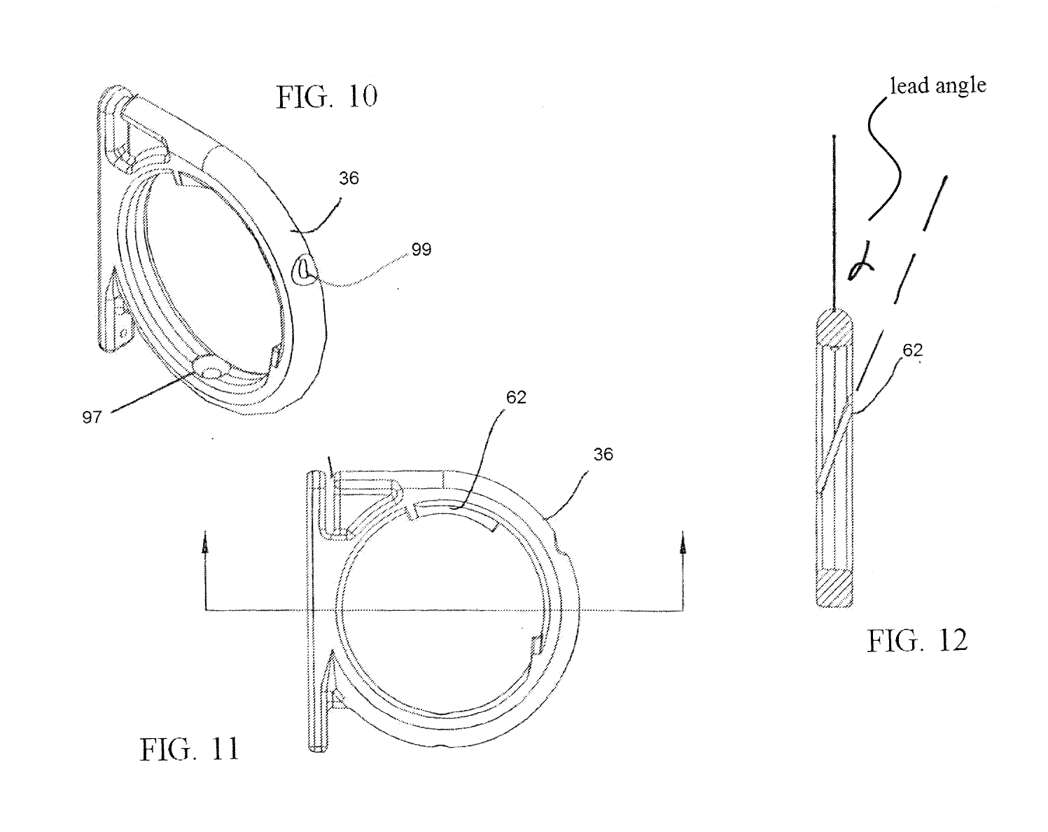

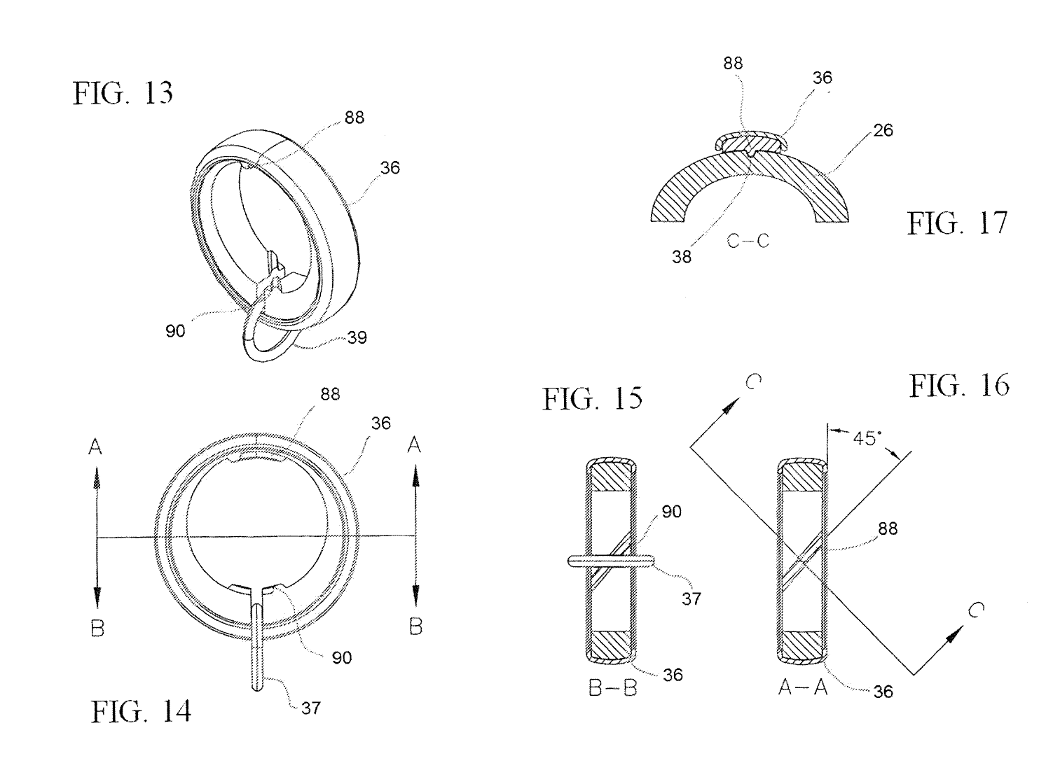

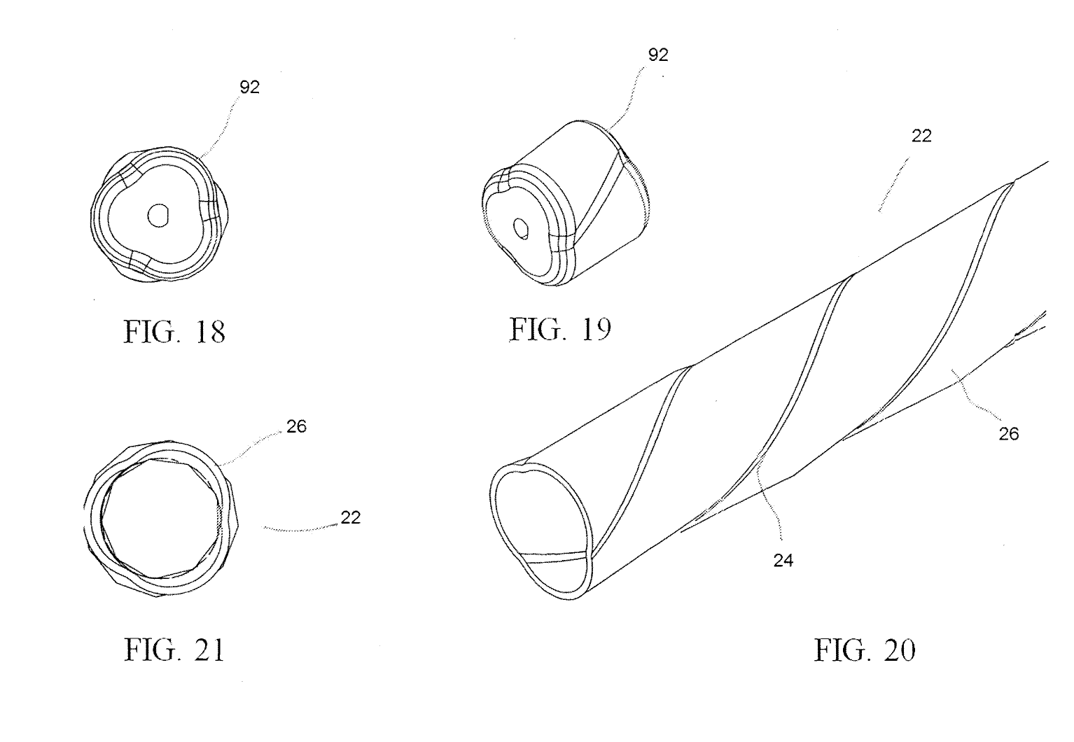

The curtain assembly 20 of the present invention may include in some embodiments at least one drive attachment element 36 having a feature 62 that communicates with a helical guide structure 24 to move the drive attachment element 36 axially along the drive element 22 when the drive element 22 is rotated. The helical guide structure may be a helical groove 24 and the feature 62 may be a tooth. Referring to FIG. 1, one end, such as the motor end, of the curtain can be fixed 64 and the adjacent opposing end, such as the bearings end, of the curtain 66 can be attached to the drive attachment element 36. The feature 62 as a tooth is shown in FIGS. 10-12. FIG. 10 shows an enlarged perspective view of the drive attachment element 36. FIG. 11 is an enlarged side view of the drive attachment element 36 showing the drive tooth 62 according to one embodiment. FIG. 12 is an enlarged cross-sectional view of the drive attachment element 36 showing the angle α (approximately 30 degrees) of the drive tooth 67. This angle α is the same angle as the helical groove makes with respect to a cross-sectional plane of the drive element.

As shown in FIGS. 10-12, the drive attachment element 36 can be ring-shaped and slides over the drive element 22. A different construction, however, may be used for the drive attachment element 36. As an example, the drive attachment element may have one or more additional structures 62, which may follow a corresponding one or more additional grooves, and/or one or more of the structures 62 can be located at a different rotational position with respect to the longitudinal axis of the drive element when the structure is mounted onto the drive element. The drive attachment element 36 is preferably provided with a slot 99 into which a traditional curtain hook 37 can be used to connect the end of the curtain to the drive attachment element 36. Curtain pins and curtain rings that are well known in the art to hang curtains may be used.

The structure 62 is designed to communicate with or engage the helical groove 24 of the drive element to move the drive attachment element 36 axially along the drive element, thereby moving the curtain. In one embodiment, the feature is a tooth formed on an angle on the inner surface of the body of the drive attachment element. The angle α of the drive tooth 62 is specifically designed to engage the helical groove on the drive element 22. In an embodiment, a design consideration is to maximize the amount of contact between the rotating drive element 22 and the drive attachment element 36 to move the weight of the curtain. The location of the tooth 62 with respect to the drive attachment element 36, in some embodiments of the present invention, are adjustable such that the angle the location of the tooth makes with respect to the drive element when the drive attachment element is interconnected to the drive element is adjustable. This adjustability allows the user of the curtain assembly to set the correct location of the drive attachment element(s) 36 in relationship to the axial position along the drive element for a particular rotational position of the drive element, as where the tooth is positioned and where the helical groove is located for a particular angular position of the drive element determines the axial position of the drive attachment element and, therefore, the axial position of the point of the curtain attached to the drive attachment element. In this way, if it is desired for a distal end of the curtain to reach the distal end of the drive element at a particular degree of rotation of the drive element (e.g., 720°, or 3600°), then the relative rotational position of the tooth to the drive attachment element can be adjusted.

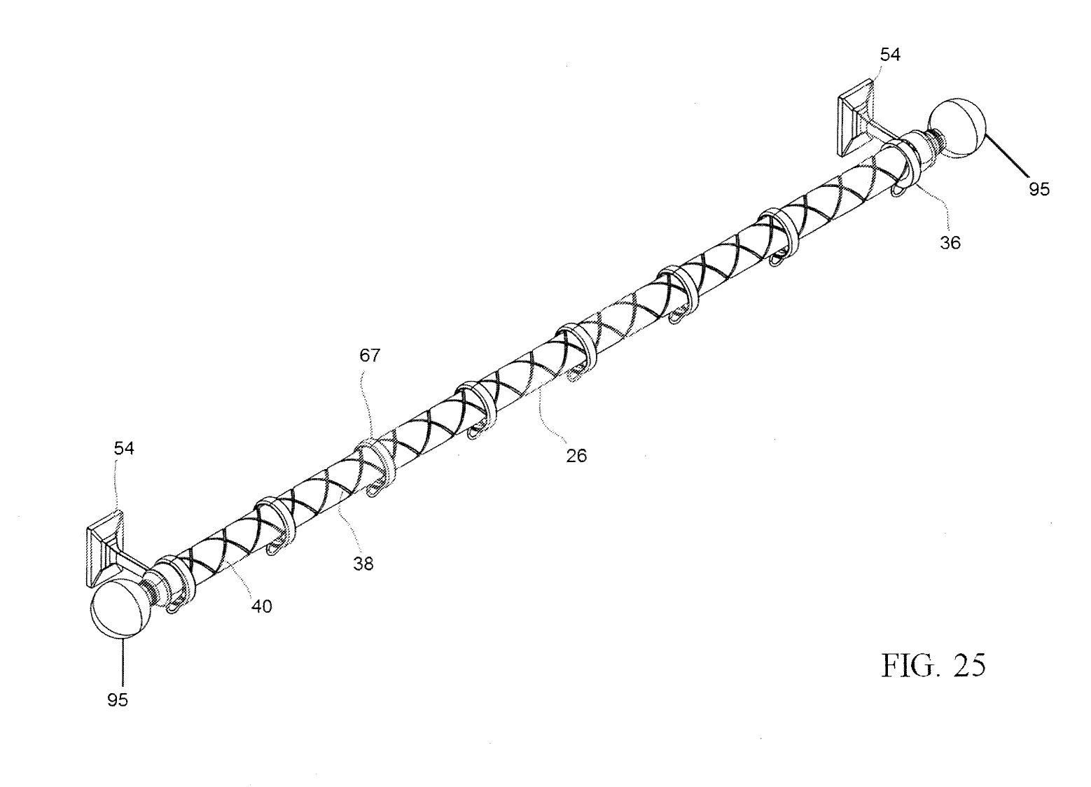

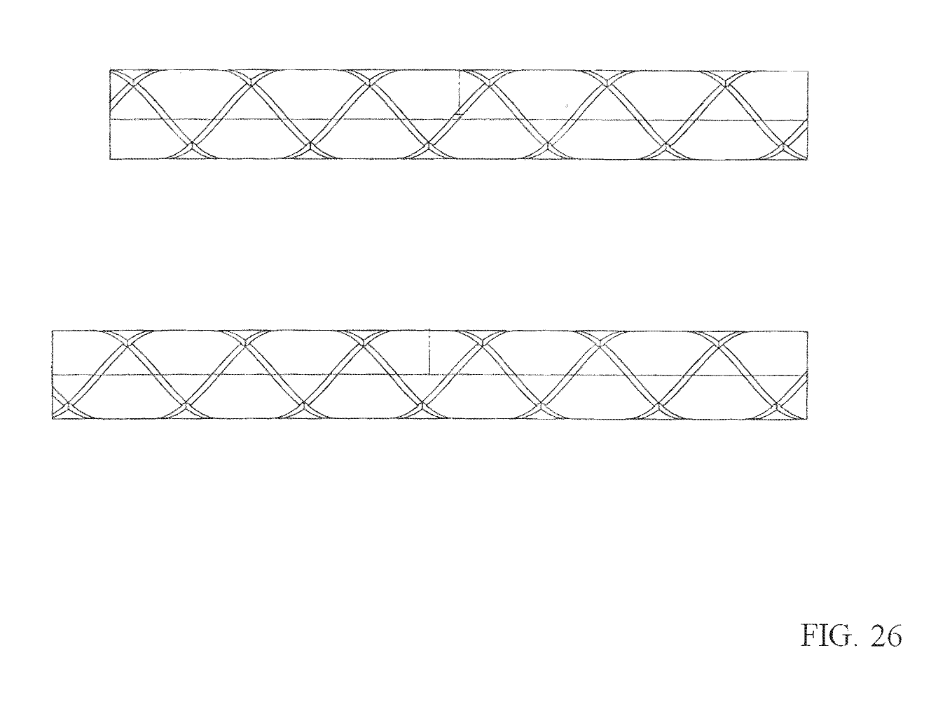

In some embodiments, the drive attachment element 36 has a first drive tooth 88 and a second drive tooth 90 as shown in FIGS. 13-16. Both the first drive tooth 88 and the second drive tooth 90 are configured to communicate with different helical grooves 24 of the drive element 22. The first drive tooth 88 and the second drive tooth 90 are positioned inside the drive attachment element 36 at the top and the bottom of the drive attachment element 36, respectively. FIGS. 15 and 16 show cross-sectional views of the top and the bottom of the drive attachment element 36 which show the angle α₁ of the first drive tooth and the angle of the second drive tooth α₂. The angles α₁, α₂ are both 45 degrees. The angles α₁, α₂ of the first drive tooth 88 and the second drive tooth 90 are not limited to 45 degrees and are configured to communicate with the corresponding helical groove 24 of the drive element 22. In a preferred embodiment, also shown in FIGS. 22-26, there are four helical grooves 26. Two are clockwise spirals 38 and two are counter-clockwise 40.

One issue with this type of helical pattern on center closing curtains is keeping the timing of the drive attachment elements and the helical groove such that the two curtains always meet in the center of the opening when the drive element is drive (rotated to the close position. This issue is further complicated by being able to cut down the length of the tube to fit smaller windows. If a quad-helix drive element (two clockwise and two counterclockwise helixes) is cut down to a length that is not a multiple of ½ the pitch of the helixes, the drive attachment elements of the right curtain and the left curtain (for a dual curtain assembly) may not meet in the middle of the drive element. See FIG. 26. The adjustable drive attachment element can allow the teeth to be repositioned inside the drive attachment element such that the drive attachment element can start from a different axial position along the drive element and end at the desired axial position in the center, or other desired axial position. This adjustment of the position of the tooth with respect to the drive attachment element can correct the offset caused by the odd length of the drive element, e.g., from cutting an end off, and allows the right curtain drive attachment element and the left attachment element to meet in the middle.

The gear teeth between the “Clicker” and “Gear Ring” parts of the adjustable drive attachment element, in a specific embodiment, do not allow the “Clicker” to rotate when it is on the tube. In this case, removing the adjustable drive attachment element from the drive element allows the user to adjust the “Clicker” manually by disengaging it from the Gear Ring. The outward force of the drive element on the Clicker's gear teeth essentially locks it into the Gear Ring. Specific embodiments allow the tooth to be repositioned about one inch in either direction. For a drive element where ½ the pitch length is two inches, rotating the tube 180 degrees before installing the adjustable drive attachment element changes the starting position by ½ pitch length, which will correct the adjustable drive attachment element's starting position to an acceptable degree.

Although the structure 62 described in the embodiments above is a tooth, other embodiments for the structure 62 may be used as well.

### Simple Attachment Elements

The curtain assembly 20 may further comprise a plurality of idle attachment elements 67 connected to the drive element 22 for sliding movement along the drive element 22. The remaining attachment points 68 of the curtain 34 that are not connected to the drive attachment element 36 can then be suspended from the drive element 22 using one or more idler attachment elements 67.

Referring to FIG. 1, the curtain has one fixed end 64 and an adjacent opposing end 66 that is connected to the drive attachment element 36. The remaining ends (or attachment points) of the curtain 68 are positioned between the fixed end 64 and the adjacent opposing end 66 that is connected to the drive attachment element 36. These remaining attachment points 68 may be suspended from the drive element 22 using a plurality of idler attachment elements 67. The idler attachment elements 67 are interconnected to the rotatable drive element 22 as shown in FIGS. 1-4. Such interconnection of idler attachment elements 67 can be such that the idler attachment element surrounds a portion of, or all of, the circumference of the cross-section of the drive element and hangs freely on the drive element. In other embodiments, the idler attachment elements can be also interconnected with a structure external to the drive element.

The idler attachment elements 67 may be shaped similar to the drive attachment element 36. In some embodiments, the idler attachment elements 67 may have a smooth bore to allow free movement along the drive element 22 as the curtain moves. In other embodiments, the idler attachment elements 67 may have a tooth to assist in the movement of the curtain across the drive element. In embodiments having a tooth, the drive element can have a region that frees the tooth when the simple attachment element reaches a certain axial region of the drive element, such as an end of the drive element, going one axial direction, and re-engages the tooth as the idler attachment element is pulled in the other axial direction out of the same axial direction.

As shown in FIGS. 1-4, the idler attachment elements 67 may be rings that slide over the drive element 22. The idler attachment elements 67 may be provided with a slot or a hole (not shown) into which a traditional curtain hook (or loop) 37 is used to attach the remaining attachment points 68 of the curtain 44 to the idler attachment element 67 as shown in FIGS. 4-6. Curtain pins and curtain rings that are well known in the art to hang curtains may be used.

### Pull Rods and Programming

In some embodiments, the drive attachment element 36 has a single tooth 62 and is a loose fit on the drive element 22. In these cases, the curtain assembly 20 can include a draw rod 70 connected to the drive attachment element 36 wherein the drive tooth 62 is disengaged from the guide structure 24 of the drive element 22 by applying force on the draw rod 70. The draw rod 70 may be an elongated rod or any other mechanism that is configured to allow the user to manually disengage the drive attachment element 36 from the guide structure 24. The draw rod can then be used to axially move the drive attachment element along the drive element.

The motor 82 for the curtain assembly 20 may be programmed from the factory with a preset number (integer or fractional) of drive element 22 revolutions to move the curtain axially across the drive element 22. There are a variety of reasons, however, why this preset number of revolutions may change. For example, the drive element 22 may be shortened (e.g., cut) to accommodate a narrower window 34 or the curtain has been manually moved with the draw rod 70 and not moved by the pull cord 72.

Therefore, in an embodiment, the initial setup of the motor 82 is able to count the number of revolutions the drive element 22 makes to fully open and fully close the curtain 44. This setup may be accomplished by a setup routine in which a program button is pressed once on a remote control 96 to start the motor 82 moving the curtain 44 and then pressing the button a second time, either to stop the movement or after the movement has stopped, which stores the number of revolutions the curtain 44 has moved.

In a specific embodiment, the number of revolutions can be confirmed by pressing the program button a third time, which reverses the motor 82 and moves the curtain 44 in the opposite direction. Pressing the program button a fourth time, either to stop the curtain 44 or after the movement has stopped, can cause the number of counts to be compared, and set a new count in the memory to complete the set up routine. If the program button on the remote control 96 is not pressed the second time, the motor 82 can run until the preset count is reached, then shut off. Alternatively, the assembly can implement some sort of maximum axial distance detector or force detector, or clutch, such that the motor stops, or stops rotating the drive element, respectively, when a threshold force is encountered trying to move the drive attachment element.

If it is desired to automatically move the curtain after the curtain was manually moved, the user can press the program button twice on the remote control 96, which will cycle the curtain twice. This resynchronizes the curtain movement count by first moving the curtain to one distal end of the drive element followed by moving the curtain 44 to the opposite distal end of the drive section, i.e., two cycles.

When the curtain 44 is moved towards its fully deployed position, as shown in FIG. 1, the drive attachment element 36 is driven by the rotation of the helical groove 24 on the drive element 22 acting on the feature in the drive attachment element until the drive element 22 rotates a set number of revolutions and stops in the fully deployed position.

### Center Closing Embodiments

Referring to FIG. 4, a specific embodiment of the curtain assembly 20 is shown in which the curtain 44 used is a center closing curtain 46. As described above, a center closing curtain 46 is composed of two fabric panels, a right panel 50 and a left panel 48, which meet in the center of the window 42 to close and cover the window 34.

The center closing curtain 46 is in the deployed position and the window 34 is covered in FIG. 4. The drive element 22 has a clockwise helical groove 38 and a counter clockwise helical groove 40 formed on the outer surface 26 of the drive element 22. The clockwise helical groove 38 and counter clockwise helical groove 40 have the same angle and oppose each other to create the correct movement of the center closing curtain 46 when the drive element 22 rotates.

To accommodate a center closing curtain 46, the curtain assembly 20 has a left drive attachment element 74 and a right drive attachment element 76 as shown in FIG. 4. The left drive attachment element 74 is connected to the adjacent opposing end 66 of the left panel 48 and the right drive attachment element 76 is connected to adjacent opposing end 66 of the right panel 50. In other words, the left panel 48 has a fixed end 64 and an adjacent opposing end 66 that is connected to the left drive attachment element 74. The right panel 50 has a fixed end 64 and an adjacent opposing end 66 that is connected to the right drive attachment element 76. There may also be a left draw rod 78 and a right draw rod 80 attached to the left drive attachment element 74 and the right drive attachment element 76, respectively.

The tooth 62 of the right drive attachment element 76 can follow the counter-clockwise helical groove 40 and the tooth 62 of the left drive attachment element 74 can follow the clockwise helical groove 38, such that when the drive element is rotated in a first rotational direction the left panel 48 and right panel 50 both close and when the drive element is rotated in the opposite direction the left panel 48 and right panel 50 both open. In a specific embodiment, the drive element has only one or more clockwise helical grooves 24 on the left end of the drive element, on which the closed left panel 48 hangs, and the drive element has only one or more counter-clockwise helical grooves on the right end of the drive element, on which the closed right panel 50 hangs.

### Dual Curtain

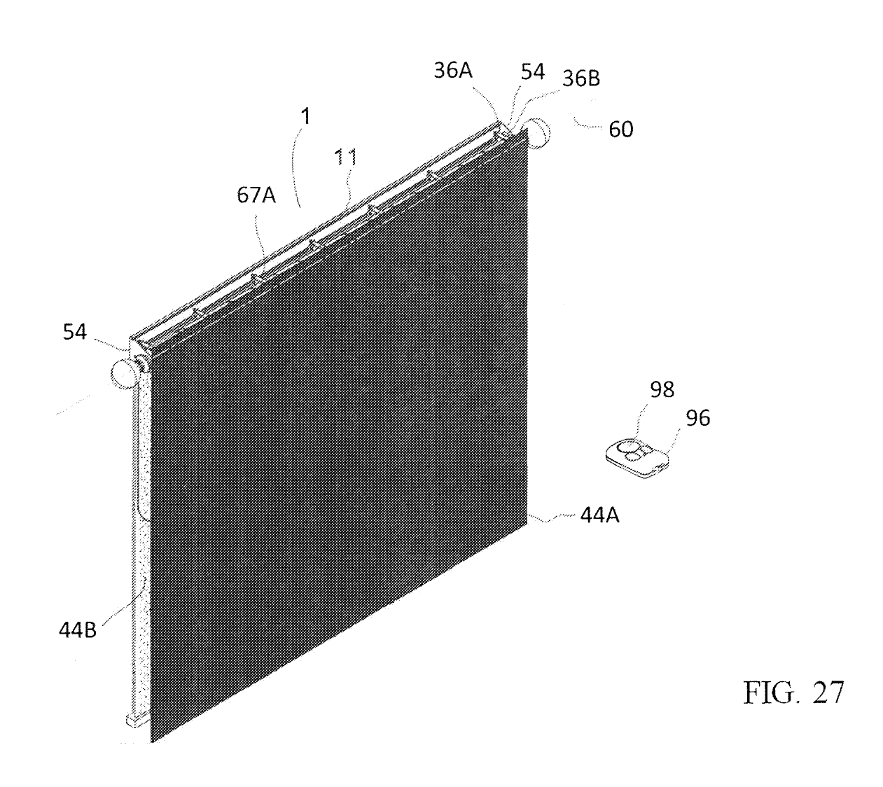

Referring to FIGS. 27-30, a dual curtain assembly 1 is provided. The dual curtain assembly 1 comprises a rotatable drive element 22 wherein at least one helical structure 24 is formed on the outer surface 26 of the drive element 22; curtain drive elements 36A and 36B having a corresponding structure that communicates with the helical structure 24 to move the curtain supports axially along the drive element 22 when the drive element 22 is rotated and; a rotation assembly 33 for rotating the drive element 22.

In some embodiments of the invention, the helical structure 24 is a helical groove and the corresponding structure is a tooth. While the helical structure 24 is shown in FIGS. 27-30 as a helical groove, the helical structure is not limited to a groove. Similarly, the corresponding structure discussed below in some embodiments is a tooth but is not limited to being a tooth. In some embodiments, the curtain support includes an outer curtain outer curtain drive attachment element 36A and an inner curtain drive attachment element 36B as shown in FIGS. 27-30 and explained further below.

The curtain assembly 1 may further comprise an outer curtain 44A and an inner curtain 44B; the outer curtain 44A is suspended from the rotatable drive element 22 while the inner curtain 44B is suspended from hooks 17 in carrier tracks 12 and 81 that move along the support guide 11. The rotatable drive element 22 comprises at least one drive element 22 having opposing distal end portions 35, 36, where the distal end having the motor can be referred to as the motor end 58 and the other distal end can be referred to as the bearing end 59, wherein at least one helical groove 24 is formed in either a clockwise direction or a counterclockwise direction on the outer surface 26 of the drive element 22 extending from one distal end portion 35, 36 of the drive element 22 to the opposing distal end portion 35, 36 of the drive element 22.

When the drive element 22 is rotated, either the outer curtain 44A or the inner curtain 44B will move along the drive element 22, while the other curtain is held in place in a non-driving or stall area. Once the moving drive attachment element 36A or 36B has reached a stall area at the end of the drive element 22, the non-moving drive attachment element will be tugged to engage the helical groove 24. This movement of the outer curtain 44A and the inner curtain 44B, along the helical groove 24 of the drive element 22 is explained in greater detail below. Whether the outer curtain 44A moves or the inner curtain 44B moves is determined by the sequence of the movement of the curtains. A system for selecting either the outer curtain 44A or the inner curtain 44B is explained below.

As shown in FIG. 27, the outer curtain 44A and inner curtain 44B may be composed of a single continuous panel of fabric that moves back and forth across the drive element 22 to the deployed position (covering the window 34) and to the stored position (not covering the window 34). Although, there is no limitation on the type of fabric used for the curtains 44A and 44B, in one embodiment, the outer curtain 44A is a blackout curtain and the inner curtain 44B is a sheer curtain. Using a blackout curtain with a sheer curtain to cover the same window 34 allows the user to use the sheer curtain when some light is desired and then also to use the blackout curtain when no light is desired. For example, the blackout curtain may be stored and the sheer curtain may be deployed, if some light is desired and privacy is needed. The blackout curtain may be deployed and the sheer curtain may be deployed when no light is desired. The blackout curtain may be stored and the sheer curtain may also be stored, when light is desired and privacy is not needed. The dual curtain assembly 1 disclosed herein allows for these combinations of positions for the outer curtain 44A (blackout curtain) and the inner curtain 44B (sheer curtain) as shown in FIGS. 27-30.

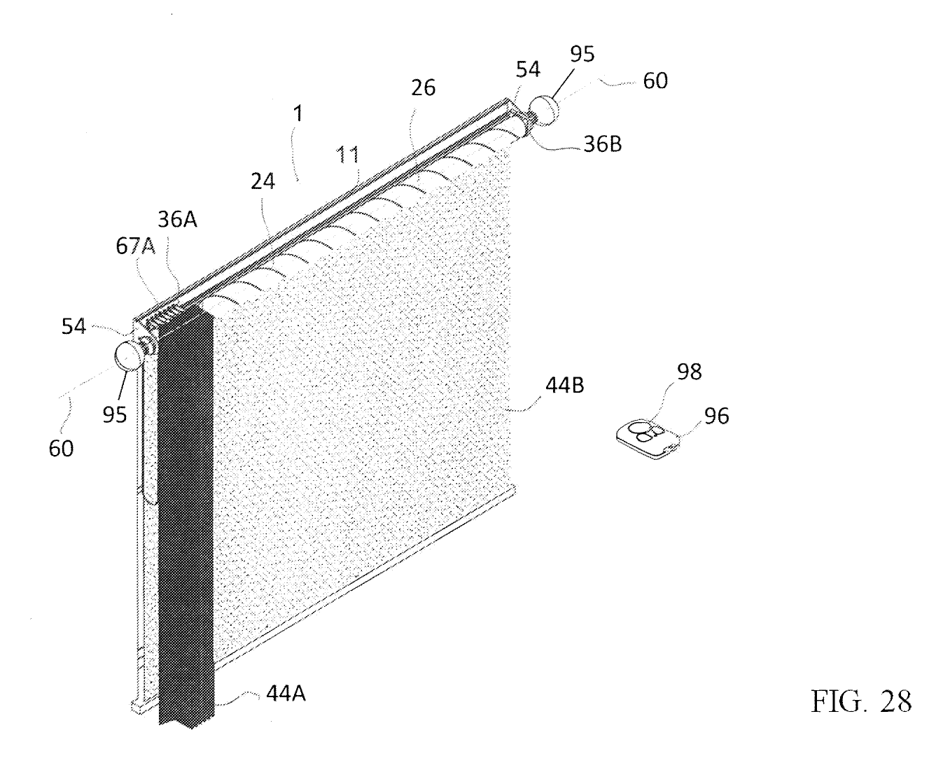

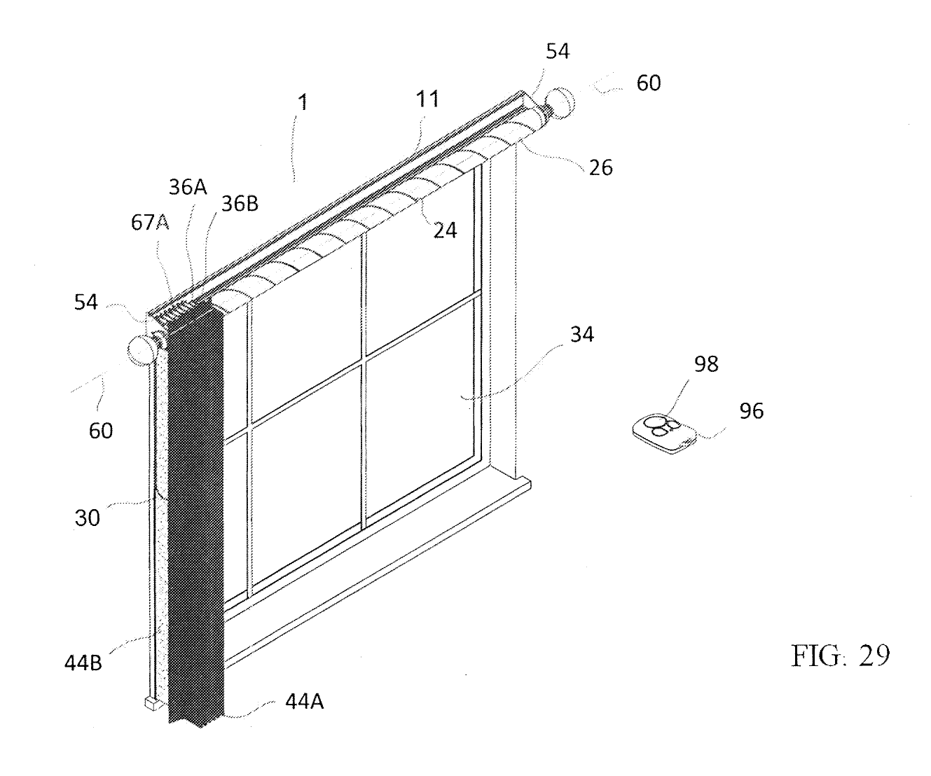

FIG. 27 illustrates a curtain assembly 1 when the outer curtain 44A is a blackout curtain in the deployed position and the inner curtain 44B is a sheer curtain in the deployed position. Therefore, in FIG. 27, the window 34 is covered by the outer curtain 44A or the blackout curtain and the inner curtain 44B. FIG. 28 illustrates a curtain assembly 1 when the outer curtain 44A is a blackout curtain in the stored position and the inner curtain 44B is a sheer curtain in the deployed position. The window 34 is covered by the sheer curtain and the blackout curtain is stored in this instance. FIG. 29 illustrates a curtain assembly 1 when the outer curtain 44A is a blackout curtain in the stored position and the inner curtain 44B is a sheer curtain in the stored position. The window 34 is left uncovered in this instance.

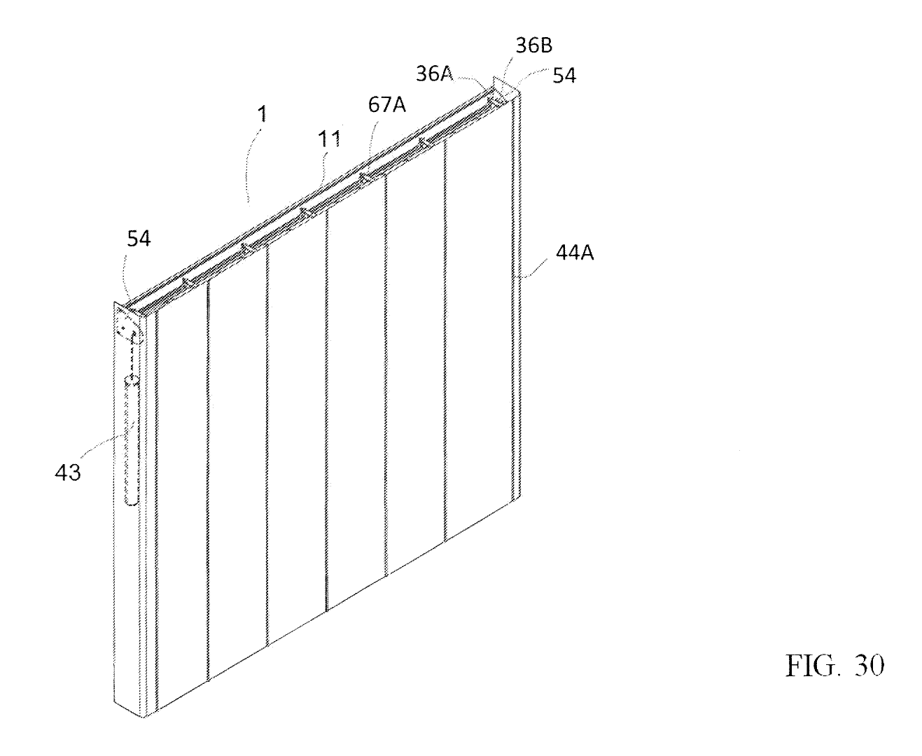

FIG. 30 illustrates the preferred embodiment curtain assembly 1 when the outer curtain 44A is a blackout curtain in the deployed position and the inner curtain 44B is a sheer curtain in the deployed position. Therefore, in FIG. 27, the window 34 is covered by the outer curtain 44A or the blackout curtain and the inner curtain 44B. Further, the outer curtain has the stationary end attached to the end bracket 54 and the movable end wrapped around the other end bracket 54 on the distal end. There is also a cut away area to show the position of an external power supply 43.

### Drive Element and Drive Section

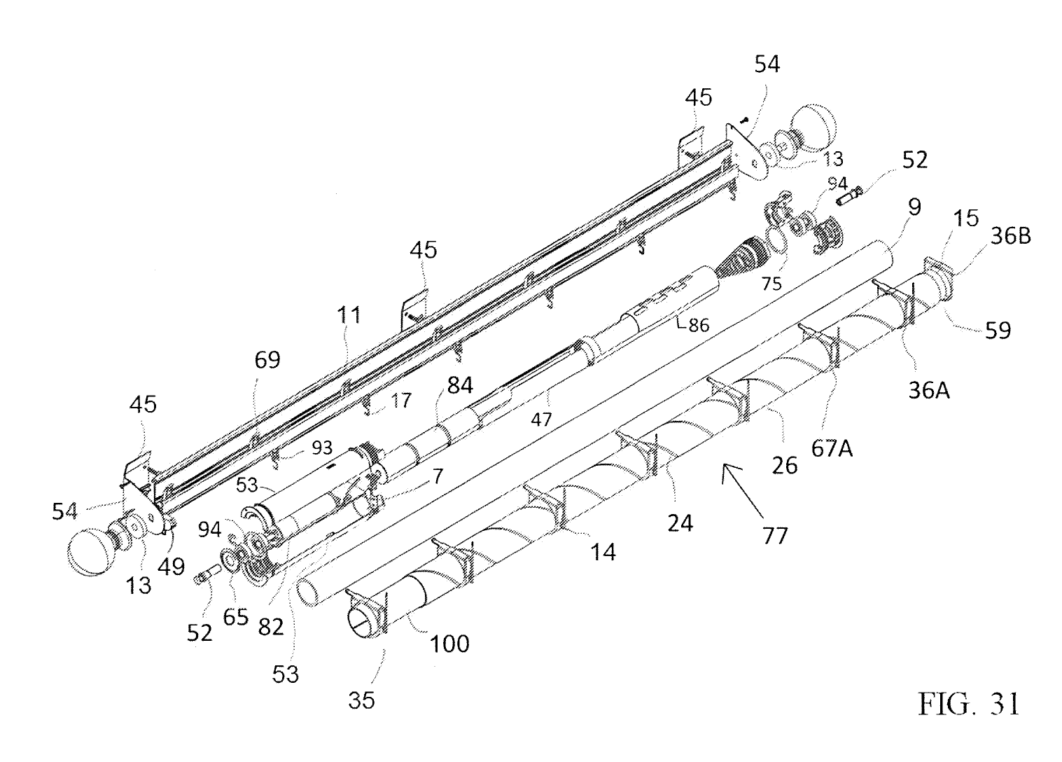

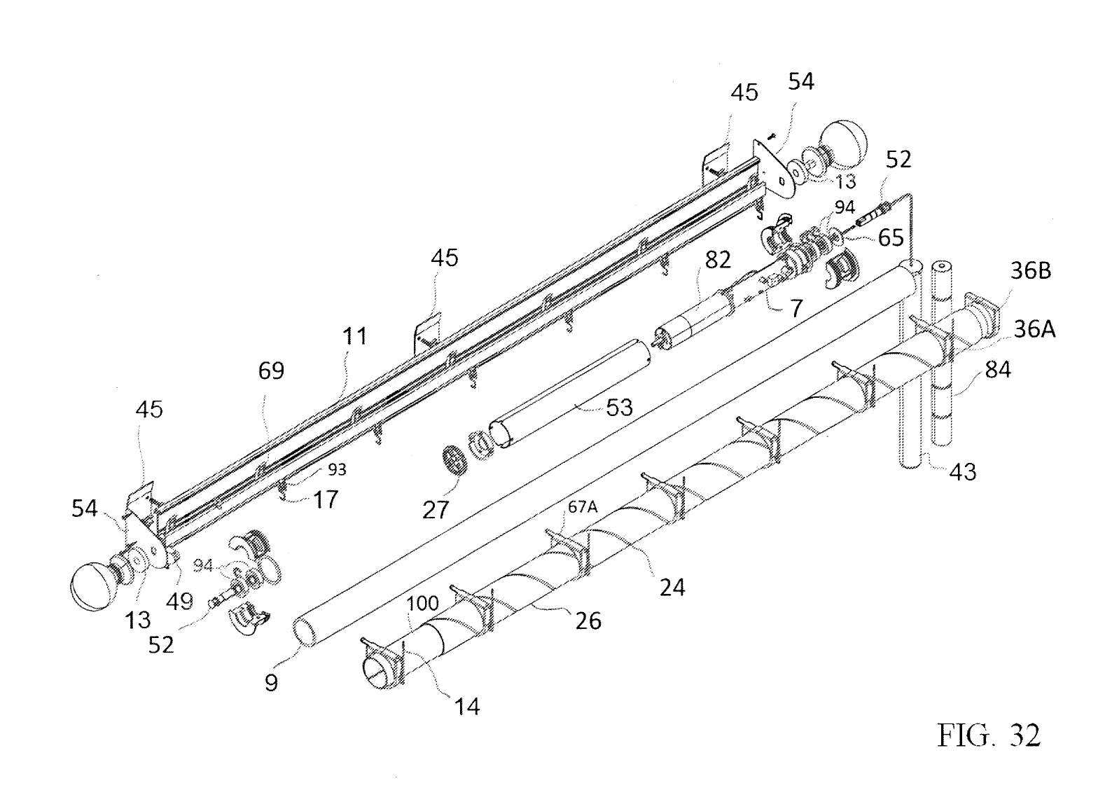

The rotatable drive element 22 will now be explained in detail below. The curtain assembly 1 includes a rotatable drive element 22. FIGS. 31 and 32 show the rotatable drive element 22 and its components in greater detail. Both the outer curtain 44A and the inner curtain 44B are connected to the rotatable drive element 22 by the outer curtain drive attachment element 36A or the inner curtain drive attachment element 5 or various attachment and suspension elements as explained below. The rotation assembly 33 which rotates the drive element 22 moves these attachment drive elements which are connected to the curtains 44A and 44B separately across the drive element 22.

The rotatable drive element 22 is designed to be installed above a window 34 similar to a traditional curtain rod. For example, as shown in FIG. 27, drive element 22 is mounted on axles 52 that are located and secured in the end brackets 54. The end brackets 54 are adapted for connection with a window frame, sash or wall. The end brackets 54 may also include a rubber mounting disk 13 that is compressed when the drive element 22 is installed to hold the drive element 22 firmly in place and minimize noise.

The drive element 22 is connected to a rotation assembly 33 for rotating the drive element 22 wherein the rotation of the drive element 22 moves the outer curtain drive attachment element 36A and the inner curtain drive attachment element 36B separately across the helical groove 24 of the drive element 22. The rotation assembly 33 may be a draw cord 72 connected to the drive element 22 or a motor 82. The drive element 22 may be rotated manually. For example, a draw cord 72 as shown in FIGS. 27-29 may be connected to the drive element 22 such that the drive element 22 can be manipulated manually to rotate when it is desired to deploy or store the curtains 44A or 44B. The use of pull cords 72is well known in the art.

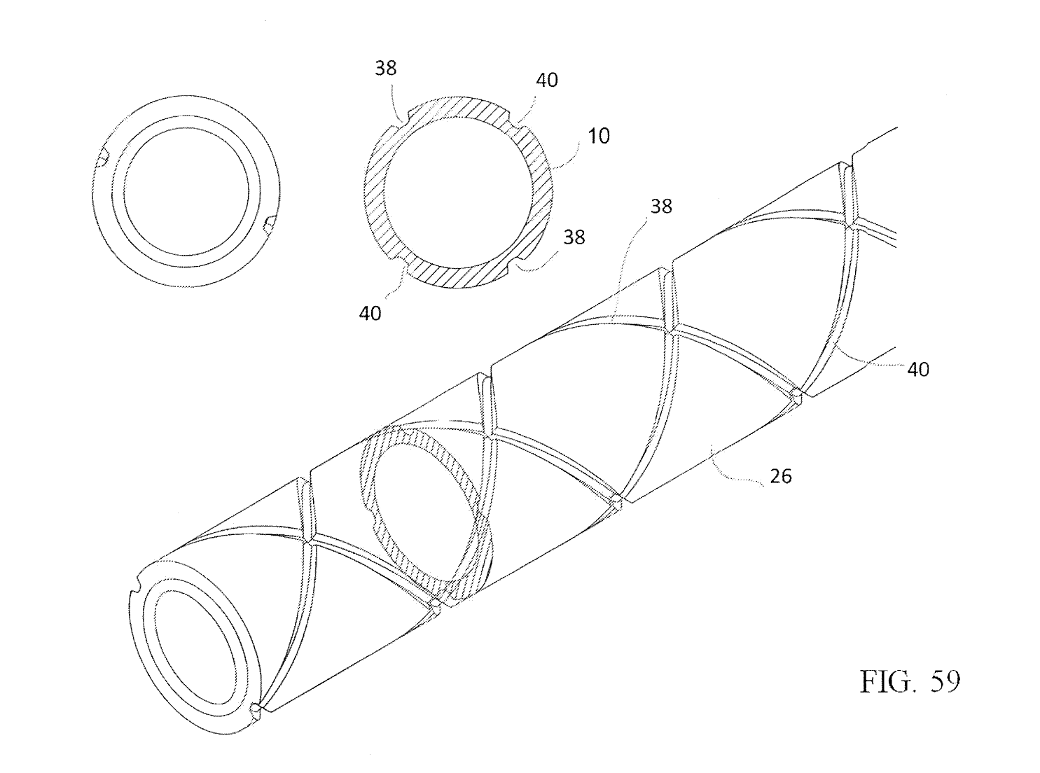

The drive element 22 may also be connected to a motor 82, which can be used to rotate the drive element 22. The motor 82 may be mounted either inside or outside the drive element 22. In one embodiment, the motor 82 is mounted inside the drive element 22 and generally concealed from plain view. Components including axles 52 and bearings 94 may also be located inside the rotatable drive element 22. A slip ring 28 may be used to transfer current from the power supply 43 external to the drive element 22 to the motor 82 in the drive element 22 as shown in FIG. 32. Alternatively, batteries 84 in a battery tube 86 may be used as shown in FIG. 31 to power the motor 82. The batteries 84 in the battery tube 86 may be in a spring loaded sleeve to assist with loading and unloading batteries 84 from the battery tube 86. In some embodiments, the motor drive adapter 27 as shown in FIG. 59 may also be used to securely attach or connect the motor 82 to the drive element 22. In other embodiments, the motor housing 53 fits tightly against the drive element 22 and turns the drive element 22 when the motor output shaft 87 is held in end bracket 54 to prevent it from turning.

In a motorized operation, the user may push a button 98 on a remote control 96 to turn on the motor 16 to rotate the drive element 22 such that the sequence selected curtain 44A or 44B moves across the drive element 22 between a stored position and a deployed position depending on the user's preference. The remote control 96 and button 98 are shown in FIGS. 27-29. In other embodiments, the remote control may respond to a voice command and send a signal to the motor controls, which then causes the motor 82 to rotate the drive element 22.

The curtain assembly 1 may also include a remote control 96 having a control board which generates a signal when the user makes a selection on the remote control 96. The control board has a transmitter which can wireless communicate with a receiver which is remotely located from the transmitter. For example, the receiver may be located in the drive element 22. The receiver receives the transmitted signal from the transmitter and transmits it to the motor 82, which will cause the motor 82 to turn on, rotate the drive element 22, and moves one of the curtains 44A or 44B.

As the drive element 22 rotates, either manually or by a motor 82, the outer curtain drive attachment element 36A or the inner curtain drive attachment element 36B is engaged on the drive element 22 and moves across the drive element 22 to either a deployed or stored position while the other curtain 44A or 44B remains in place. When the moving curtain 44A or 44B reaches the end of the drive element 22, the stationary curtain 44A or 44B will be pulled into engagement with the helical groove 24 and move across the drive element 22 to a new position.

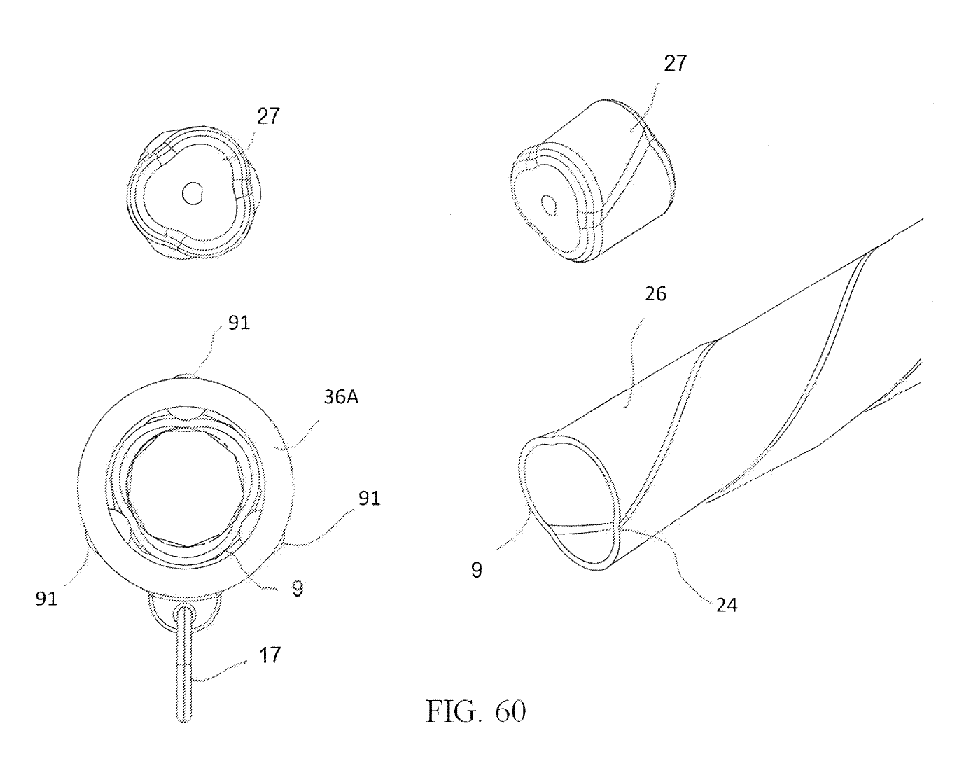

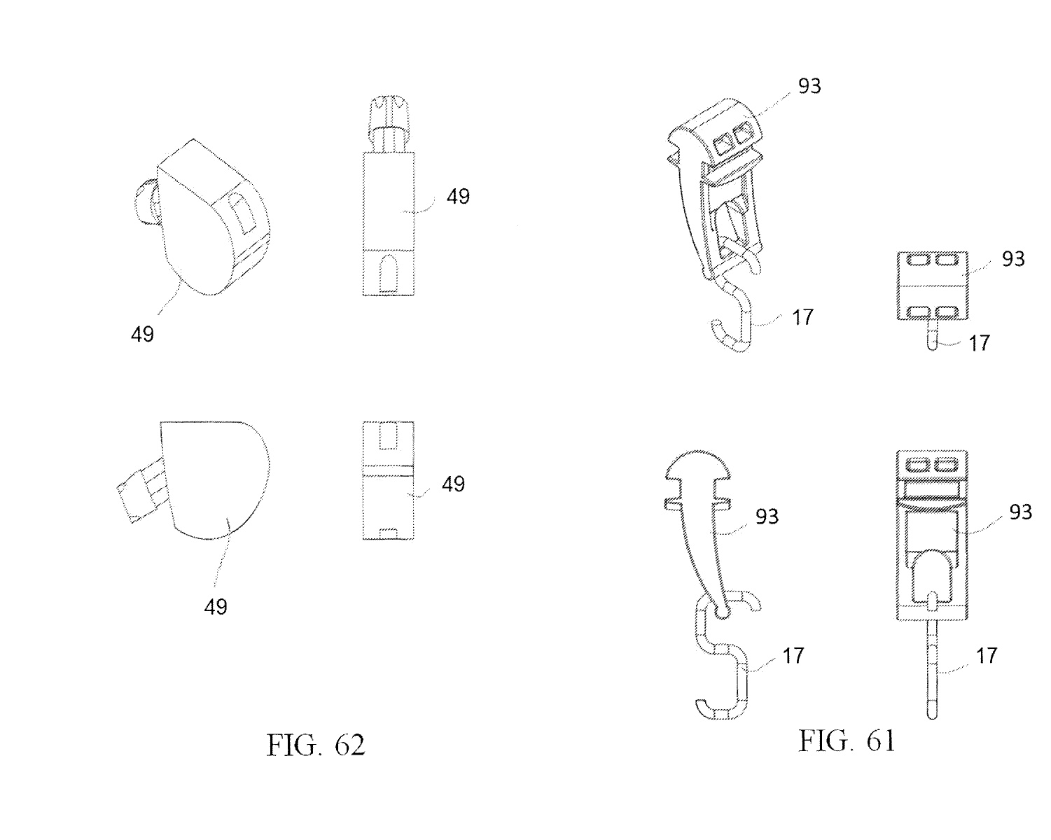

The rotatable drive element 22 is preferably cylindrical in shape as shown in FIGS. 31, 32, 34, and 59, which shows the drive element 22 having an inner tube, referred to as an inner drive element 9, and an outer tube or sleeve 63. However, the shape of inner drive element 9 and an outer tube or sleeve 63 of the drive element 22 are not limited and can be non-circular. In an alternative embodiment, as shown in FIG. 60, the rotatable drive element 22 may be tri-lobed. In this case the drive element is a spiraled tube having creases that a ball bearing can ride in.

The drive element 22 may vary in size. For example, the drive element 22 may be the width of the window 34 or it may be wider than the window 34. There is no limitation on the diameter of the drive element 22 other than space needed inside a room. Preferably, the drive element 22 is configured to mount a motor 82 inside the drive element 22 rather than mounting the motor 82 outside the drive element 22. Using the inside of the drive element 22 to conceal the motor 82 may give a more aesthetically pleasing design for a curtain assembly 1 or 20. Any number of materials may be used to fabricate the drive element 22 provided the drive element 22 can support the weight of the outer and inner curtains 44A, 44B.

The drive element 22 comprises a guide structure 24, such as a helical groove, over at least one or more portions of the length of the drive element 22. The drive element 22 has opposing distal end portions 35, 59 and may be any length along the longitudinal axis 60 of the drive element 22. The longitudinal axis 60 of the drive element 22 is shown in FIGS. 27-30. The length of the guide structure along the drive element 22 is a factor in determining how far the curtain 44A or 44B will travel across the drive element 22, i.e., the entire length of the drive element 22 as opposed to some shorter section of the drive element 22.

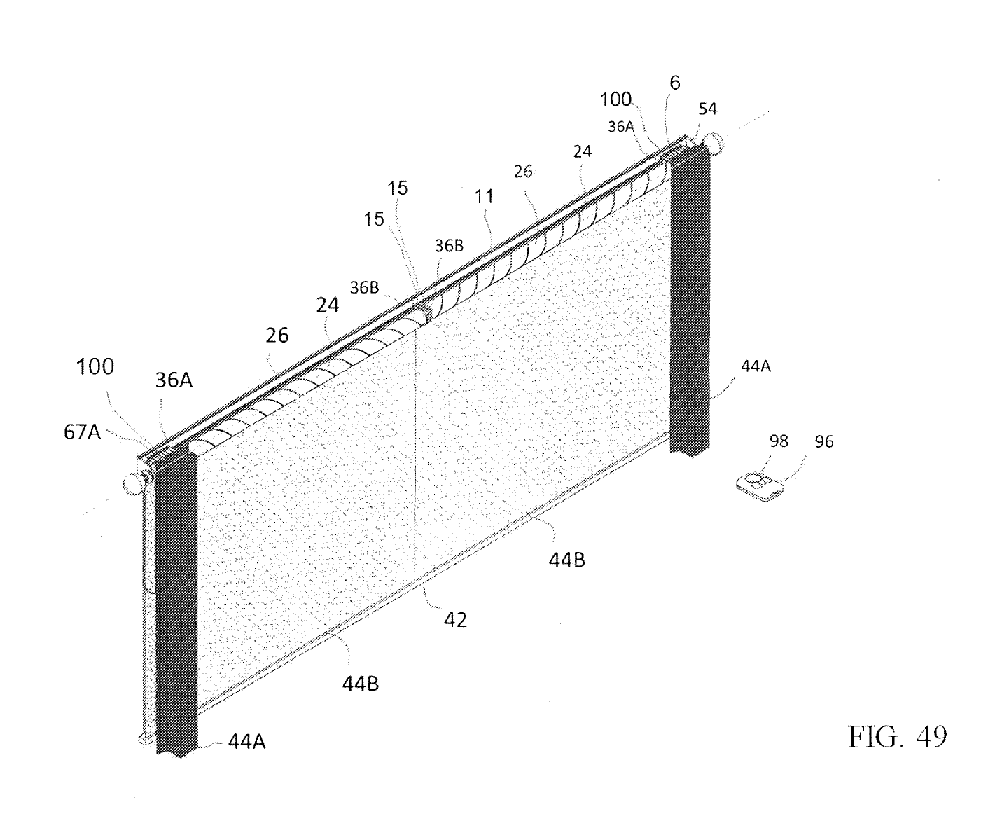

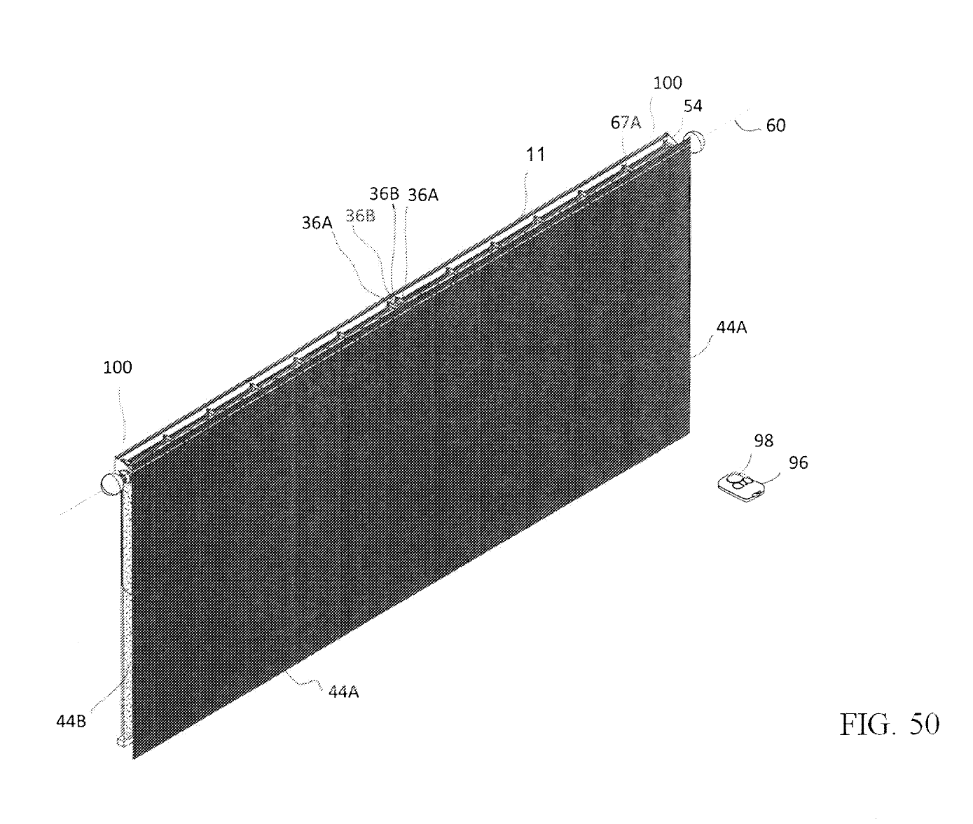

In an embodiment, the drive element 22 has at least one helical groove 24 that is formed in either a clockwise direction or a counterclockwise direction on the outer surface 26 of the drive element 22 extending from one distal end portion 35, 59 of the drive element 22 to the opposing distal end portion 35, 59 of the drive element 22. FIG. 49 illustrates a left hand drive element 22 in which the helical groove 24 is in a clockwise direction and also illustrates a right hand drive element 22 in which the helical groove 24 is in a counterclockwise direction.

In some embodiments, the drive element 22 may have two helical grooves 24, one formed in the clockwise direction and one formed in the counterclockwise direction as shown in FIG. 59. A drive element 22 having helical grooves 24 in both directions is particularly useful for center closing curtains 46 as explained below.

In the preferred embodiment, the drive element 22 may have two helical grooves 24 in the same direction, where the inner drive attachment element 36B has two teeth 5a and 5b spaced 180 degrees apart and the outer drive attachment element 36A has two teeth 4a and 4b spaced 180 degrees apart, such that tooth 4a, and tooth 5a, engages one of the helical grooves and tooth 4b, and tooth 5b, engages the other helical groove at the same time, respectively, so as to add stability with respect to driving drive attachment element 36A, and 36B, respectively.

In other embodiments, the drive element preferably has four helical grooves 24, two clockwise helical grooves 24 and two counterclockwise helical grooves 24 as shown in FIG. 59. A cross-sectional view of the rotatable drive element having four helical grooves 24, two clockwise helical grooves and two counterclockwise helical grooves is shown in FIG. 59. Helical grooves are preferably spaced approximately 180 degrees apart. The clockwise helical grooves 24 and the counterclockwise helical grooves 24 preferably opposed each other and are spaced 180 degrees apart. The profile of the helical grooves 24 is self-centering to allow the first outer drive tooth 4a and the first inner drive tooth 5a to traverse the intersection of the clockwise helical groove and the counter clockwise helical groove without binding.

The helical groove 24 forms a path through the drive element 22 as shown in FIGS. 27-30. As the drive element 22 rotates, one of the curtains 44A or 44B is pulled along the helical groove 24 across the drive element 22 into a deployed or stored position. Both the clockwise and the counterclockwise helical grooves 24 will cause the curtain 44A or 44B to move axially across the drive element 22 when the drive element 22 rotates and the curtain drive elements 36A or 36B are engaged with the helical groove 24.

The helical grooves 24 may be formed by forming grooves into the outer surface 26 of the drive element 22 such that the grooves are recessed from the outer surface 26 of the drive element 22. Alternatively, the helical grooves 24 may be formed as protrusions that project or bulge from the outer surface 26 of the drive element 22. The protrusions may be formed any means, for example, by winding material around the outer surface 26 of the drive element 22.

The angle of the helical groove 24 may vary and therefore, may differ in the amount of time that it takes to travel across the drive element 22. For example, a helical groove 24 with a larger angle may create a shorter path for the curtain 44A, 44B to travel and result in a faster moving curtain 44A or 44B for a given rotational speed of the drive element. In some embodiments, the angle of the helical grooves 24 may vary along the drive element 22 such that the curtain 44A, 44B may move at different speeds along the drive element 22, for a given rotational speed of the drive element, if desired. The angle of the helical groove 24 preferably varies from 30 degrees to 60 degrees and is most preferably 45 degrees.

In an alternative embodiment, the drive element 22 may be formed from a drive sleeve or outer tube 63 that is sized to fit around a portion of an inner drive element 9, which can be, for example, an inner tube 61. In this case, the drive sleeve has at least one helical groove 24 in a clockwise or counter clockwise direction formed on the outer surface of the sleeve. The drive element 22 must be able to translate the torque from the rotation assembly to axially movement of the curtain support or attachment elements 36A, 36B across the drive element 22, and the drive sleeve may be made from a high lubricity material. Therefore, the drive sleeve can be secured to the inner drive element 9 such that the sleeve does not slide up or down the drive element 22 or rotate around the inner drive element 9. It may also be desired to remove the sleeve from the inner drive element 9 and replace it with another sleeve. Using a sleeve to form the drive element 22 has the advantage that the helical groove 24 or the length of the drive element 22 may be easily changed by removing the sleeve and replacing it without fabricating a new drive element 22.

### Attachment Elements and Teeth

In some embodiments, the curtain assembly 1 may include at least one outer curtain drive attachment element 36A connected to the drive element 22 and has a drive teeth 4a and 4b that communicates with the helical groove 24 to move the outer curtain drive attachment element 36A axially along the drive element 22 when the drive element 22 is rotated. The outer curtain drive attachment element 36A is connected one end of the outer curtain 44A. The curtain assembly 1 may include at least one inner drive attachment element 36B connected to the drive element 22 and has a drive teeth 5a and 5b that communicates with the helical groove 24 to move the inner drive attachment element 36B axially along the drive element 22 when the drive element 22 is rotated. The inner drive attachment element 36B is connected one end of the inner curtain 44B.

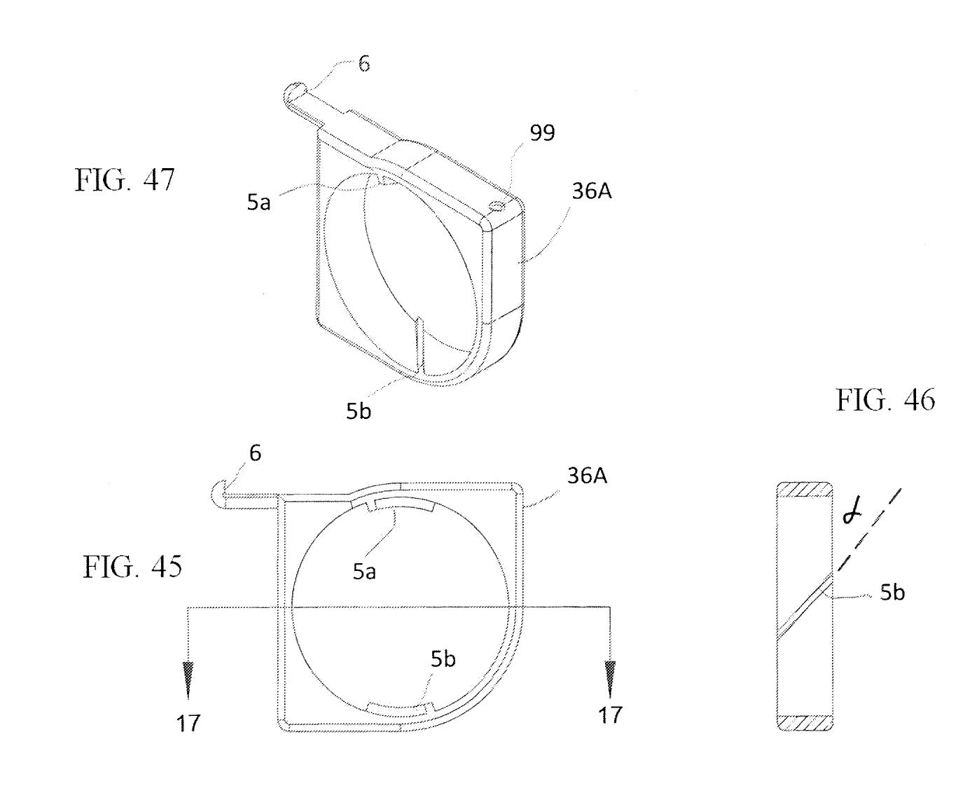

FIGS. 45-47 show the front and cross-sectional views of the outer curtain drive attachment element 36A as well as the drive teeth 5a and 5b. Both the first outer drive tooth 5a and the second outer drive tooth 5b are configured to communicate with the helical groove 24 of the drive element 22. The first outer drive tooth 5a and the second outer drive tooth 5b are positioned inside the outer drive attachment element 36A which shows the angle α of one drive tooth and both the angles are 45 degrees.

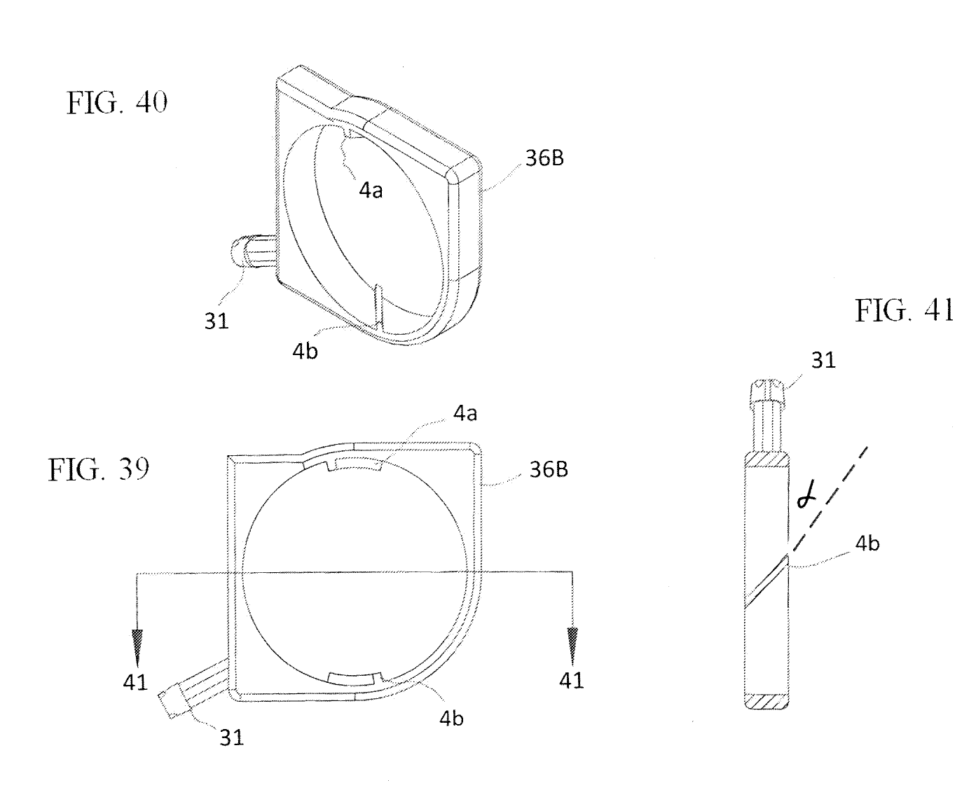

FIGS. 39-41 show the front and cross-sectional views of an embodiment of an inner drive attachment element as well as the drive teeth 4a and 4b. Both the inner drive tooth 4a and the inner drive tooth 4b are configured to communicate with the helical groove 24 of the drive element 22. The inner drive tooth 4a and the inner drive tooth 4b are positioned inside the drive attachment element which shows the angle α of one drive tooth and both the angles are 45 degrees. In this embodiment, the inner carrier attachment post 31 is located at a portion of the inner drive attachment element designed to interconnect with a carrier in the inner curtain carrier track 81.

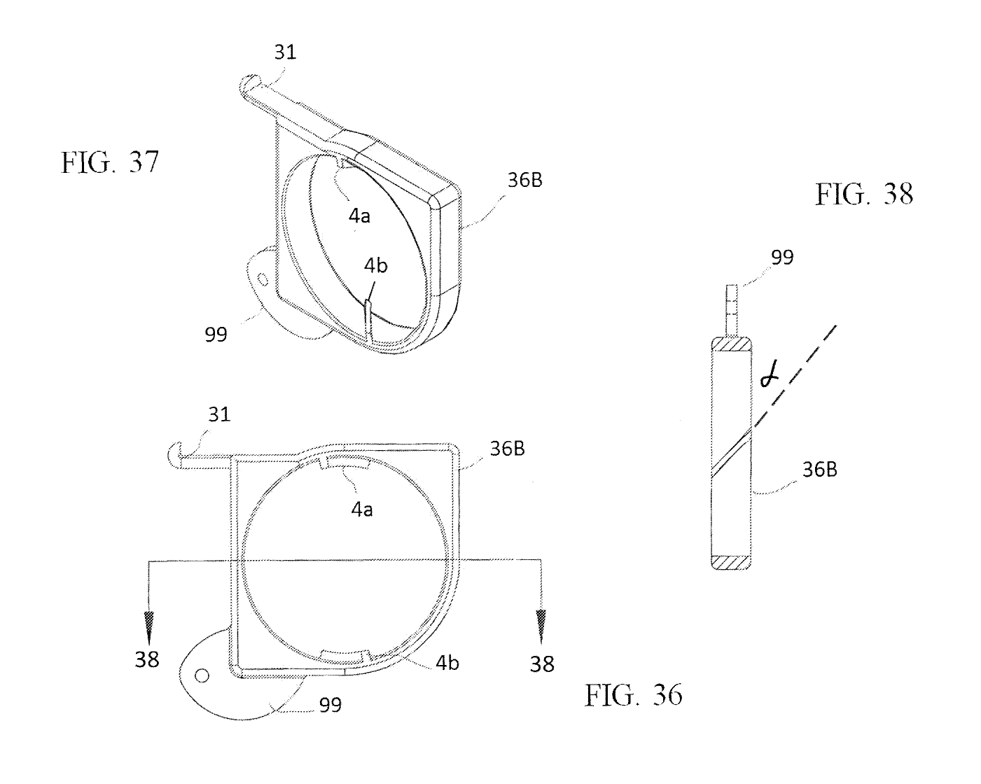

FIGS. 36-38 show the front and cross-sectional views of an alternative inner drive attachment element 36B as well as the drive teeth 4a and 4b. Both the inner drive tooth 4a and the inner drive tooth 4b are configured to communicate with the helical groove 24 of the drive element 22. The inner drive tooth 4a and the inner drive tooth 4b are positioned inside the drive attachment element which shows the angle α of one drive tooth and both the angles are 45 degrees. In this embodiment, the inner carrier attachment post 31 can be the same as the outer carrier attachment post 6 of FIGS. 45-47 designed to interconnect with a carrier in the outer curtain carrier track 12, and the attachment points of the inner curtain can attach via hooks to the receiver for hooks 99.

As shown in various figures, the outer curtain outer curtain drive attachment element 36A and the inner curtain drive element 36B are ring-shaped and slide over the drive element 22. Although a different construction may be used for the outer curtain outer curtain drive attachment element 36A and the inner curtain drive element 36B, they are be able to connect to the appropriate ends of the outer curtain 44A and the inner curtain 44B and engage the helical groove 24 and move across the drive element 22.

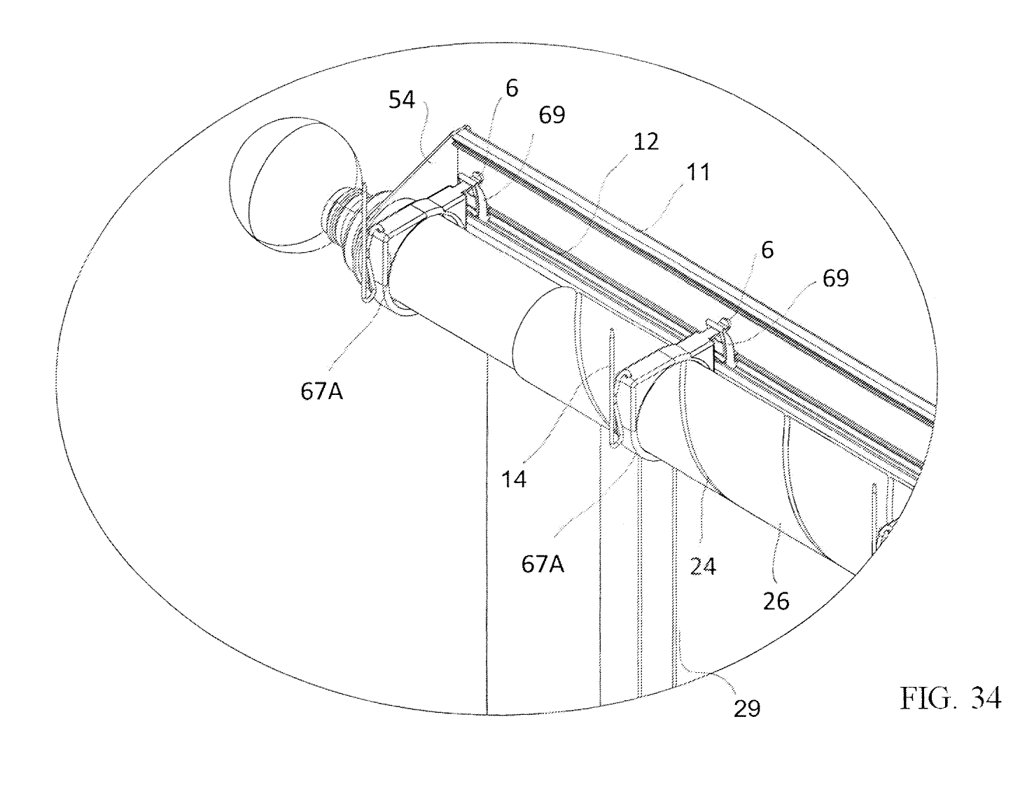

The outer curtain outer curtain drive attachment element 36A is preferably provided with a slot or a hole 99 into which a traditional curtain hooks or pins can be used to connect the ends and upper edge of the outer curtain 44A to the appropriate attachment element. FIG. 34 illustrates an example of the hole 99 and a pin hook 14 on an outer curtain idler attachment element 67A. In another embodiment, as shown in FIG. 60, a traditional curtain ring is used. The inner curtain 44B is suspended by S-hooks 17 in inner curtain carrier track 81 in support guide 11. Curtain pins, hooks and rings are well known in the art to hang curtains 44A, 44B.

The drive tooth 5a on the outer drive attachment element 36A and the drive tooth 4a on the inner drive attachment element 36B may have the same construction. The outer drive tooth 5a and the inner drive tooth 4a are both designed to engage with the helical groove 24 of the drive element 22 to drive the curtain 44A or 44B across the drive element 22. In one embodiment, the drive tooth 5a is formed on an angle inside the body of the outer curtain drive attachment element 36A. The angle is specifically designed to engage the helical groove 24 on the drive element 22. A design consideration is to maximize the contact between the rotating drive element 22 and the outer drive attachment element 36A and/or inner drive attachment element 36B to carry the weight of the curtain 44A or 44B. The outer curtain outer curtain drive attachment element 36A and the drive teeth 5a and the inner curtain drive attachment element 36B teeth and the inner curtain teeth 4a, in some embodiments of the present invention, are adjustable. The adjustability of these components allow the user of the curtain assembly to set the correct timing on the location of the outer curtain drive attachment element(s) 36A and inner curtain drive attachment element(s) 36B in relationship to the helical grooves 24.

Although the curtain support described in the embodiments above is an outer curtain outer curtain drive attachment element 36A and an inner curtain drive attachment element 36B, other embodiments for the curtain support may be used as well.

### Outer Curtain Idler Attachments

The curtain assembly 1 may further comprise a plurality of outer curtain idler attachment 67A connected to the rotatable drive element 22 for sliding movement along the drive element 22 wherein the adjacent ends of the outer curtain 44A that are not connected to the outer curtain drive attachment element 36A are suspended from the drive element 22 using one or more outer idler attachment elements 67A.

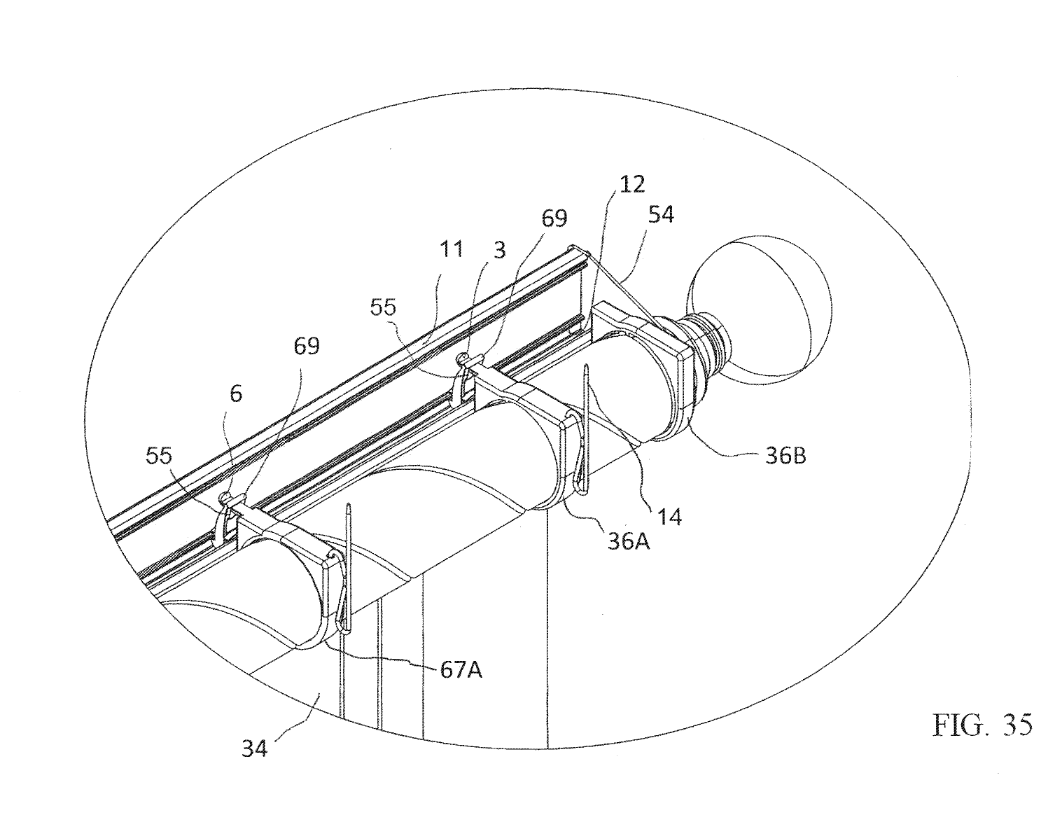

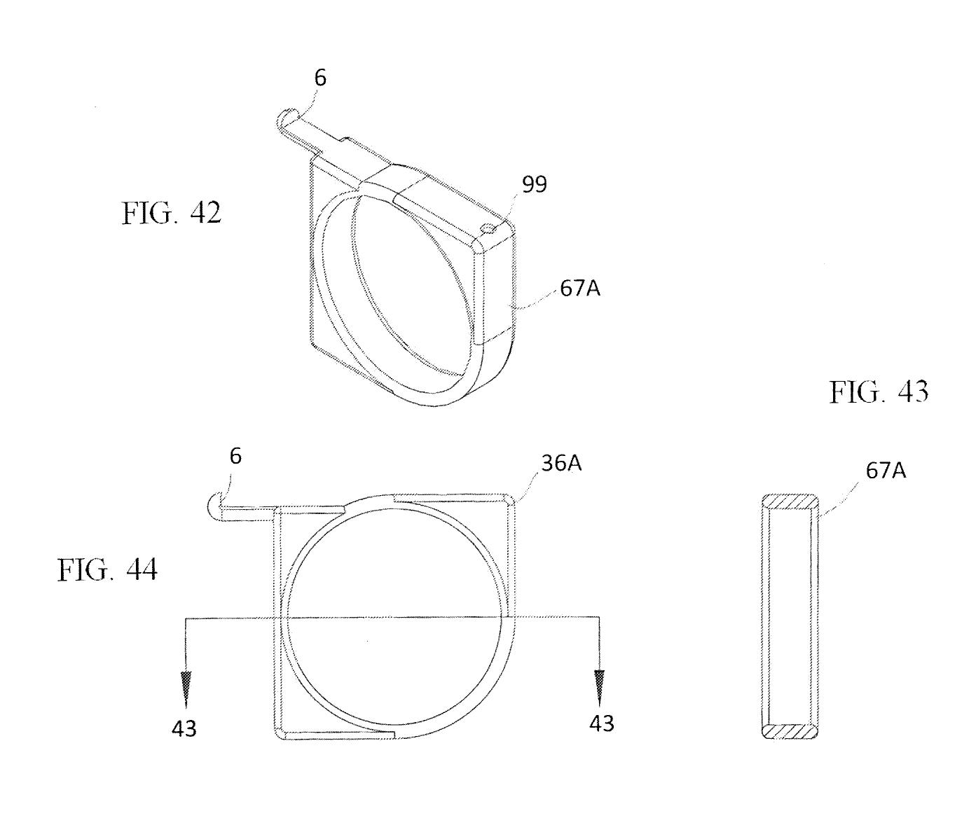

The outer curtain 44A has the movable end connected to the outer drive attachment element 36A. The non-movable end of the outer curtain 44A can be attached to the end bracket 54. Outer idler attachment elements 67A may be used to suspend the remaining attachment points of outer curtain 44A to the drive element 22. The outer idler attachment elements 67A are connected to the rotatable drive element 22 as shown in FIGS. 31-32 and 34-35. An enlarged view of the outer idler attachment 67A is shown in FIGS. 42-44.

The outer idler attachment 67A may be shaped similar to the outer drive attachment element 36A and inner drive attachment element 36B. The outer idler attachment 67A can have a smooth bore to allow free movement along the drive element 22 of the tube as the curtain 44A is moved or may have a tooth on each outer idler attachment 67A to assist in the movement of the curtain 44A.

The outer idler attachments are also linked to the outer curtain carriers 69by the insertion of the outer carrier attachment post 6 on the outer idler attachment elements 67A into the aperture 55 on outer curtain guide carrier 69. The outer current carriers are then positioned in the outer curtain carrier track 12 in the support guide 11. This prevents the outer curtain idler attachment 67A from rotating or binding the rotation of the element 22.

The outer curtain idler attachment 67A are preferably provided with a slot or a hole 99 into which a traditional curtain hook or pin can be used to attach the ends of the outer curtain 44A to the outer curtain idler attachment. FIG. 42 illustrates an example of this hole 99 and a pin hook 14 on an outer curtain idler attachment 67A.

The inner curtain 44B can have the stationary end connected to the end bracket 54 and other end attached to the inner drive attachment element 36B. The inner curtain carrier track 81 and hooks 17 may be used to suspend the remaining attachment points of the inner curtain 44B to the inner curtain carrier track 81 of the support guide 11 along the axis of the drive element 22.

The outer curtain 44A is connected to the outer drive attachment element 36A and the inner curtain 44B is attached to the inner drive attachment element 36B. This arrangement ensures that the outer curtain 44A and inner curtains 44B drive attachment elements 36A and 36B are linked together on the same drive element 22 and they are able to move in sequence across the drive element 22.

### Outer Driver Stall Area and Inner Driver Stall Area

The curtain assembly 1 preferably includes at least one outer driver stall area 100 positioned to one end of the drive element 22 to engage and disengage the outer drive attachment element 36A from the helical groove 24 of the drive element 22.

The curtain assembly 1 also preferably includes at least one inner driver stall area 15 positioned on the distal end of the drive element 22 that is configured to hold the inner curtain drive element 36B in place while the outer drive attachment element 36A moves through the drive element 22.

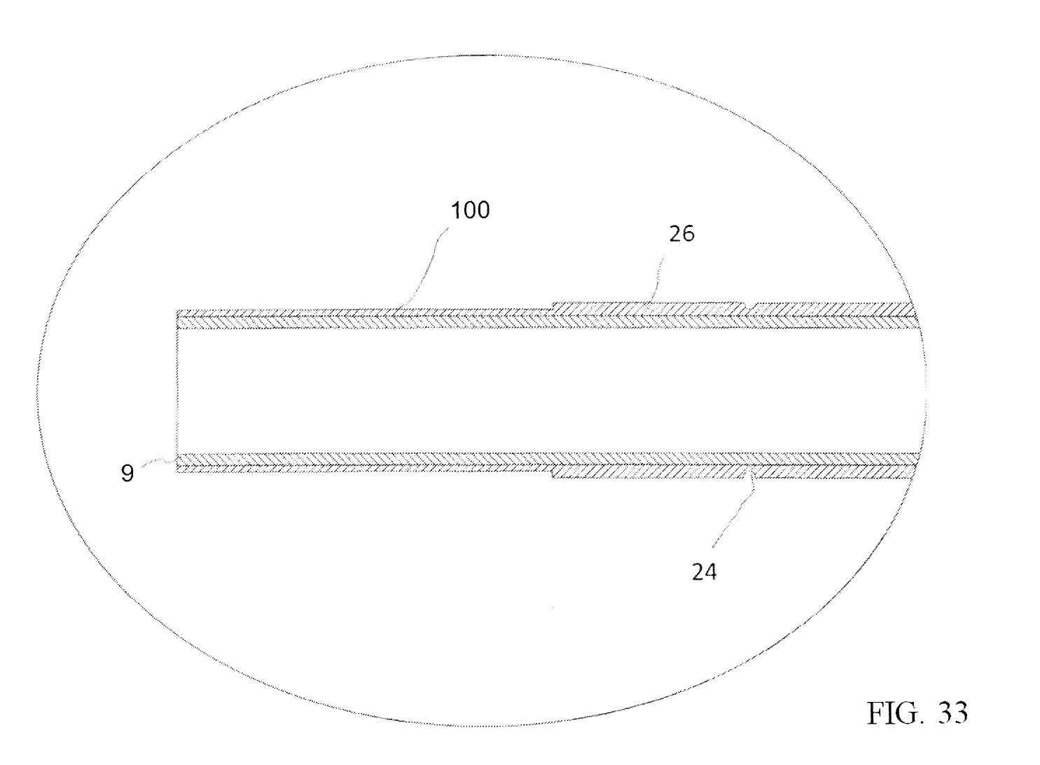

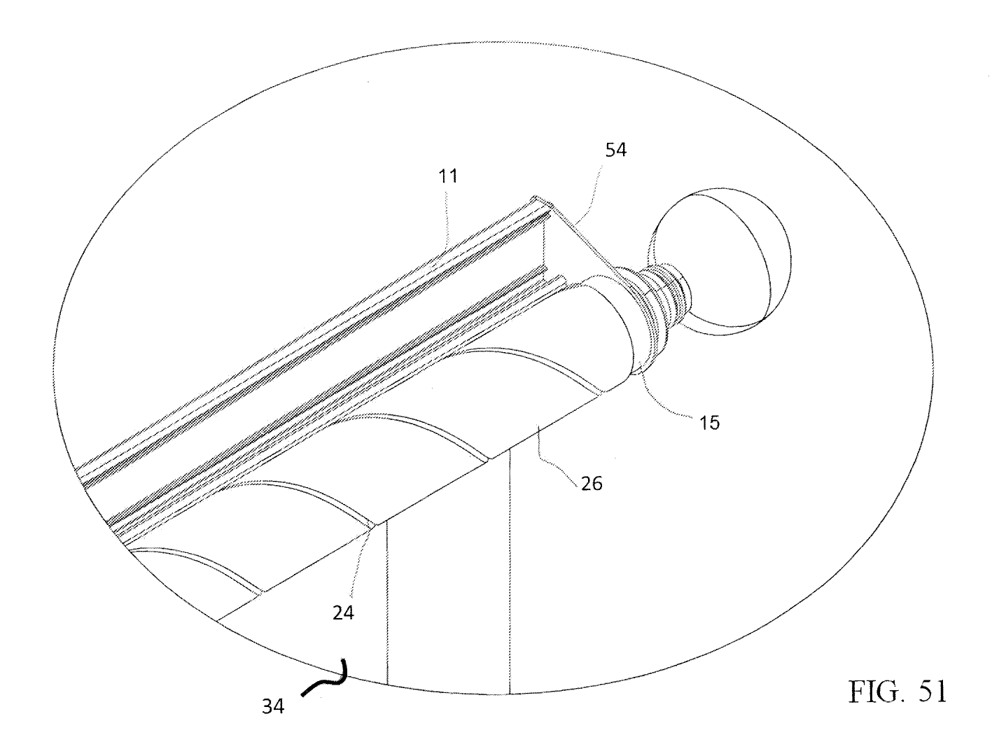

FIGS. 33-34 show an outer driver stall area 100 at one distal portion 35, 59 of the drive element 22. FIG. 51 shows the inner driver stall area 15 at the opposing distal end 35, 59 of the drive element 22. FIG. 49 shows a rotatable drive element 22 having an outer driver stall area 100 at each distal end portion of the drive element 22 and an inner driver stall area 15 positioned in between the two stall areas 100. The rotatable drive element 22 shown in FIG. 49 will accommodate the outer curtains 44A and inner curtains 44B, as center closing curtains.

Enlarged views showing details of the outer driver stall area 100 are shown in FIG. 34. The outer driver stall area 100 is a section of the drive element 22 along the drive element 22 without a helical groove 24 formed on the outer surface 26 of the drive element 22. The outer driver stall area 100 interrupts the movement of the outer curtain 44A or the inner curtain 44B along the helical groove 24 therefore allowing the curtain assembly 1 to change which attachment element (either the outer curtain drive attachment element 36A or the inner curtain drive element 36B) is engaged with the helical groove 24.

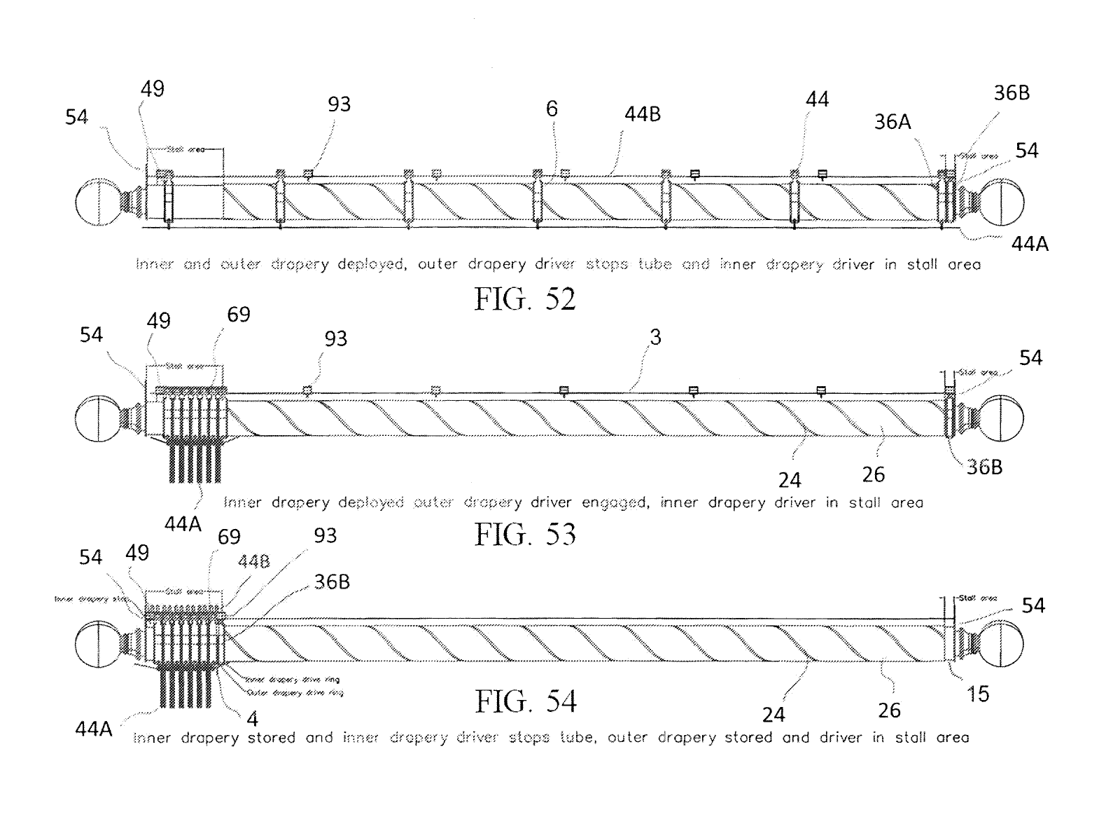

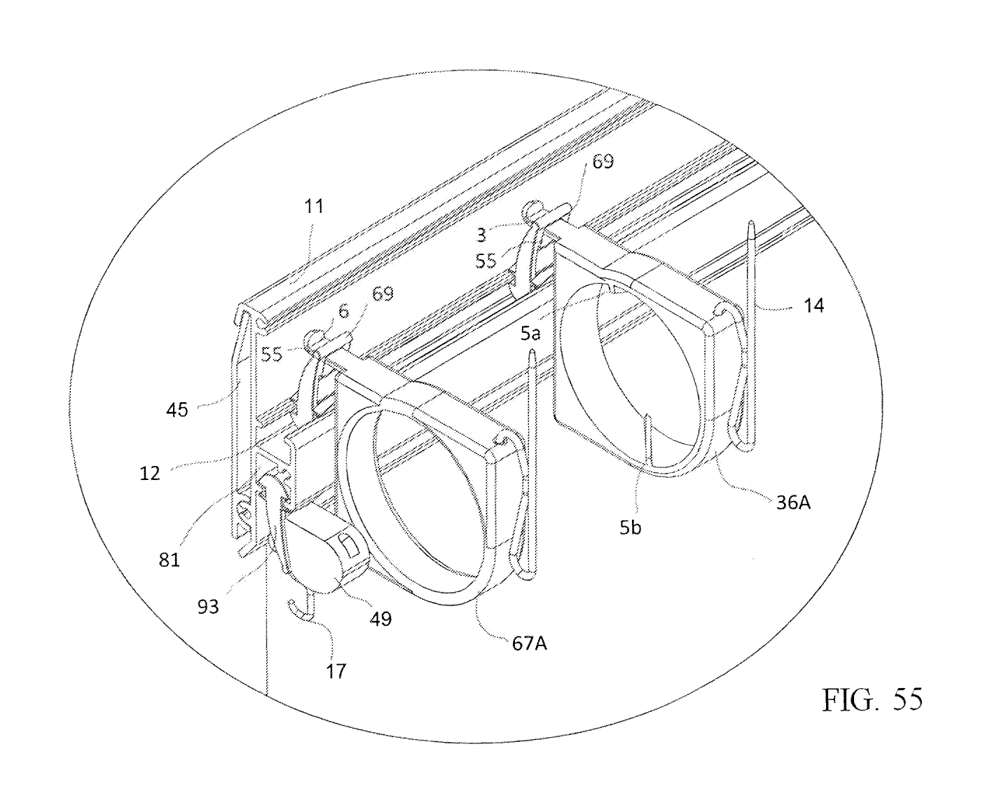

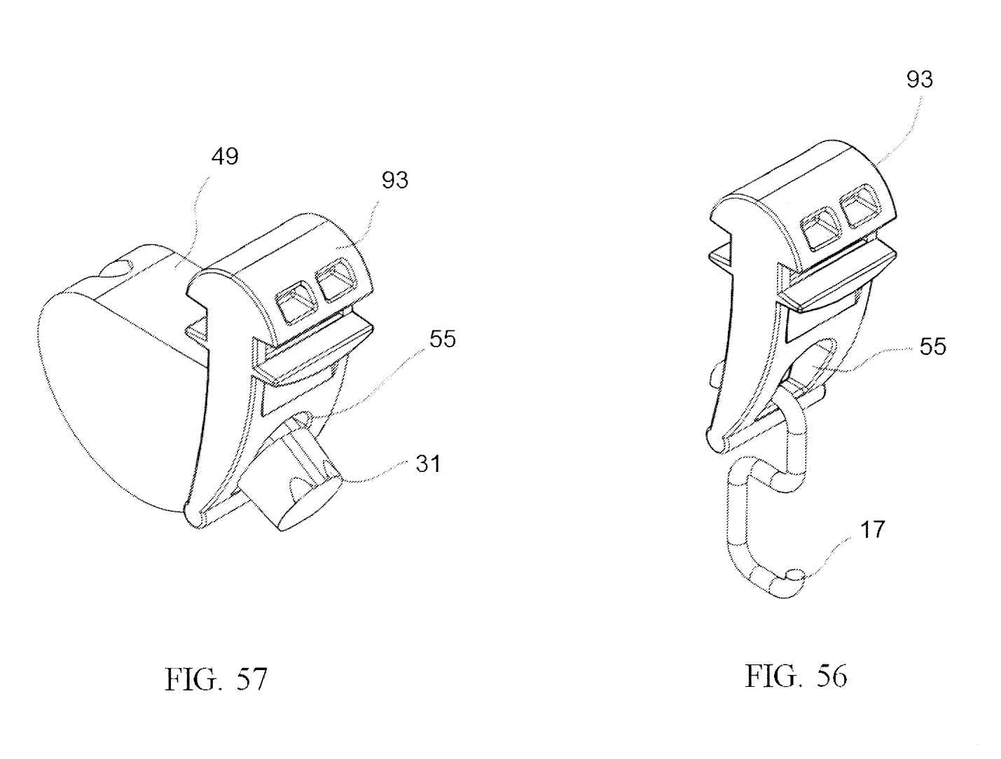

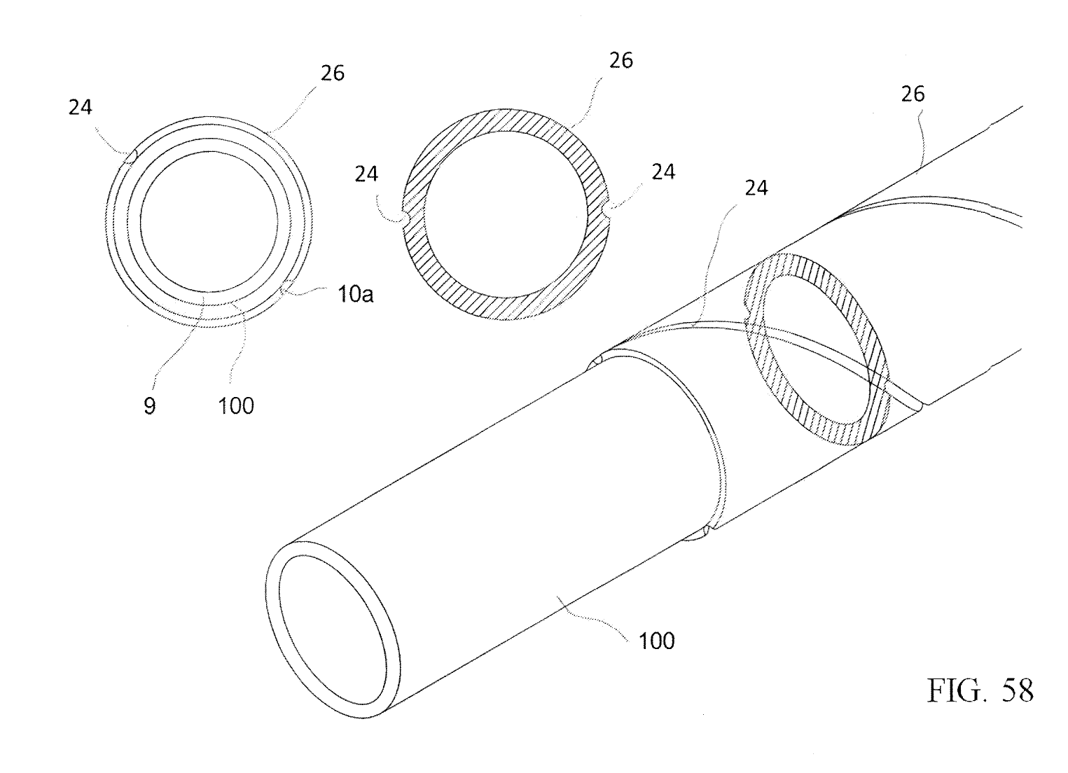

Referring to FIGS. 52-54, the outer driver stall area 100 also serves to collect or provide a space for the outer curtain idler attachment elements 67A as well as the outer curtain drive attachment element 36A. For example, when the outer curtain drive attachment element 36A is engaged and moves through the drive element 22, it will reach the outer driver stall area 100 at the end of the drive section. The outer driver stall area 100 stops the movement of the outer curtain drive attachment element 36A in the helical groove 24 and temporarily stores the outer curtain drive attachment element 36A. The outer curtain idler attachment elements 67A that are holding the remaining adjacent end of the curtain 44A are pushed by the outer curtain drive attachment element 36A and ultimately stack up in the outer driver stall area 100 until the outer curtain drive attachment element 36A becomes disengaged with the helical groove 24 and will remain stalled until the drive element 22 rotates in the opposite direction. As this disengagement occurs, the outer curtain drive attachment element 36A pushes against the outer curtain idler attachment 67A in the outer driver stall area 100 which moves the inter-curtain engager 49 toward the end bracket 54. The inner curtain 44B, being the correct length, pulls the inner curtain drive element out of the inner driver stall area 15 and into engagement with the helical grooves 24.

In some embodiments, the inner driver stall area 15 is positioned at the distal end 59 of the drive element 22 opposite the outer driver stall area 100 and functions to hold the inner curtain drive element 36B stalled in place. In other embodiments, at least one inner driver stall area 15 is positioned between two outer driver stall areas 100, as shown in FIG. 49. The position of the inner driver stall area 15 on the drive element 22 defines the end of the portion of the drive element 22 where the inner curtain drive element 36B travels on the drive element 22. As described above, FIG. 27 shows a curtain assembly 1 when the outer curtain 44A (blackout) is in the deployed position and the inner curtain 44B is also in the deployed position. At this moment, the outer curtain 44A is fully extended and the curtain drive attachment element 36A is in the helical groove 24 at one distal end of the drive element 22 and the inner curtain drive element 36B is in the inner driver stall area 15 at the same end of the drive element 22. To change the positions of the curtains such that the outer curtain 44A is in the stored position and the inner curtain 44B stays in the deployed position as shown in FIG. 28, the drive element 22 starts to rotate in the opposite direction. The rotation of the drive element 22 will move the outer curtain drive attachment element 36A, attached to outer curtain 44A, collapsing curtain 44A into the stored position until outer curtain drive attachment element 36A moves into the outer driver stall area 100 where it will push against the outer idler attachment elements 67A in the outer driver stall area and force the inter-curtain engager 49 toward the end bracket 54 creating a tug pressure on the inner curtain 44B and the inner curtain drive element 36B because the inner curtain 44B is the correct length and extended. This tug pressure pulls the inner curtain drive element 36B out of the inner driver stall area 15 and into engagement with the helical groove 24 positioning the curtains as shown in FIG. 28. When the inner curtain 44B is fully extended, the inner curtain drive element 36B will move into the inner driver stall area 15. Because the inner curtain is now extended, the outer curtain drive attachment element 36A will be pulled into the helical groove 24 prepared to deploy the outer curtain 44A. Because the inner driver stall area 15 does not have a helical groove 24, the inner curtain attachment 36B element is prevented from moving or stalled along the drive element 22.

As the outer drive attachment element 36A moves through the drive element 22, the outer curtain 44A will move from the stored position to the fully deployed position and the outer drive attachment element 36A moves up to and against the inner curtain drive element 36B in the inner driver stall area 15 and stops the drive element 22 from rotating. The curtain assembly 1 will then be as shown in FIG. 27, with the outer curtain 44A in the deployed position and the inner curtain 44B in the deployed position.

To move the inner curtain 44B to the stored position as shown in FIG. 29, the drive element 22 will rotate and the outer drive attachment element 36A moving into the outer driver stall area 100 will pull the inner curtain drive element 36B from the inner driver stall area 15 thereby engaging the inner curtain drive element 36B with the helical groove 24. The inner curtain drive element 36B will move the curtain 3 through the drive element 22 from the deployed position to the stored position at the other distal end of the drive element 22 until the inner curtain drive element 36B pushes against the outer drive attachment element 36A and stops the drive element 22 from rotating. At this point, the inner drive attachment element 36B is engaged with the helical groove 24.

### Guide Mechanism

The curtain assembly 1 preferably includes a support guide 11 wherein the guide means facilitates the movement of the outer and inner curtains 44A, 44B along the drive element 22 without misalignment. The support guide 11 may also assist with the spacing of the curtain panels when the outer curtain 44A or the inner curtain 44B is fully extended in the deployed position.

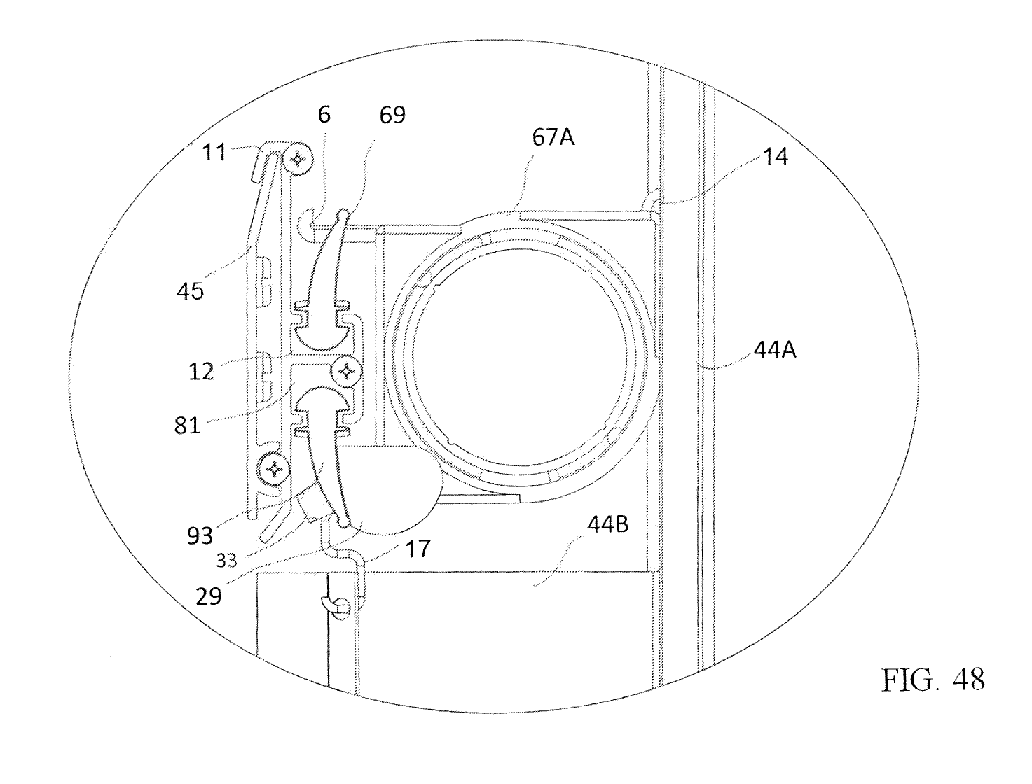

In one embodiment, the support guide 11 is an elongated pair of channels positioned parallel to the rotatable drive element 22. The support guide 11 is shown in several of the figures, including an end view in in FIG. 48. The inner curtain carrier track 81 and the outer curtain carrier track 12 are the same part but are numbered differently and discussed differently because their functions are different. The inner curtain carriers 93 have apertures 55 where an inner carrier attachment post 31 on the inner curtain drive element 36B is inserted at one end of the inner curtain and an inner carrier attachment post 31 on the inter-curtain engager 49 is inserted on the other end. The remaining inner curtain carriers 93 have S-hooks 17 inserted into the aperture 55 as known in the art.

The outer drive attachment element 36A and the outer curtain idler attachment 67A preferably have a hanger pin hole 99 wherein the pin hooks 14 are connected to the attachment elements and support the outer curtain 44A. Further, these attachment elements 36A and 67A to the outer curtain 44A are guided and held from rotation by the insertion of the outer carrier attachment posts 6 into the apertures 55 in curtain carriers 69 riding in the outer curtain carrier track 12 in support guide 11.

This arrangement provides the user with the option of manually operating the movement of the curtains 44A or 44B across the drive element 22. For example, the user may decide to manually operate the curtain assembly 1. The user could turn off the motor 82 and rotate the drive element 22 manually by using the pull cord 72.

The motor 82 for the curtain assembly 1 may be programmed from the factory with a preset number of drive element 22 revolutions to move the curtain the width of the window 34 opening. However, there are a variety of reasons why this preset number of revolutions may change. For example, the drive element 22 may be shortened to accommodate a narrower window 34.

Therefore, the initial setup of the motor 82 may be able to count the number of revolutions the drive element 22 makes to fully open and fully close the curtains 44A or 44B. This may be accomplished by a setup routine where pressing a program button 98 on a remote control 96 once to start the motor 82 moving the curtain 44A, 44B and then pressing the button 98 another time to stop the movement which will store the number of revolutions the curtain 44A, 44B has moved.

The number of revolutions can be confirmed by pressing the program button 98 a third time, which will reverse the motor 16 and move the curtain 44A, 44B in the opposite direction. Pressing the program button 98 a fourth time will stop the curtain 44A, 44B, compare the counts, and set a new count in the memory to complete the set up routine. If the program button 98 on the remote control 96 is not pressed the inner time, the motor 82 will run until the preset count is reached, then the motor 82 will shut off. If the number of revolutions is ever lost, the controls can reset a zero position when the outer curtain drive attachment element 36A stops the drive element 22 from rotating when the outer curtain 44A is fully deployed, as shown in FIG. 52 or when the outer curtain 44A and the inner curtain 44B are fully stored and the inner curtain drive element 36B stops the drive element 22 from rotating, as shown in FIG. 54.

In specific embodiments, the drive element 22 stops rotating when the inner driver attachment element 36B and the outer driver attachment element 36A are brought into contact at either end of the drive element. When the inner driver attachment element 36B and the outer driver attachment element 36A are brought into contact, the inner driver attachment element 36B and the outer driver attachment element 36A bind together and their teeth bind in the drive element's grooves. The interconnection of the inner driver attachment element 36B and the outer driver attachment element 36A to the support guide 11 in opposite orientations helps to cause this binding. Once the inner driver attachment element 36B and the outer driver attachment element 36A bind together, the drive element is bound, and the controller board senses that the driver element is no longer rotating and stops running the motor.

In specific embodiments, the stall area 100 and/or 15 prevents one of the inner driver attachment element 36B and the outer driver attachment element 36A from moving down the drive element 22. When the inner driver attachment element 36B and the outer driver attachment element 36A meet each other, the axial force (down the rotational axis of the rotating drive element) binds the stalled driver to the still-driving driver. This, coupled with the weight of the curtain hanging from the outer driver and the interconnection of the inner driver attachment element 36B and the outer driver attachment element 36A to the support guide, causes the driver whose teeth are still engaged to the tube to bind up with the rotational drive element. At that point, this driver is being torqued so as to try and rotate around the axis of rotation and prevented from such rotation by the support guide, which stalls the motor and signals the controller board to stop running the motor.

### Vibration Sensing Activation/Deactivation

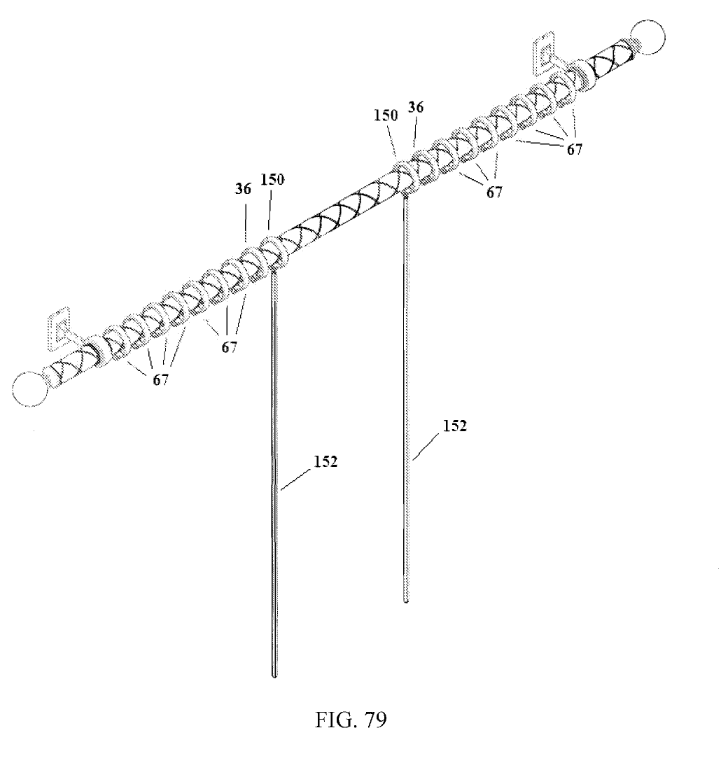

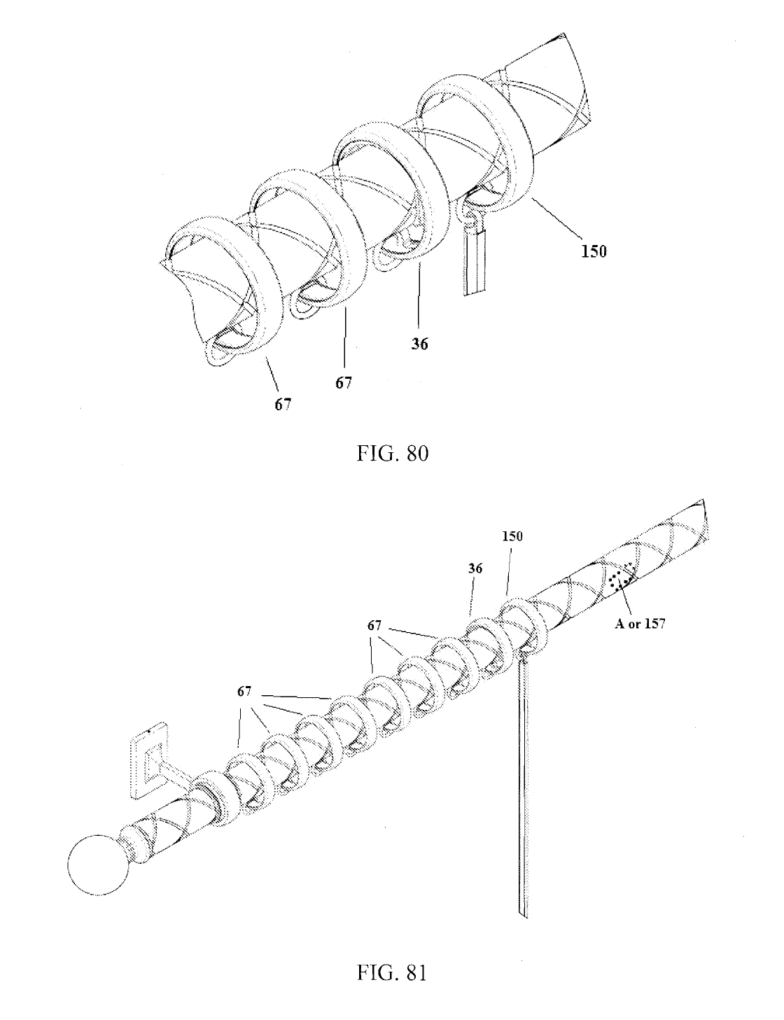

As is shown in FIGS. 31 and 32, and FIGS. 78-81, rotatable drive element 22 is mounted in rubber mounting disk 13 which helps to absorb or prevent the transmission of vibration from the wall through brackets 54 and into drive element 22, or vice versa. By absorbing or deadening the vibration between the brackets 54 and the rotatable drive element 22 this increases the ability to sense intended vibrations on the drive element 22. Specific embodiments, pertaining to a dual curtain assembly (center close or single side close) or a single curtain assembly (center close or single side close), can employ one or more accelerometers or other sensors that sense vibration that can allow a user to activate and/or control the curtain assembly. A variety of sensors can be utilized, including a sensor detecting a force or torque applied to the drive element or other component of the assembly, such as a force in a direction perpendicular to the longitudinal axis of the drive element or a torque applied to the drive element about the longitudinal axis of the drive element. Examples of sensors that can be utilized include, but are not limited to, sound detectors, vibration sensors, strain sensors, stress sensors, length detector (e.g., length of stretchable curtain), gyroscopes, load sensors and motion sensors. The accelerometer or sensor can be connected to the system in any manner. In one arrangement, the accelerometer or sensor is positioned within the drive element 22 or connected to any component positioned within the drive element 22. The accelerometer or sensor can be positioned on the window covering, a draw cord, a battery sleeve, a drive attachment element, an idle attachment element, or other component of the system. In another embodiment, the accelerometer or sensor is connected to a bracket. In yet another arrangement, the accelerometer or sensor is included as part of the motor control board as a component thereof.

In a specific embodiment, a FREESCALE™ accelerometer, Model No. MMA 8451Q±2 g/±4 g/±8 g, 3-Axis digital accelerometer or a model No. MMA 7601±1.5 g/±6 g digital accelerometer can be placed on the motor control board, which is positioned within the drive element 22 (10). The accelerometer can then detect an acceleration or vibration and output a signal that indicates an amplitude of the vibration or acceleration and the output signal can be compared to a threshold to determine whether the motor should be activated to turn the drive element or deactivated to stop turning the drive element.

Specific embodiments can allow a user to pull down on the curtain, e.g., the deployed curtain or stored curtain, and communicate one or more command. The command can be based on, for example, the length of time of the application of the force, the magnitude of the force applied, the number of times the force is applied, the elapsed time between multiple applications of force, the pattern of the force applied, and/or the current state of the curtain. The command can be, for example, one or more of the following: open the curtain, close the curtain, close the curtain if curtain open, open the curtain if curtain closed, stop curtain in current location, open, or close, curtain to specific location (e.g., a preset location (state) or a location (state) taught to the system by the user), open the inner curtain only, open the outer curtain only, open both the inner and outer curtain, close the inner curtain only, close the outer curtain only, close both the inner and outer curtain, open the inner and/or outer curtain to a specific location, open or close a single curtain or inner and outer curtain to one or more states (e.g., to a preset state or a state taught to the system by the user), to remember the current location (state), open, or close, one or more curtains until the force is terminated, and/or other useful commands in a manner similar to commanding the system using, for example, a remote control.

The force or other mechanical input can be provided by the user through a switch (e.g., a button, toggle switch, or other mechanism mounted to the system or near the system), a cord or other structure connected with the system. As an example, a cord can be provided such that when a user pulls on the cord a torque is applied to the drive element 22 or other portion of the system, a force is applied to the drive element 22 or other portion of the system, a switch is activated or toggled, a magnetic material is moved, and/or a physical input is provided to the system. In a specific embodiment, two cords or other structures (e.g., two rods) can be provided such that if the first cord is pulled a first command (such as open one or more curtains) is inputted and if the second cord is pulled a second command (such as close one or more curtains) is received.

Specific embodiments can be useful for benefiting from users' experiences with opening conventional draperies by pulling a baton attached to the drapery in the direction they want the drapery to move. Such a baton can be connected, for example, to a ring on which the drapery hangs, to the drapery itself, or to a structure interconnected to a ring and/or the drapery. In an embodiment designed to have the user pull a baton in the direction the user wants the drapery to open, one or more accelerometers, and in a specific embodiment one accelerometer, is connected to the system and is used to sense vibrations when a user pulls a baton connected to an inward most ring. A three axis accelerometer can be utilized to detect acceleration (e.g., vibration) of a part of the system, such as the motor control board.

In this arrangement, the accelerometer 157 is connected to the system in any manner, including positioning the accelerometer 157 within the hollow interior of the rotating drive element 10, directly connecting the accelerometer 157 to the rotating drive element 10 itself, connecting the accelerometer 157 to a bracket, positioning the accelerometer 157 to the motor 82 or motor control circuit board 7, connecting the accelerometer 157 to a finial or end cap connected to the rotating drive element 10 or a bracket 45, or connecting the accelerometer to any other portion of the system in a manner where it can receive or sense vibrations and therefore activate the motor 82. The accelerometer 157 is electrically connected to the motor control circuit board 7 and/or the motor 82.

There are a number of tugs or disturbances that the drive element 10 can experience, such as: a vertical tug (a “tug”); a lateral tug (a “slide”), where a lateral tug is having a component parallel to the longitudinal axis of the drive element; a tug having a component transverse to the longitudinal axis of the drive element and a component parallel to the longitudinal axis of the drive element; a tug that is transverse to the longitudinal axis of the drive element, and a tap (“tap”).

A vertical tug occurs when a user pulls down on the shade material, or a curtain or a rod or other device connected to the drive element 10. This “tug” may create a low frequency thud, or a heavy and strong disturbance that reverberates through the drive element 10. In this arrangement the accelerometer 157, or other sensor, is tuned specifically to detect this tug or low frequency disturbance, or disturbances within a predetermined frequency range. However the use of a vertical tug has disadvantages. Namely, consumers are not accustomed to tugging on the shade material to open the drapery, and, therefore, the users need to learn a new method, albeit a simple, but somewhat unnatural, one. While a system can be designed to use a vertical tug, for applications in public places, such as hotel rooms, the user's lack of understanding as to how to activate the drapery system can lead to frustration or breaking of the system. In addition, it is undesirable to tug directly on the shade material as this can cause the shade material to tear, and repeated tugging can stain, wear or soil the drapery material over time.

A lateral tug or “slide” occurs when the user pulls the shade material, or curtain, with a tug having a component parallel to the longitudinal axis of the drive element, such that the shade material, or curtain, moves laterally along the length of the drive element 10. The user can cause the shade material to exert a force on the drive element, or other part of the assembly that then exerts a force on the drive element, the force having at least a component in a direction parallel to the longitudinal axis of the drive element, and, optionally, a component transverse to the longitudinal axis of the drive component. Such a force can then cause an attachment element 67 that the drapery is connected to move in a direction parallel to the longitudinal axis of the drive element. As an example, when the user laterally tugs a portion of the drapery attached to an idler attachment element 67 with a tug having a component parallel to the longitudinal axis, this causes the idler attachment element to slide over the drive element 10. As the idler attachment elements 67 slide over the drive element 10 the idler attachment elements interact with the guide structure 24. As the idler attachment elements 67 interact with the guide structure 24 the idler attachment elements tend to fall into the grooves as they pass over the guide structure 24 and cause audible clicking noises as well as other disturbances, or vibrations in the drive element. This disturbance tends to be of a higher frequency than caused by a vertical tug, especially when the idler attachment elements 67 and the drive element 10 are formed of metal thereby causing a metal-on-metal interaction. In a specific arrangement, the accelerometer 157 is specifically tuned to detect this high frequency disturbance caused by the lateral tug, or tug that causes the idler attachment element 67 to slide over or travel along the drive element 10.

It is important to note that in embodiments where the driver attachment element 36 has one or more driver teeth 62 that engage the guide structure 24, it is preferable that the user not use a lateral tug to the drive attachment element 36 in order to activate the system when the drive teeth are engaged, as the drive attachment element will not easily slide laterally over the drive element, as the driver teeth 62 are engaged in the guide structure 24. Instead, in this arrangement, it is more effective to laterally tug a portion of the drapery that is attached to an idler attachment element(s) that is the inward-most idler attachment element 67, or one or more of the idler attachment elements 67 positioned behind the driver attachment element 36. While laterally tugging a portion of the drapery attached to the inward most idler attachment element 67, or ring, or other idler attachment element 67, such that the movement of the idler attachment element 67 over the drive element interacts with the drive element to cause a vibration that activates the motor to turn the drive element, works sufficiently well, again, consumers are not trained to operate draperies in this manner. Also, operating the drapery system in this manner, again, requires the user to touch the drapery material directly, which, over time, can wear or soil the drapery material.

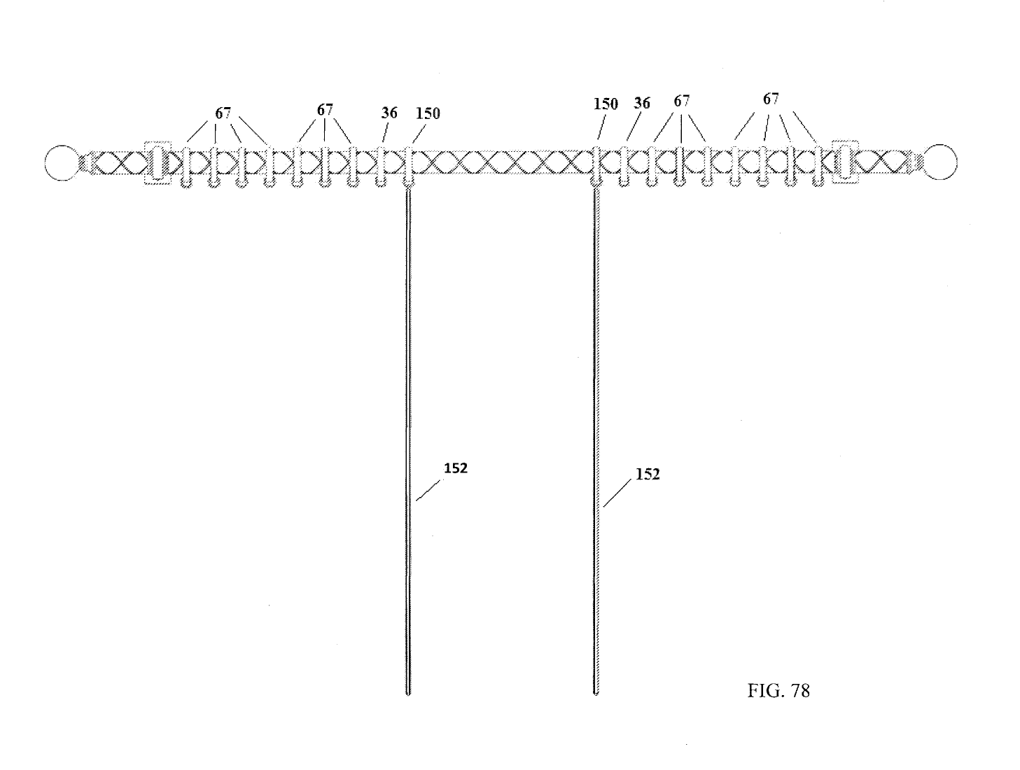

In further embodiments, referring to FIGS. 78-82, the driver attachment element 36 can be positioned inward one or more positions from the inward most position, such that one or more rings are to the outside of the drive attachment element 36. That is, in the stack of idler attachment elements 67, the driver attachment element 36 is positioned inward at least one position so as to be inside of the last, or outside, idler attachment element 67, which, hereinafter, will be referred to as the “inward idler attachment element” 150. In FIG. 78 there are two attachment elements (or inward idler attachment elements) in the inward most position, (both of these inward attachment elements having a baton 152 shown connected to the attachment element, but the batons need not be attached in the embodiment being described). In this arrangement, placing the driver attachment element 36 inward at least one idler attachment element 67, does not prevent the system from fully opening or fully closing, as the driver attachment element 36 can merely push or pull the inward idler attachment element 150 like it does the idler attachment elements 67 positioned on the other side of the driver attachment element 36. This arrangement allows a user to operate the system using the natural tendency to laterally tug the inward most edge of the drapery and/or drapery material, i.e., cause an idler attachment element 67 to move along a portion of the drive element when the drapery is tugged. As an example, when the user tugs on the inward most edge of the drapery via tugging, the inward idler attachment element 150 is pulled so as to slide along the drive element 10, thereby causing a vibrational disturbance that is detected by the accelerometer 157 or other vibration sensor. Upon detection of the vibration, the drive element 10 can be activated to rotate in a direction and amount signaled by the tug provided based on the program of the system, such as to rotate in the opposite direction of the last movement.

In a specific embodiment, regardless of whether the driver attachment element 36 is positioned at the end of the stack of the idler attachment elements 67, or if the drive attachment element 36 is positioned inward of one or more inward idler attachment elements 150, the user can activate the drapery system by sliding any of the idler attachment elements 67 across a length of the drive element 10. In an embodiment that positions the driver attachment element 36 inside of one inward attachment idler element 150 the system can be activated by sliding any of the idler attachment elements 67 across the drive element 10, or by sliding the inward idler attachment element 150 across the drive element 10. In an alternative embodiment, the inward idler attachment element 150 can have a structure feature not present on one or more of the other idler attachment elements 67 that creates a unique vibratory signature that the system can distinguish from the vibratory signatures caused by the other idler attachment elements sliding along the drive element 10. Such a signature can be detected by a time delay between peaks, a specific frequency, or other distinctive feature of the signature.

In a further embodiment, a baton 152 is attached to the inward attachment element 150, as shown in FIGS. 78-81, which allows a user to activate the system without the user having to touch the drapery material at all. The baton 152 is formed of any suitable material and can have any suitable size, shape, and design. In the most simple of arrangements, the baton 152 is an elongated rod that hangs down from the inward idler attachment element 152 to a convenient height. To activate the system, the user merely grasps the baton 152 and pulls it so as to create a force on the inward idler attachment element 150 having a lateral component, i.e., parallel to the longitudinal axis of the drive element. The application of a force having a lateral component causes the inward idler attachment element 150 to slide over the drive element 10 so as to cause a disturbance or vibration as the inward idler attachment element 150 slides over the guide structure 24, and contacts the adjacent driver attachment element 36, contacts the adjacent inward attachment element 150 (e.g., in a center opening and closing system when the drapes are closed or in a an embodiment where the driver attachment element 36 is moved in two positions such that two idler attachment elements 67 are outside of the drive attachment element 36), and/or hits any other part of the system.

In yet another arrangement, baton 152 is connected to an idler attachment element 150 or other ring that is positioned around the drive element 10 and has sufficient clearance such that the idler attachment element 150 can be moved with respect to the drive element 10. In this arrangement, the user grasps the baton 152 and moves the idler attachment element 150 until it strikes the drive element 10. This can be accomplished by raising the baton 152 until the bottom of the idler attachment element 150 strikes the bottom of the drive attachment element 10 (known as a tap). This can also be accomplished by raising the baton 152 until the top of the idler attachment element 150 is raise off of the top of the drive attachment element 10 and lowering it again until the idler attachment element 150 again strikes the drive element 10. A tap can be generated by moving the idler attachment element 150 with respect to the drive element 10 any other manner or with a combination of these movements. Taps can be amplified by adding a metallic knob or protrusion to the inside of the idler attachment element 150 such that when the idler attachment 150 is raised this metallic piece strikes the drive element 10 thereby causing a crisp and clean vibration that is easily and repeatably sensed. In one arrangement, because the idler attachment element 150 has a larger diameter than the drive element 10, this metallic device or protrusion is positioned at the bottom of the inside of the idler attachment element 150 such that it has clearance and does not engage the drive element 10 in normal operation because the idler attachment element 150 hangs down from the drive element, but the protrusion strikes the drive element 10 when the baton 152 is raised.

In yet another embodiment, a mechanical device is connected to the idler attachment element 150 that baton 152 is connected to such that when the baton 152 is pulled, the mechanical device strikes the drive element 10. In one arrangement, this mechanical device is spring loaded mechanical arm.

In an embodiment, the accelerometer 157 is specifically tuned to detect the specific disturbances created by the vibrations caused when the inward idler attachment element 150 moves along the drive element 10 or other object strikes or engages the drive element 10. Specific embodiments can modify the surface of the drive element 10, the portion of the inward idler attachment element 150 that contacts the drive element when moving along the drive element, and/or a portion of the inward idler attachment element that contacts the drive element when the inward idler attachment element is tilted (e.g., when tugged), so that a specific disturbance is caused. By specifically tuning the accelerometer 157, the potential for false activation can be reduced, or prevented, such as activations caused by heavy footsteps, cars, trucks or trains driving by, pets or children contacting the drapery, wind or a fan blowing on the drapery, a door slamming, and/or other disturbances. The accelerometer 157 can be configured to enter into a sleep state, where little or no current is consumed, when little or no vibration or disturbance is sensed, or when no vibration or disturbance is sensed above a predetermined threshold amount, or within a predetermined spectrum or window. This can be created by setting a threshold disturbance limit for the accelerometer 157; until that threshold limit is exceeded the accelerometer 157 remains asleep.

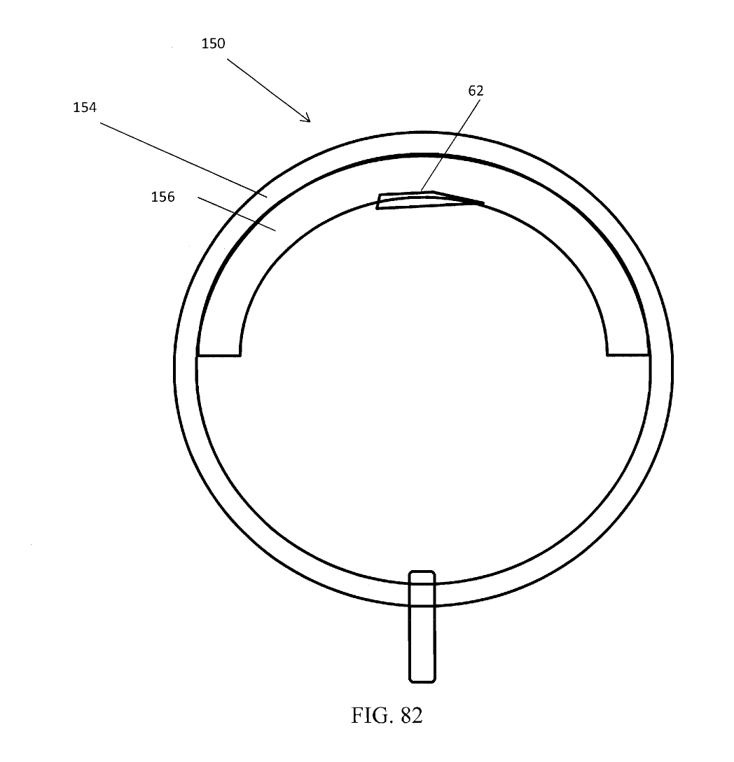

In an embodiment, to improve the efficacy of the system, the inward idler attachment element 150 is formed of an outer ring 154, which can be the same outer ring the idler attachment elements 67 are formed of or a different outer ring than the idler attachment elements 67 are formed of, and has a driver tooth 62, or other structure, extending inwardly from the outer ring, or other structure positioned within the outer ring 154. In a specific embodiment, the inward idler attachment element is formed of an outer ring 154 and a single driver tooth 62 extending inwardly from a collar 156. The drive tooth 62 can be, for example, on the top of the drive element 10 when the inward idler attachment element 150 is in position. In one arrangement, the outer ring 154 is formed of a metallic material, where the collar 156 and tooth 62 are formed of a composite material, such as a plastic or the like. In the arrangement shown in FIG. 82, the tooth extends downward from the center top of the ring 154 and collar 156 and the collar 156 does not form a complete or constant circle like the ring 154. Instead, the bottom or lower end of the collar 156 is recessed or terminates.

The combination of having a single tooth 62 as well as a collar 156 that provides enough clearance around the drive element 10, provides the inward idler attachment element 150 with enough clearance such that the user can pull the inward attachment element 156 along the drive element 10, while the tooth 62 positioned in the top of the inward idler attachment element 150 provides some driving force. Further, such a driver tooth 62 can create a unique vibration signature, which can be detected by the accelerometer 157 and/or other vibration sensor, which can optionally be tuned to the vibration created by the driver tooth 62 of the inward idler attachment element 150.

In operation of a specific embodiment, when a user wants to open or close the system, the user grasps the baton 152 and pulls it so as to pull the inward idler attachment element 150 laterally slides along a length of the drive element 10. In doing so, the inward idler attachment element 150 tilts in the direction of the pull, and because the collar 156 is absent or thinner adjacent the bottom end of the outer ring 154, the bottom end of the outer ring 154 can engage the drive element 10 so as to induce a vibration that can be sensed by the accelerometer 157 and/or other vibration sensor. As the inward idler attachment element 150 is further pulled, the tooth 62 is pulled out of engagement with the guide structure 24, which can cause further vibrations that can be sensed by the accelerometer 157 and/or other vibration sensor. As the inward idler attachment element 150 is further pulled, the tooth 62 and the other portions of the inward idler attachment element 150 slide along the drive element 10 intermittently contacting the guide structure 24 where present. This sliding causes vibrations that can be sensed by the accelerometer 157 and/or other vibration sensor. When the accelerometer 157 and/or other vibration sensor senses the right disturbance or vibration, the accelerometer 157 and/or other vibration sensor sends a signal to activate the motor 82 and/or motor control circuit board 7, which rotates the motor 82 as appropriate based on the operation protocol, such as in the opposite direction of the last rotation, so as to open or close the drapery.

In a further specific embodiment, the baton 152, or other structure can be connected to an idler attachment element, or other structure operatively connected to the drive element, where the curtain is not connected directly to the idler attachment element the baton is connected to. The idler attachment element the baton is connected to is interconnected to one of the drive attachment element or idler attachment elements via a string, strap, spring like material, or other connecting structure that allows the idler attachment element the baton is connected to move within some range of distance from the attachment element it is connected to. Such an embodiment allows the user to tug on the baton and move the idler attachment element along the drive element so as to create a vibration that can activate the drive element to rotate, while remaining connected to the attachment element it is attached to. In a further embodiment, the idler attachment element the baton is attached to is not connected to any other attachment element, but can be moved along the drive element by the baton in the regions of the drive element not occupied by other attachment elements. In such embodiments the drive attachment element can be the most inward attachment element or can be one or more positions inside of the most inward attachment element.

In yet a further specific embodiment, a screw, bolt, post, or other component extends inwardly from the outer ring 154 toward drive element 22. In this arrangement, it is preferable that the screw, bolt, post or other component is formed of a metallic material and it terminates a distance before the surface of drive element 22, such that the end of screw, bolt, post, or other component does not touch drive element 22 but is in close proximity to the surface of drive element 22. In one arrangement the screw, bolt, post, or other component extends inward from the bottom side of outer ring 154 upward towards drive element 22. In this arrangement, when the ring 154 is tilted, by pulling baton 152, the drapery material itself, or any other component, this causes ring 154 to tilt, which causes the screw, bolt, post, or other component to engage the drive element 22 causing a metal-on-metal disturbance which is quickly and clearly detected by accelerometer A/157. In this way, the presence of screw, bolt, post, or other component allows for activation of the system by merely pulling or tilting the ring 154 having the screw, bolt, post, or other component a minimal amount. This reduces the amount of lateral distance the ring 154 must be pulled to activate the motor.

Use and experience has shown that additional advantages are accomplished by positioning the driver attachment element 36 inward by one or more idler attachment elements 67 or inward by one or more inward idler attachment elements 150. In this arrangement, the inward most ring 67/150 is essentially pushed or pulled by the driver attachment element 36. The fully closed limit is set such that, in a center closing drapery, the opposing inward most rings 67/150 engage one another at the fully closed position, or said another way, at this point the inward most ring 67/150 stops moving. Thereafter, the system is programmed to continue to drive the driver attachment element 36 towards the now stationary inward most ring 67/150. Rotation of the drive element 22 continues until the driver attachment element 36 engages or almost engages the inward most ring 67/150. This causes the drapery material to slightly bunch up adjacent the middle, which helps to prevent an undesirable light gap. Said another way, this arrangement helps to accomplish a crossover condition and/or helps to achieve a blackout condition when blackout drapery material is used. When the two opposing inward most rings 150 engage one another, this causes the single tooth 62 to become dislodged from the guide structure 24 which causes these inward most rings 150 to stop moving inward.

Another advantage of positioning the driver attachment element 36 inward by one or more idler attachment elements 67 or inward by one or more inward idler attachment elements 150 is that the presence of the additional idler attachment elements 67/150 help to stabilize driver attachment element 36. That is, when the driver attachment element 36 is positioned as the inward most ring, as the drive element 22 is rotated, the driver attachment element 36 has a tendency to rotate with the drive element 22, which is extremely undesirable as this would cause the lateral movement of the drapery material to cease, and instead the drapery material would begin wrapping around the drive element 22 which can tear the drapery material and/or cause damage to the system. By positioning the drive attachment element 36 inward by one or more rings 67/150, this helps to stabilize the driver attachment element 36 and prevent this tendency to rotate and wrap around the drive element 22. It is believed that because the inward most ring 67/150 more easily slides along the drive element 22 and is not required to convert the rotation (or torque) of the drive element 22 to lateral movement along the drive element 22. In addition, the presence of additional drapery material positioned in front of the drive attachment element 22 provides a greater amount of mass that pulls down on the driver attachment element 36 that helps to keep the driver attachment element 36 upright thereby preventing rotation with the drive element 22.

When sensor or accelerometer 157 senses a disturbance above the threshold for waking up the sensor or accelerometer 157 or within the predetermined signal window for a disturbance, the sensor or accelerometer 157 transmits this signal to the motor controller and the motor controller determines whether the signal justifies activating or deactivating the motor 82. In one arrangement, when the motor 82 is not activated and a signal above the predetermined threshold is sensed the motor 82 is activated and the drapery is moved in the direction opposite of the last movement, to either open or close the drapery. In another arrangement, when the motor 82 is moving and a signal above the predetermined threshold is sensed the motor 82 is deactivated and the drapery.

### Center Closing Embodiments

An alternative embodiment of the dual curtain assembly 1 is shown in FIGS. 49 and 50 in which the outer curtain 44A and the inner curtain 44B are center closing curtains. A center closing curtain is composed of two fabric panels, a right panel and a left panel, that meet in the center of the window 34 to close and cover the window 34. In FIG. 50, the outer curtain 44A is a center closing blackout curtain that is in the deployed position and the inner curtain 44B is a center closing sheer curtain that is also in the deployed position. In FIG. 49, the outer curtain 44A is a center closing blackout curtain that is in the stored position and the inner curtain 44B is a center closing sheer curtain that is in the deployed position. In this embodiment, the drive element 22 of the drive element 22 preferably has four helical grooves 24, two formed in the clockwise direction and two formed in the counterclockwise direction. For example, the opposing helical grooves 24 shown in FIG. 59 create the correct movement of the center closing curtains with one motor 82 turning the drive element 22 in one direction. FIG. 59 shows an enlarged cross-sectional view of the rotatable drive element according to one embodiment of the curtain assembly showing the four helical grooves formed on the outer surface of the drive element. FIG. 59 also shows an enlarged perspective view of the rotatable drive element according to one embodiment of the curtain assembly showing the four helical grooves formed on the outer surface of the drive element.

To accommodate center closing curtains, the curtain assembly 1 has a left outer drive attachment element 36A, a right outer drive attachment element 36A, a left inner drive element 36B and a right inner drive attachment element 36B as shown in FIGS. 49 and 50. The left outer drive attachment element 36A is connected to one end of the left panel of the outer curtain 44A. The right outer drive attachment element 36A is connected to one end of the right panel of the outer curtain 44A. The left inner drive element 36B is connected to an adjacent end of the left panel of the inner curtain 44B and the opposite end of the inner curtain is attached to the end bracket 54. The right inner drive attachment element 36B is connected to adjacent end of the right panel of the inner curtain 44B and the opposite end of the inner curtain is attached to the end bracket 54.

FIG. 49 shows an embodiment of a rotatable drive element 22 in which the outer curtain 44A and the inner curtain 44B are both center closing curtains. There is an outer driver stall area 100 positioned at each distal end of the rotating drive element 22 and an inner driver stall area 15 positioned between the outer driver stall areas 100. For example, there is a left outer driver stall area 100 positioned along the drive element 22 to engage and disengage the left outer drive attachment element 36A from the helical groove 24 of the drive element 22 and a right outer driver stall area 100 positioned along the drive element 22 to engage and disengage the right outer drive attachment element 36A from the helical groove 24 of the drive element 22. The inner driver stall area 15 is configured to hold the left inner drive element 36B in place while the left outer drive attachment element 36A moves through the drive element 22. The same inner driver stall area 15 is also configured to hold the right inner drive attachment element 36B in place while the right outer drive attachment element 36A moves through the drive element 22. Alternative embodiments can have two separate inner driver stall area 15. FIG. 49 illustrates that the left and right inner drive attachment elements 36B will meet in the center 42 of the window 34 when the outer curtain 44A is deployed and the inner curtain 44B is stored to minimize light leakage. Therefore, the single inner driver stall area 15 in some embodiments is wide enough to fit both the left inner curtain drive element 36B and the right inner curtain drive attachment element 36B.

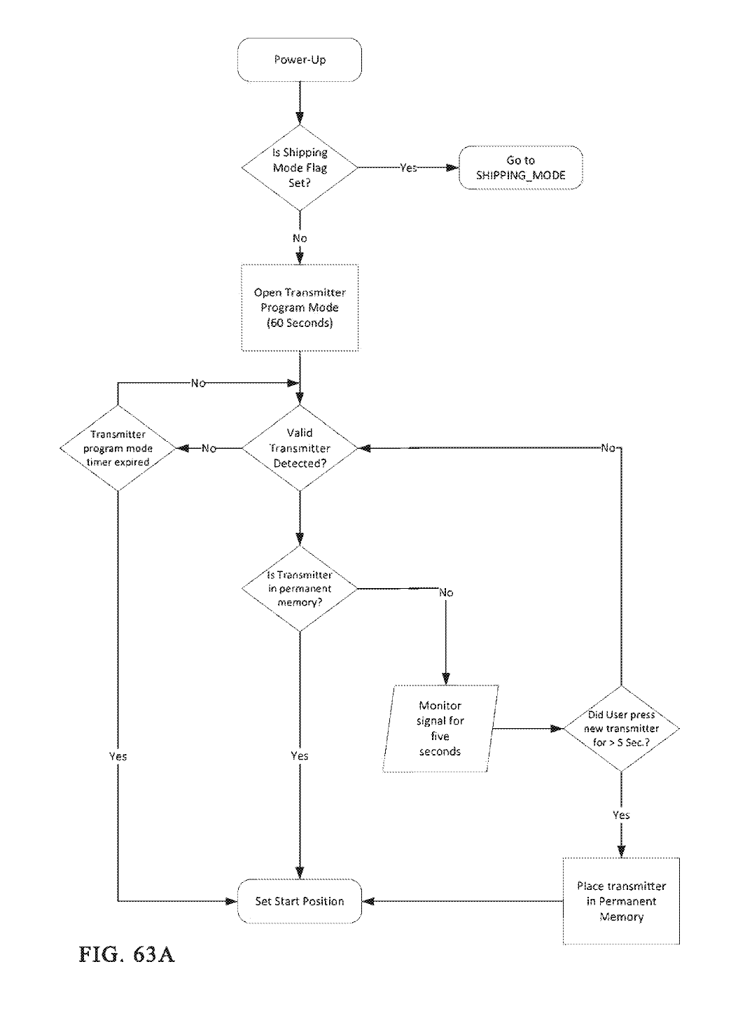

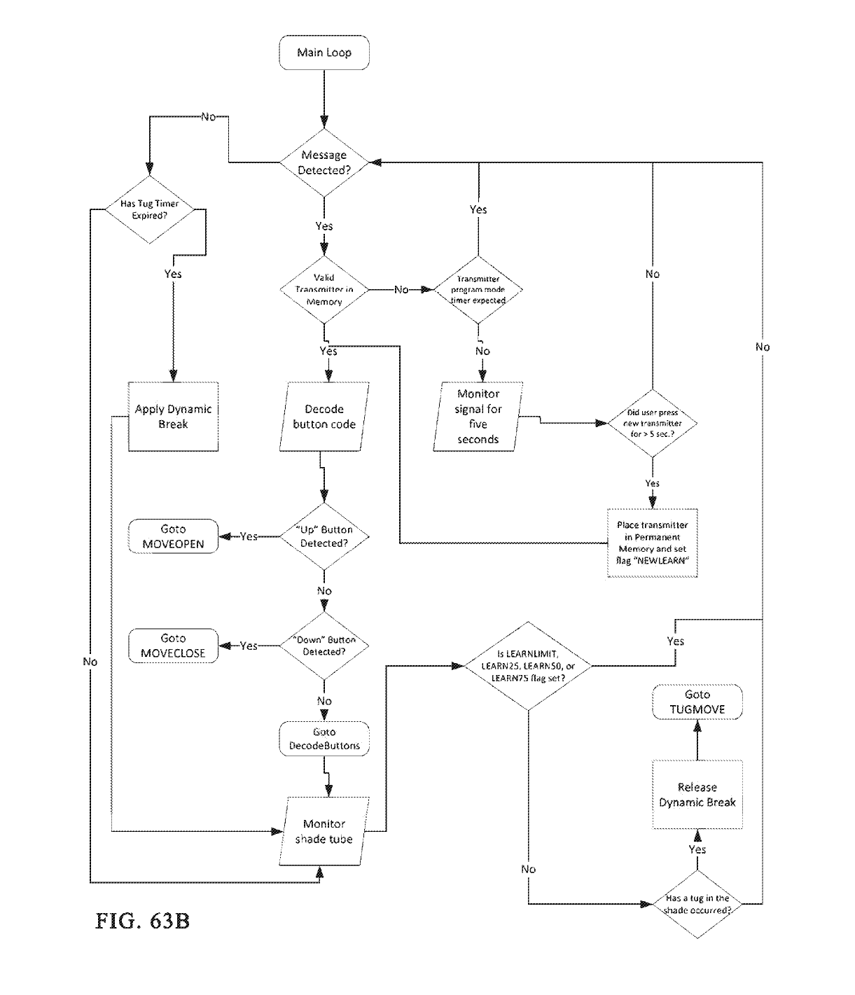

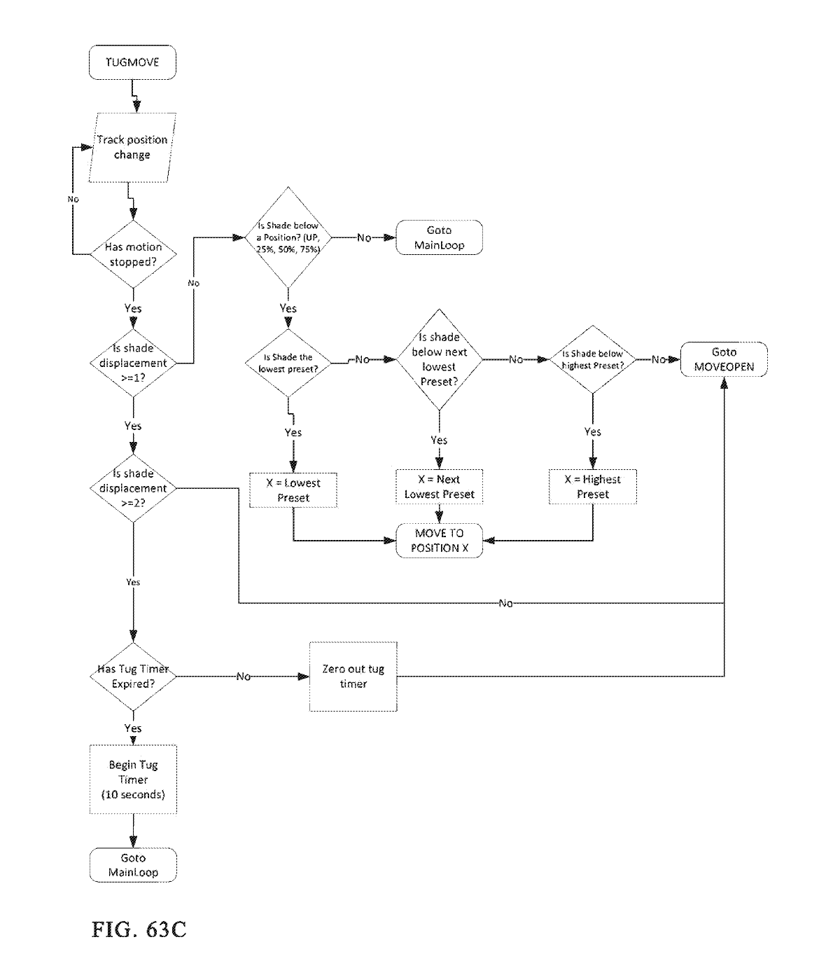

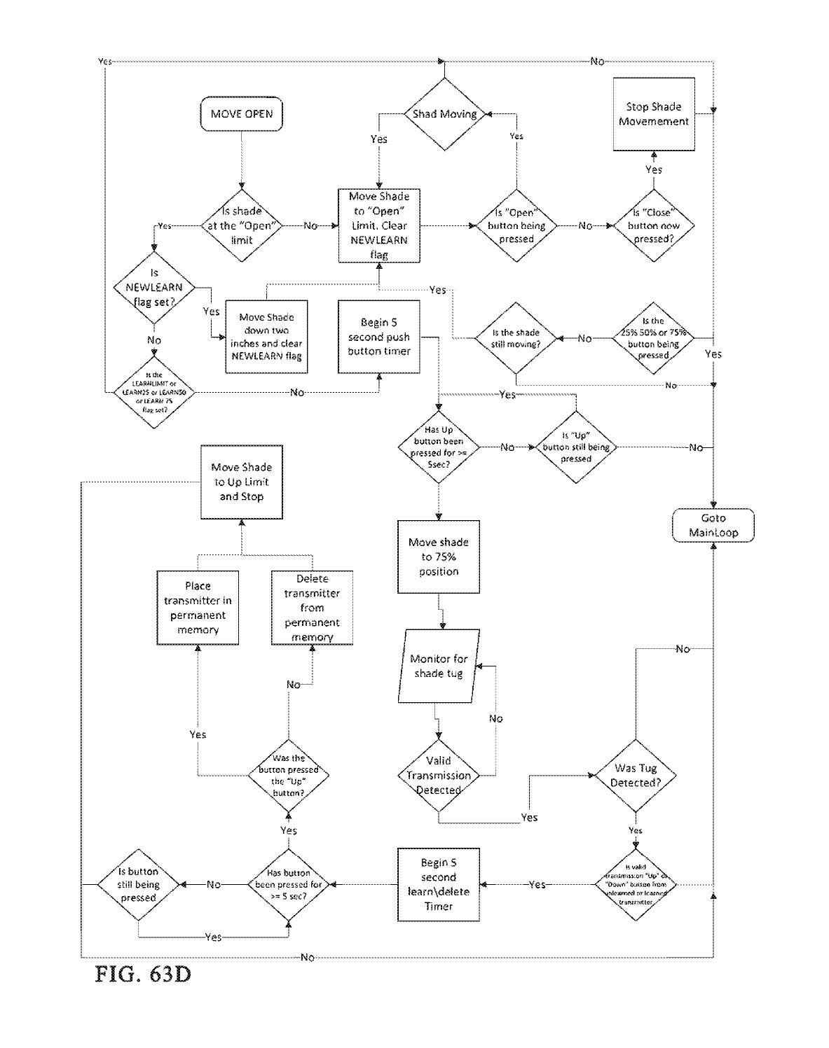

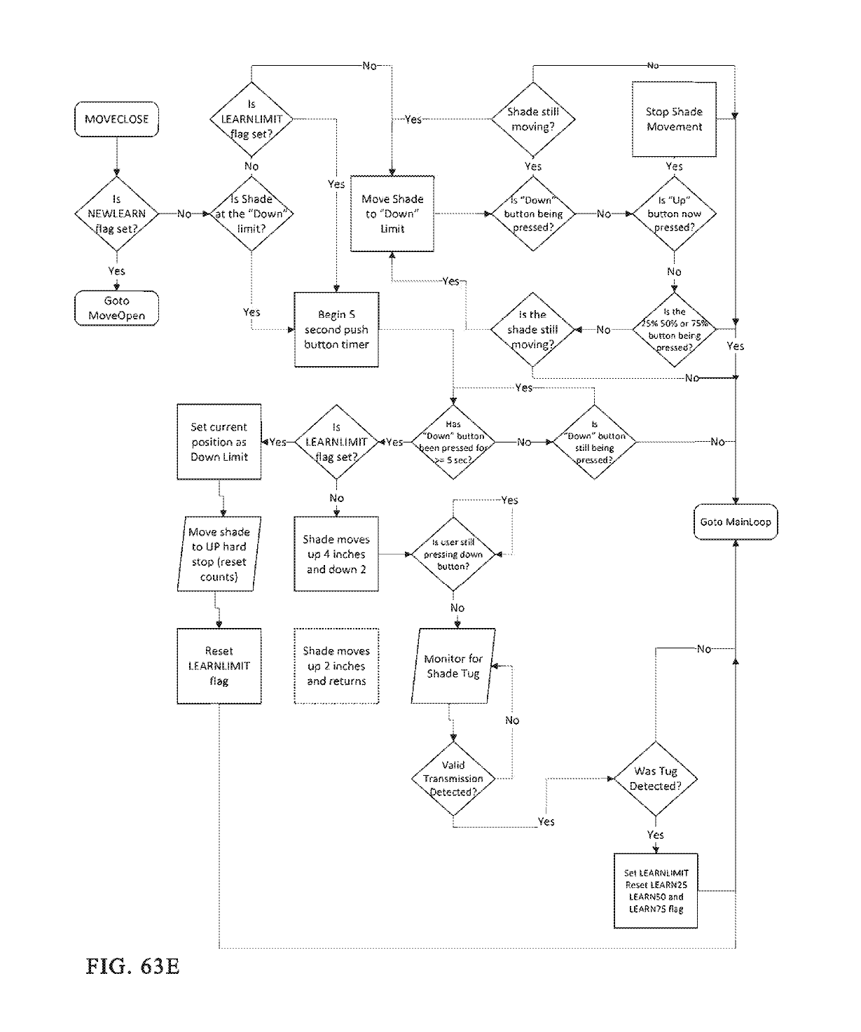

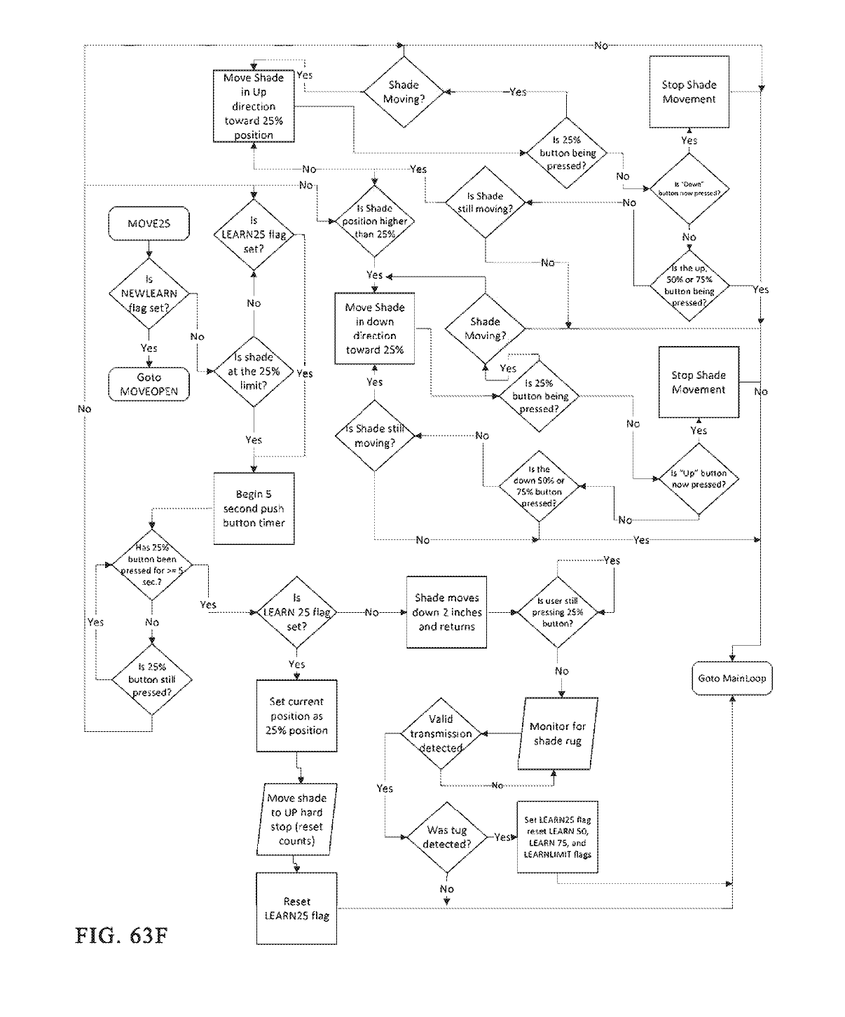

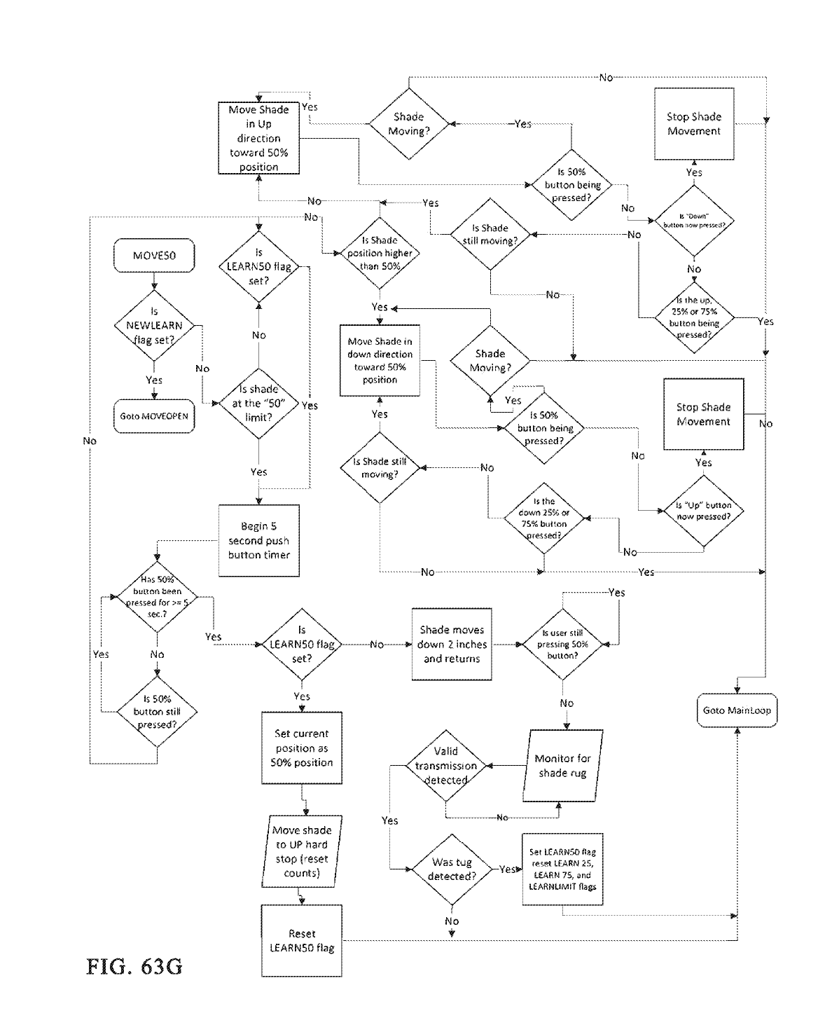

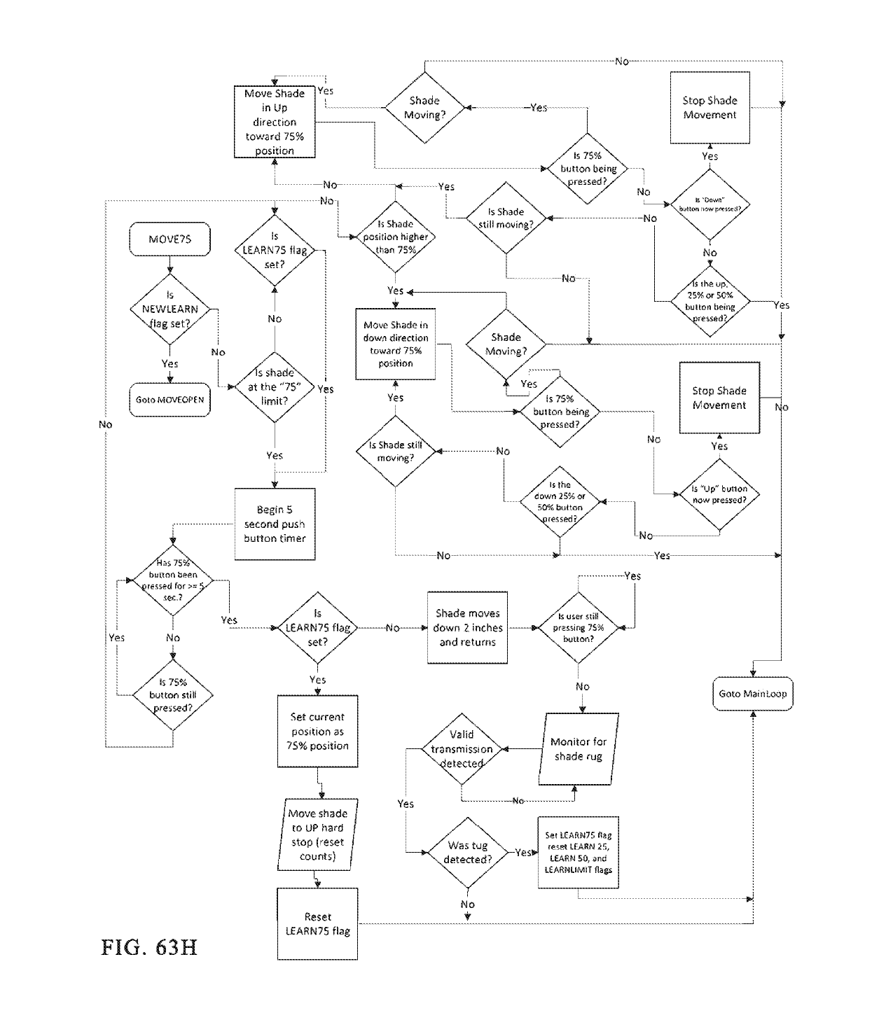

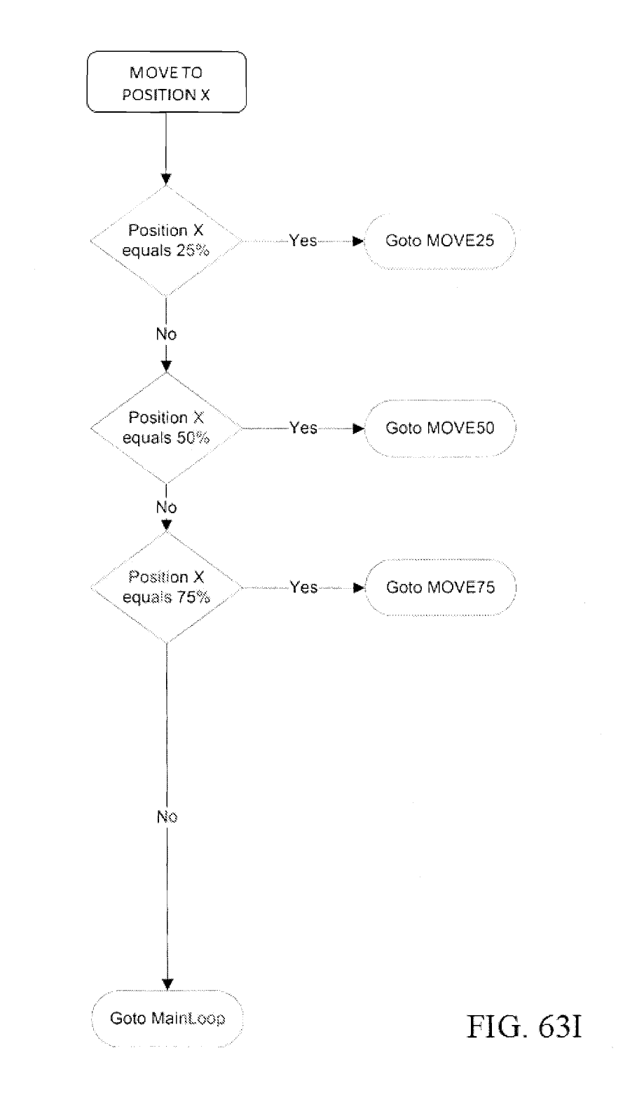

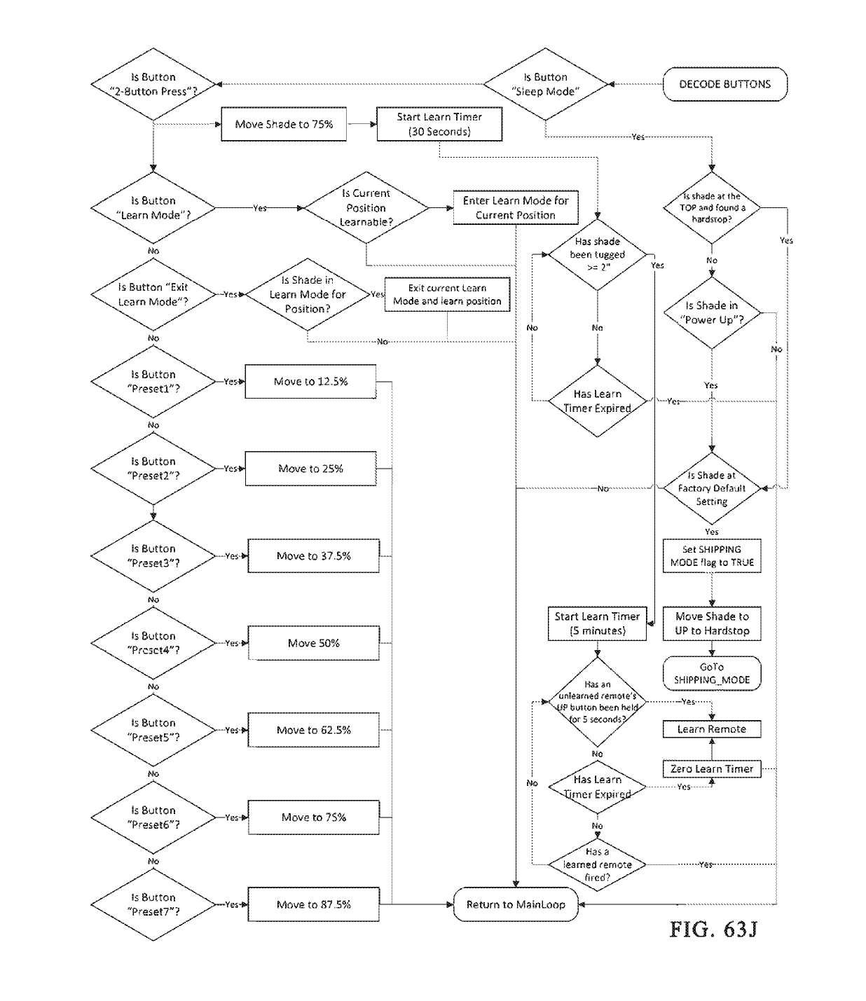

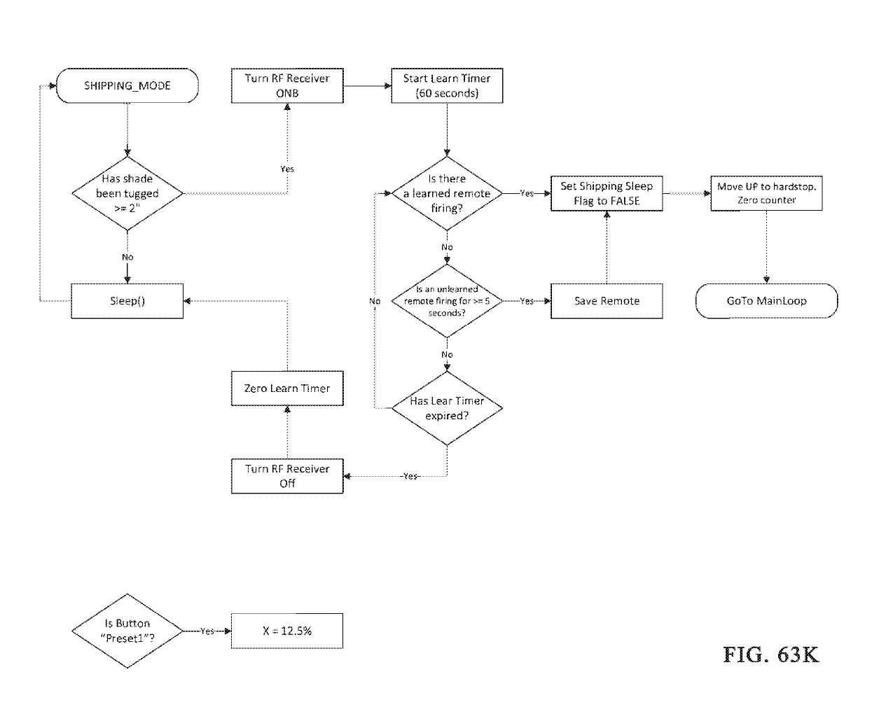

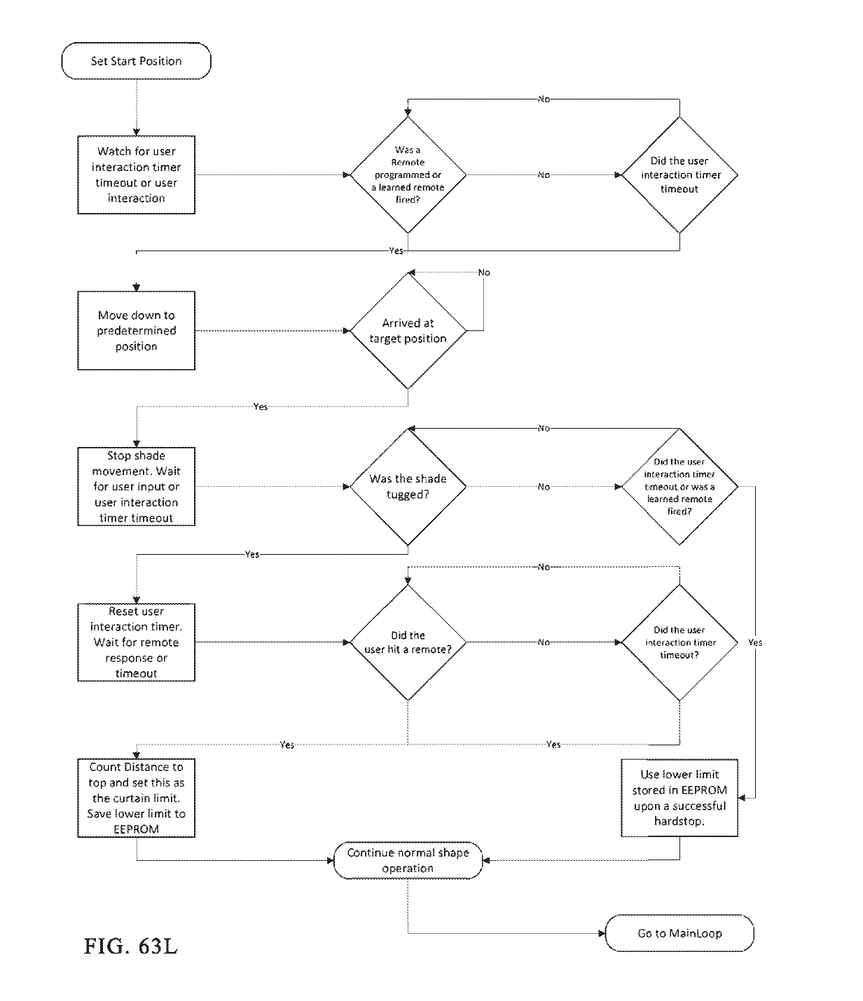

FIGS. 63A-63L show flowcharts implemented by the control system for specific embodiments of the invention.

### EMBODIMENT

### Method and Apparatus for Linked Horizontal Drapery Panels Having Varying Characteristics to be Moved Independently by a Common Drive System

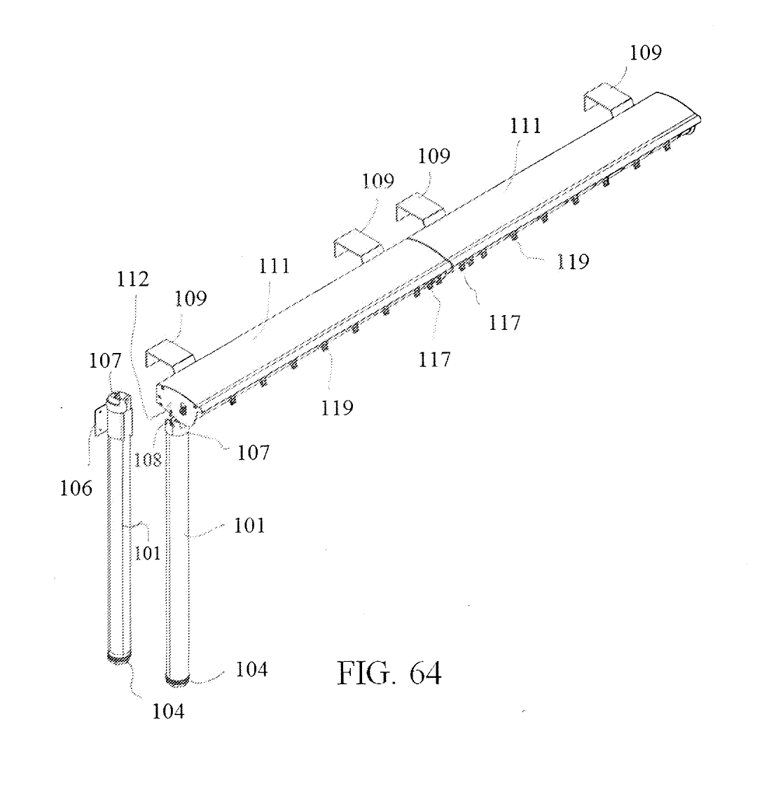

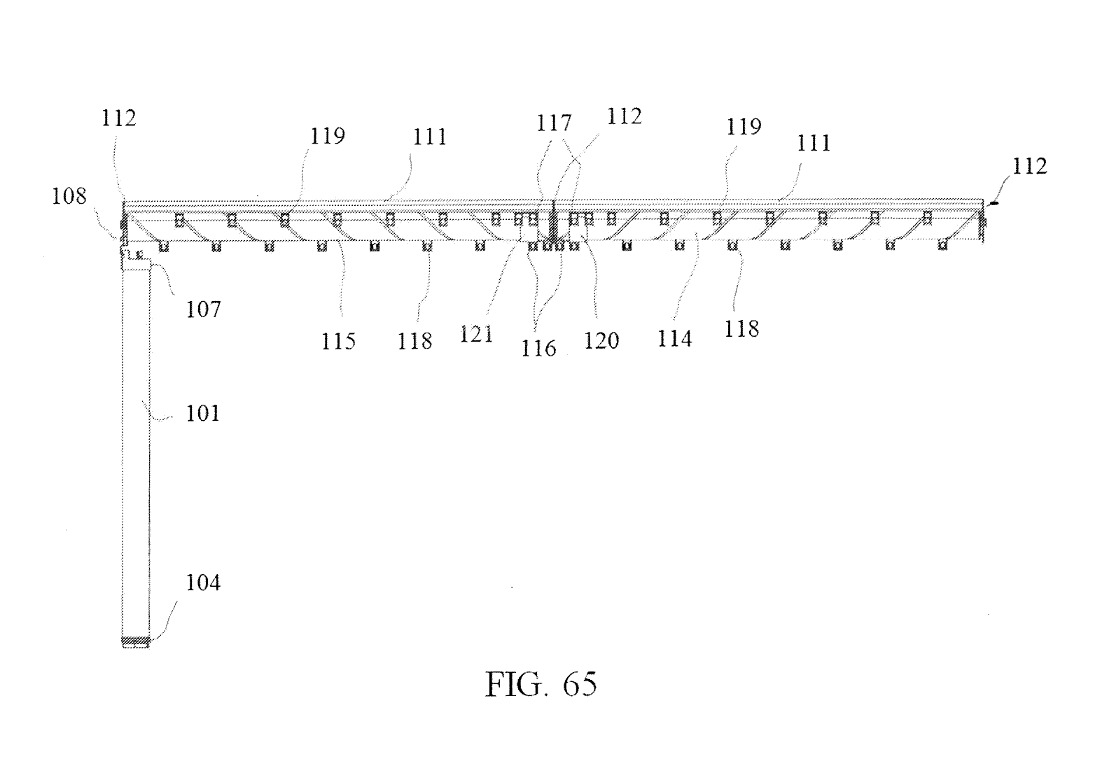

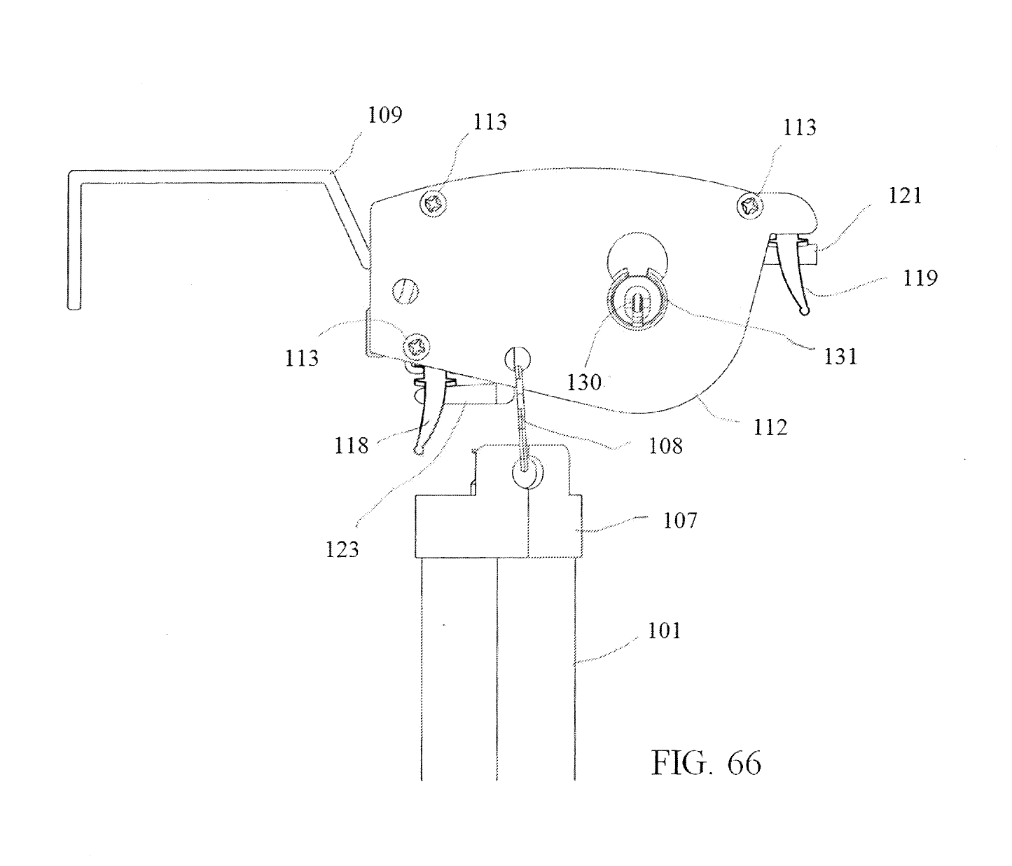

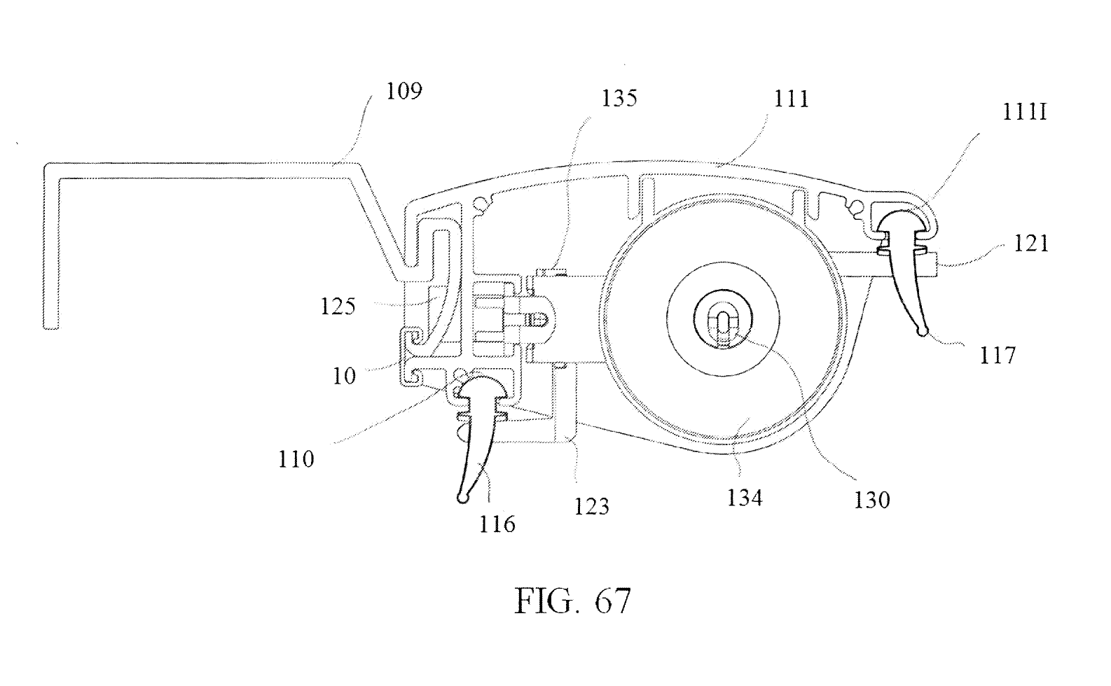

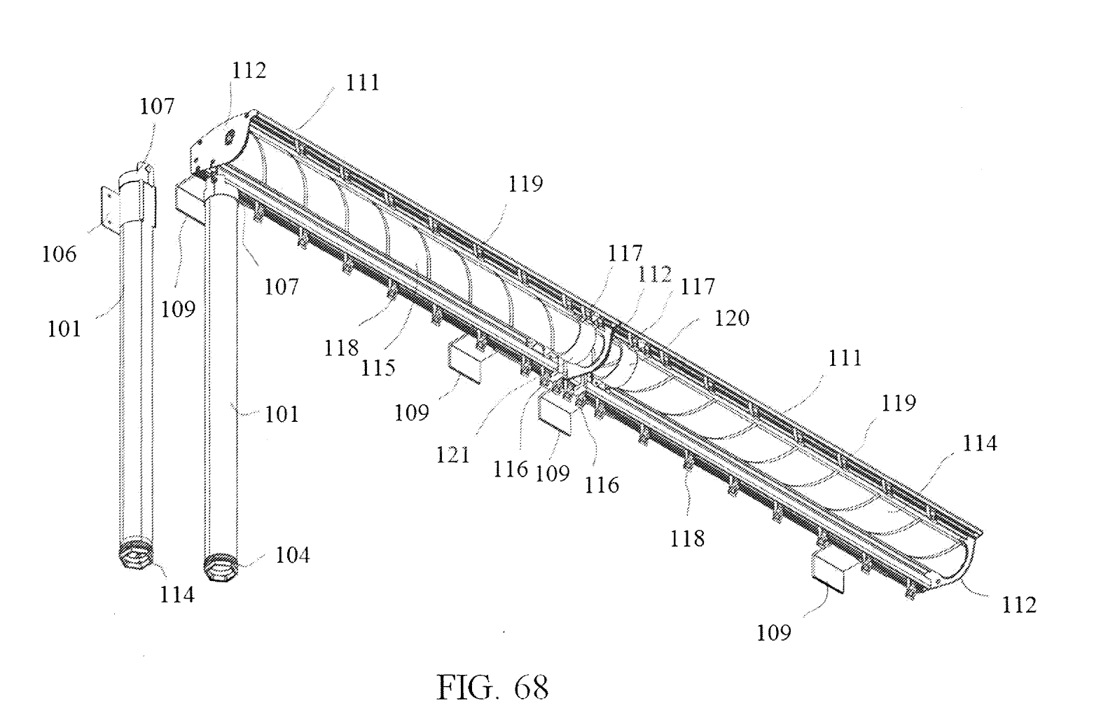

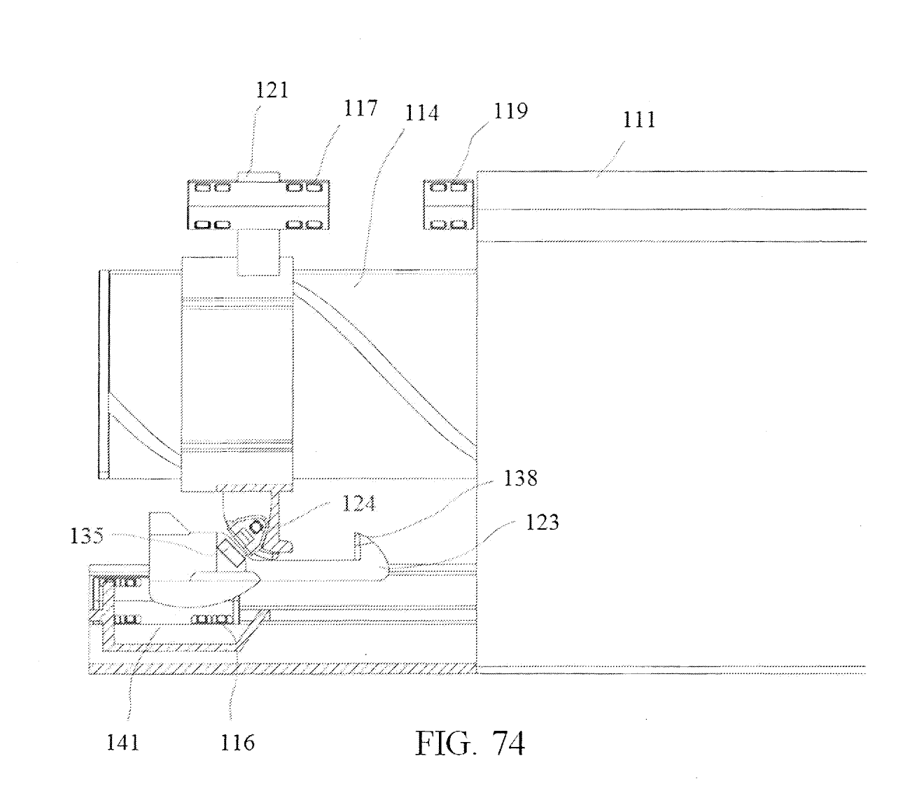

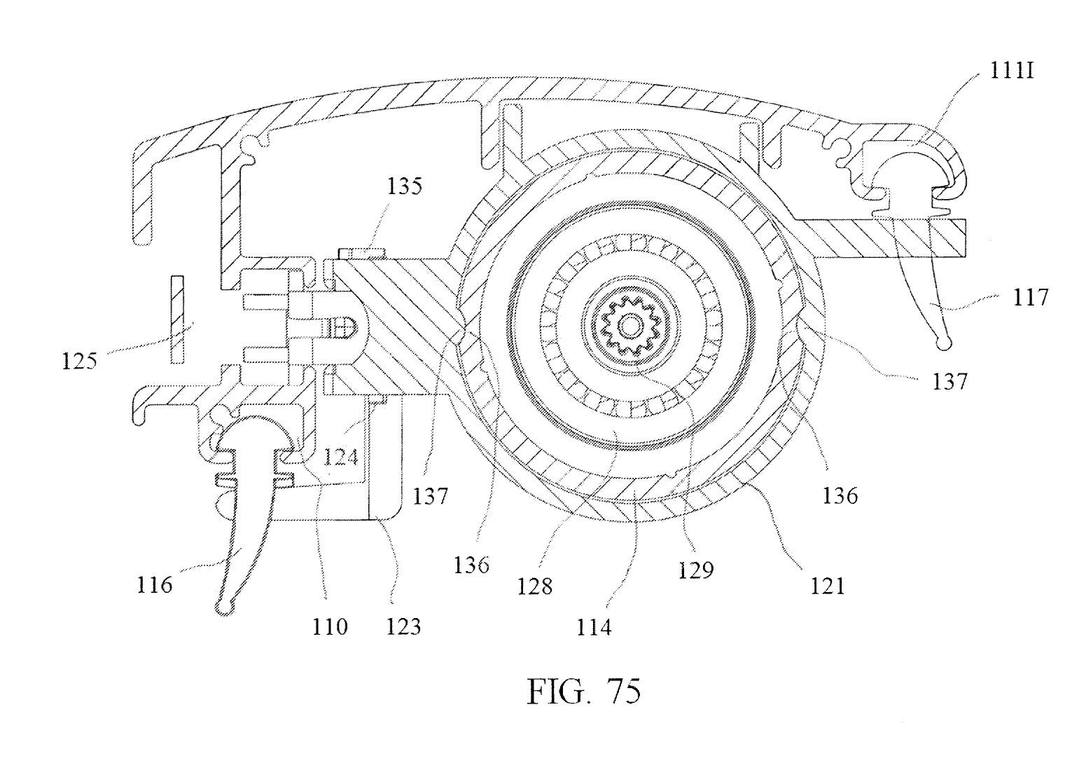

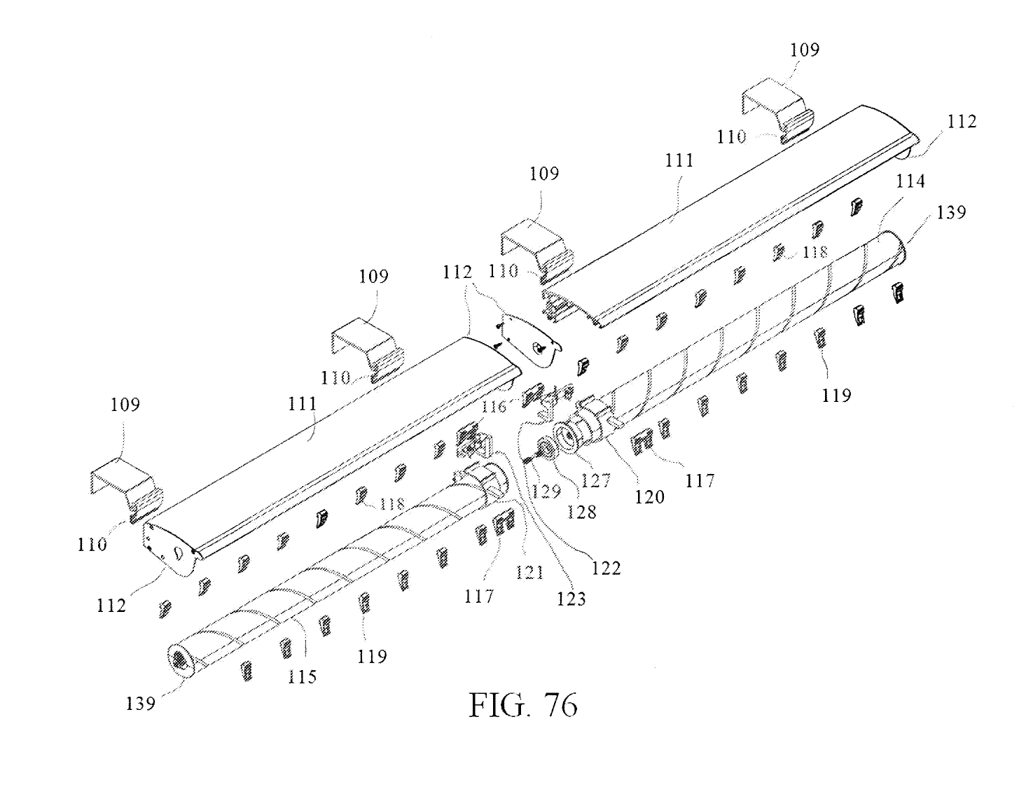

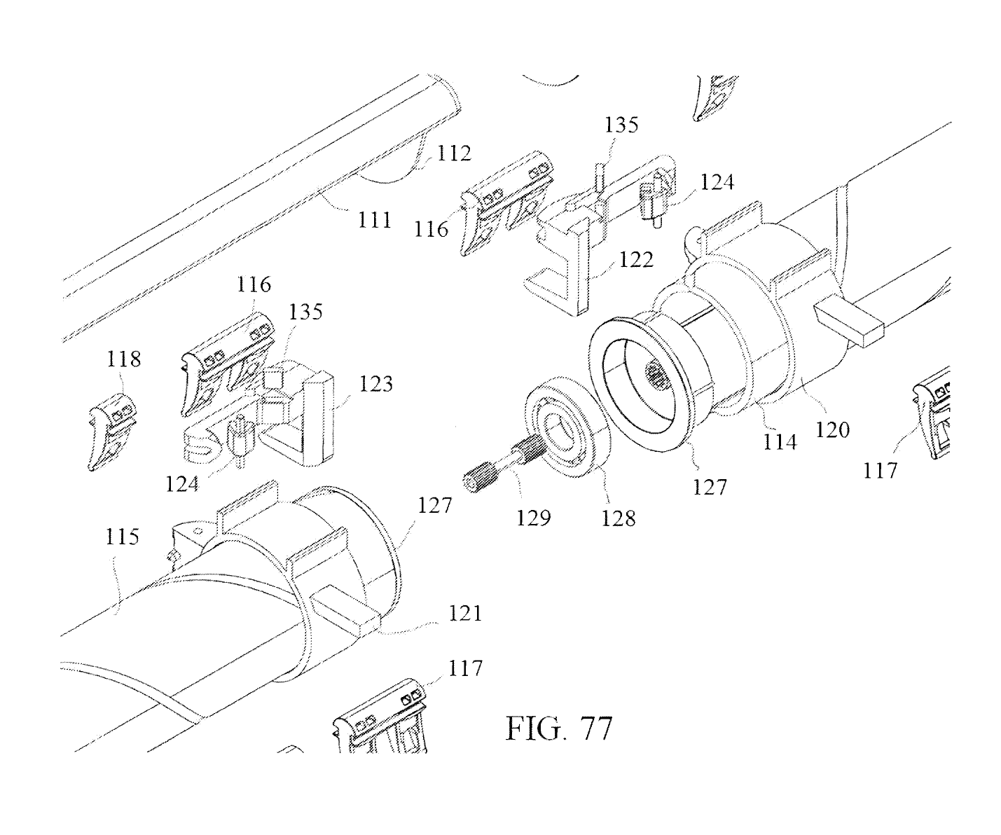

A system having two horizontal moving curtains or draperies made from dissimilar materials can display each of the two curtains individually, using a common drive system. The drive system can be operated manually by, for example, a pull cord or a draw rod, and can be motorized. In the embodiment, shown in FIGS. 64-77, the horizontal movement of the curtain or drapery is accomplished by one or more grooves, such as one or more helical grooves, formed on the outer surface of a rotating element, such as a roll shade tube, to move the curtain or drapery horizontally when the tube rotates. The drive element can also utilize a sleeve over a tube, such that the sleeve has the one or more grooves and rotating the tube rotates the sleeve. The sleeve and tube can be the same material or different materials. A sleeve made of non-metallic material over a metallic tube can provide the strength of a metallic tube with a low friction non-metallic surface of the sleeve material to interconnect with the attachment elements. The curtains or draperies (such as sheer and blackout curtains or draperies) are suspended by loosely fitting attachment elements that freely traverse longitudinally along the tube with a protrusion or protrusions on the inside of the drive element fitted into the helical grooves in the rotating element. The remaining attachment elements are loose fitting where the curtain materials can be moved independently (freely) along the tube to cover or uncover the opening as needed. This drive system can be used on shade systems referred to as a single set of shades, where a single set of shades traverse the same tube and can be stored to the right or the left of the opening. This drive system can also be used on a center opening set of shade systems, where the left hand and right hand sets of shades open from the middle of the opening and the shades are stored to either side of the opening when the shades are open.

In describing this embodiment, the terms draperies, curtains, and shades are used interchangeably. The drive mechanism for the two draperies can be linked together such that a common drive system can move each curtain individually and/or together. The shades can be moved by rotating the drive element, which in the embodiment shown in FIGS. 62-77, is a tube. The tube can be motorized so that a motor drives the tube. The system can be designed such that the tube can be manually rotating the drive element. Specific embodiments can allow both manual and motorized driving of the tube.

A magnetic attachment mechanism can be incorporated such that one shade can be manually moved by disconnecting a magnet from the drive element. The system can be designed such that the magnet of the magnetic attachment mechanism is automatically engaged when the magnets are moved slowly enough when the magnets are proximate to each other, and when the magnets are moved rapidly with respect to each other when the magnets are proximate to each other the magnets will not engage. The proximity of magnet 124 and magnet 135, and their orientation with respect to each other are the primary factors as to whether or not the magnets engage each other so as to couple the outer driver and inner driver. The speed of passing is also a factor. Magnet 124 is allowed to pivot about an axis while magnet 135 is held relatively stationary at some pre-determined angle. When the opposite poles of the magnets are proximate, they engage. As the pivoting magnet is moved past the relatively stationary magnet, the opposite poles are force passed each other (by virtue of the relatively stationary magnet being pushed into the “cup” mechanism, and the pivoting magnet continuing its linear travel along the rotating element's rotational axis. As the edges of the magnets pass each other, they suddenly repel each other. The pivoting magnet then turns its other pole toward the stationary magnet. When the magnets are in this configuration and the movement is reverse, they maintain this repelled state until the pivoting magnet reaches a position where the edges of the magnets again align. In this scenario, the proximity is very much larger than when the magnets repelled. Thus, the system has been “re-set” and is prepared to engage the magnets again.

The outer driver can either drive away and not stop, or drive away, stop, return to some intermediate position and pick up the inner driver, and then drive away. This intermediate position can be defined in the software, and can be set by the user. This intermediate position is where the magnets are proximate to the point that the force between them can move the inner driver out of the cup.

The magnets maintain a repelling force while the swivel magnet is moving to the open position. Speed is still a factor, but in specific embodiments, speed is not the only factor as to whether the out driver couple sot the inner driver. The magnets are switching between a repelling state and an attracting state by using the magnetic field between poles (around the edges of the physical magnet) to pivot the swivel magnet in and out of attraction.

The automatic engagement allows both draperies to be moved as one of the shades to be moved manually with a rod or the shade, and once the movement is complete, the motor can rotate the drive element or the drapery drive tube can be manually rotated with a draw cord. In an embodiment, both draperies can be moved as appropriate via the motor, and can be moved together with the motor, and one of the draperies can be moved by the motor or by hand. A specific embodiment can allow the sheer drapery to be manually moved by conventional mechanism, such as with a rod or by hand, where the sheer drapery can be slid along the track much like with a conventional curtain rod.

In an embodiment, by allowing different curtains to be moved by the same drive element, two curtains, such as a sheer drapery and a blackout drapery, can be operated such that neither are covering the window, the sheer drapery is covering the window, or both the sheer drapery and the blackout drapery are covering the window. This can be reversed if the sheer and the blackout draperies are reversed. In an embodiment, the sheer drapery can be translucent and the blackout drapery can be opaque.

One or more grooves, such as helical grooves, that intercoupled with the attachment elements that are driven by the one or more grooves to move the draperies can be formed into the drapery or drive element or formed into a sleeve that is positioned over the drive element. Both clockwise and counter clockwise grooves can be formed into the same drive element or sleeve.

In a preferred embodiment, all drive components, controls, and the power source can be internal to the drapery tube or drive element. Storing the drive components, the controls, and the power supply internal to the support tube can efficiently utilize the space required for a motorized shade, can reduce or eliminate the need for belt and track assemblies used in current technology, and can also eliminate the need for a motor mounting on one end of the shade assembly.

The drapery system can incorporate one or more guide tracks for one or both of the two draperies, where both draperies are driven by a common driver.

Specific embodiments employ the drive system with a center opening shade system, where the single sets of shades meet in the middle of the opening. The black-out shades can compress the stored sheer shades and overlap with the sheer shades such that no space between the shades is visible and the system does not allow light to show through into the room.

The design of the system can allow a simple cut-down ability, by, for example, removing an end cap and cutting the drapery tube. The ability to easily cut down the length of the tube allows the system to fit into narrower windows.

Embodiments can prevent a gap in the center of the window with an open center system using dual tubes sets of shades. In an embodiment, center opening sets of shades can have a motorized drive element and one motor, where movement of the curtains on the drive element in opposite directions (e.g., left to right and right to left) can be accomplished by having grooves having opposite handed rotation (e.g., right vs. left, or clockwise vs. counter clockwise) on the drive element and rotating the motor in the same direction. In a specific embodiment, the motorized drive element or sleeve can have double formed helixes in both the clockwise and counterclockwise direction. In a specific embodiment, clockwise grooves on the portion of the drive element on one side of center and counterclockwise grooves on the drive element on the other side of center can be used to move the curtain on one side of center in a first direction and the curtain on the other side of center in the opposite direction of rotation of the drive element. The drive element can then be rotated in the opposite direction to move the curtains in the opposite direction. Again, an embodiment can have one motor, one controller, and one power supply to drive the drive element on both sides of center. When the same portion of the drive element has both clockwise and counter clockwise grooves, the drive element can be used on either side of center and can, therefore, reduce the need to keep two types of drive element in stock and to keep same organized. Further, such drive elements with two clockwise and counterclockwise grooves can be used for right hand, left hand, and/or center opening shade systems, by selection of the appropriate drive and lead attachment elements.

Referring to FIGS. 64-67 the motorized assembly can be powered by a battery pack internal to the drive elements 114 and 115, a battery tube 101 attached to an end bracket, a battery tube 101 attached to the wall of a structure with a bracket 106, or a battery tube 101 attached somewhere else. There can also be a low voltage transformer supplying power to the outer draperies as known in the art. The draperies are hung from the outer drapery clips 119, which are positioned and moved in the cover track 111, track 111i, and the inner draperies are hung from the inner drapery clips 118 which are positioned and moved in the cover track 111 track 111o. There are also outer driven clips 117 driven along the track 111i by the outer driver 120 and inner driven clips 116 driven along the track 111o.

Although a center open track assembly is shown in FIGS. 64-69 and 78-77, the right hand side of the assembly shown in FIGS. 64-69 and 76-77 can be for a right hand drapery and the left hand side of the assembly shown in FIGS. 64-65 and 76-77 can be for a right hand drapery, within the intent of this disclosure.

The drapery assembly can be mounted over an opening with brackets as shown, or via a variety of methods, as known in the art.

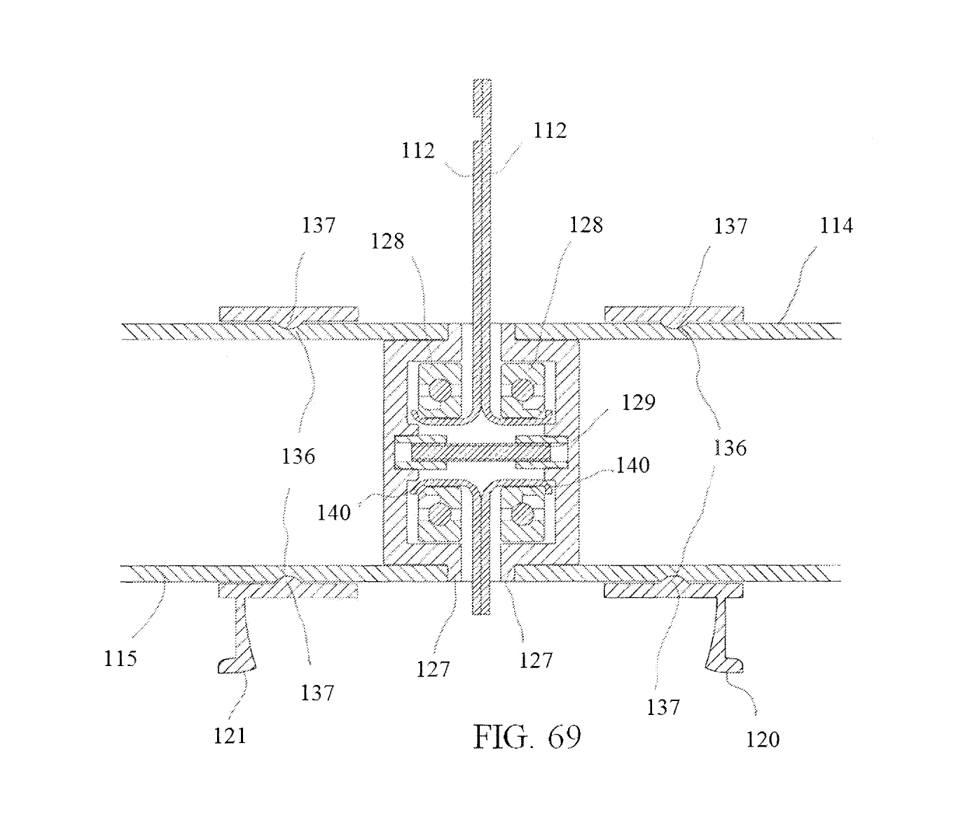

Referring to FIG. 69, the end of each drive element ending in the middle is shown. This end can be opposite the motor or end bearing assembly 139. In a preferred embodiment, tubes 114, 115 have a keyed insert 127 into which a bearing 128 fits. The bearings are permanently mounted on the end plates 112 on an extruded hole 140. The bearing allows tubes 114, 115 to rotate with minimal friction. A drive gears and shaft assembly 129 connects each keyed insert 127 to the other, through the center of the extruded hole 140 on the end brackets 112. In this way, rotation of one of the tubes 114, 115 will cause the rotation of the other tube 114, 115.

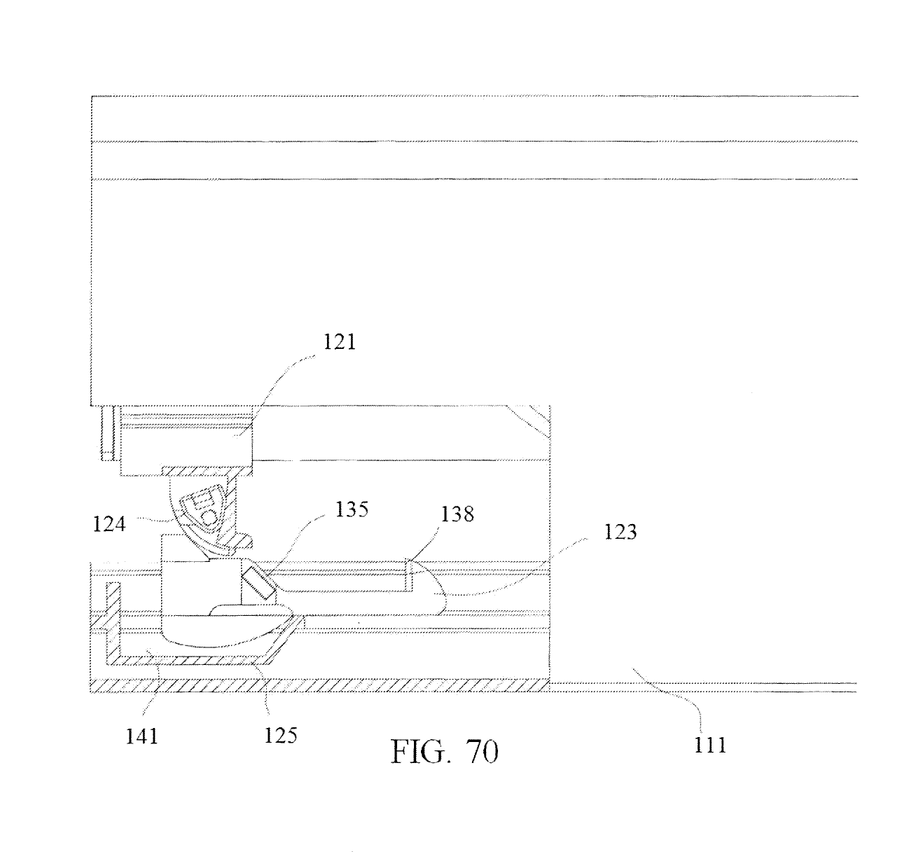

Referring to FIGS. 70-74, which show a top view of the inner curtain driver 22 with a portion of the cover track 11 cut away, the inner drivers 122 and 123, outer drivers 120 and 121, and inner driver cups 125 and 126 all work together to connect and disconnect the outer drapery from the inner drapery. Such connection and disconnection utilizes magnets and control of their relative orientation, and location, and movement of the outer drivers either below a critical speed or above the critical speed during a certain portion of the connecting and disconnecting process. The outer drivers 120 and 121 have a small pivoting magnet 124 that works with a corresponding inner driver 122 and 123 that has a stationary magnet 135. When connected, magnet 124 and magnet 135 face each other with opposite poles.

As the outer drivers 120, 121 drive toward the center of the assembly (end brackets 112), the inner driver 122, 123 is pushed along until it reaches a cut-out 141 in the guide extrusion. Within the cut-out 141 sits the inner driver cups 125 and 126. The outer drivers 120 and 121 press the inner drivers 122, 123 against the protruding leg of the inner driver 122 and 123, and the force of the outer drivers 120 and 121 push the inner drivers 122 and 123 into the cups 125 or 126. The magnets 124 and 135 are sheared apart during this movement. The outer driver 120 or 121 then continues to move with respect to the inner driver 122 or 123, and the pivoting magnet is repelled by the inner driver's magnet 135 (see FIG. 70).

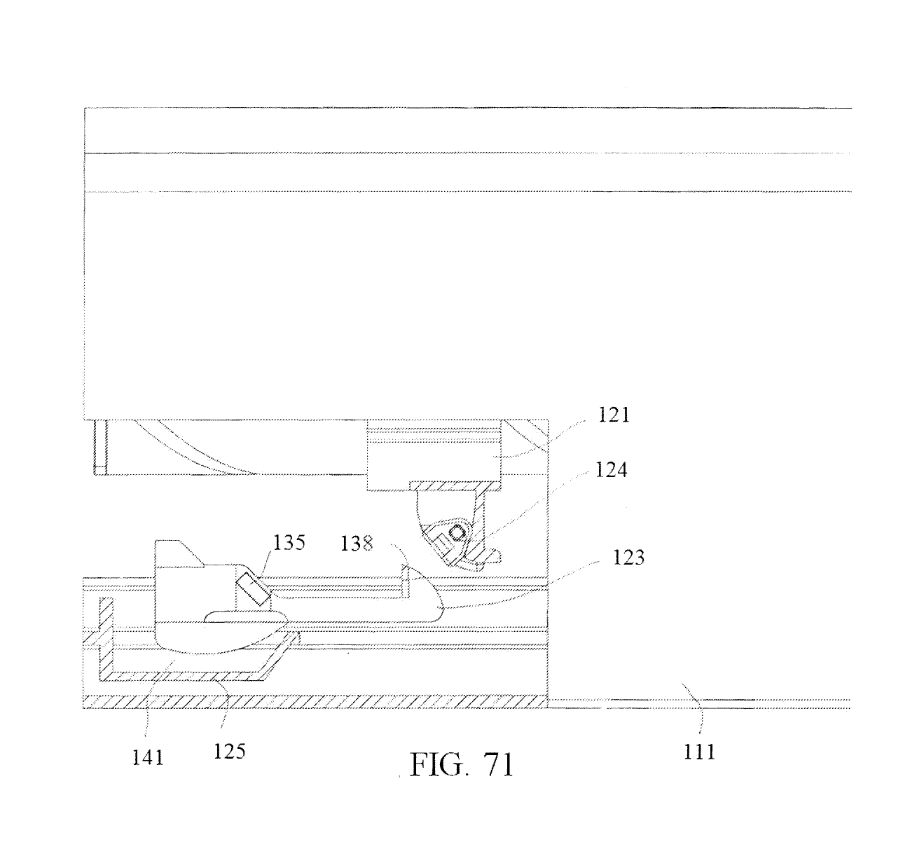

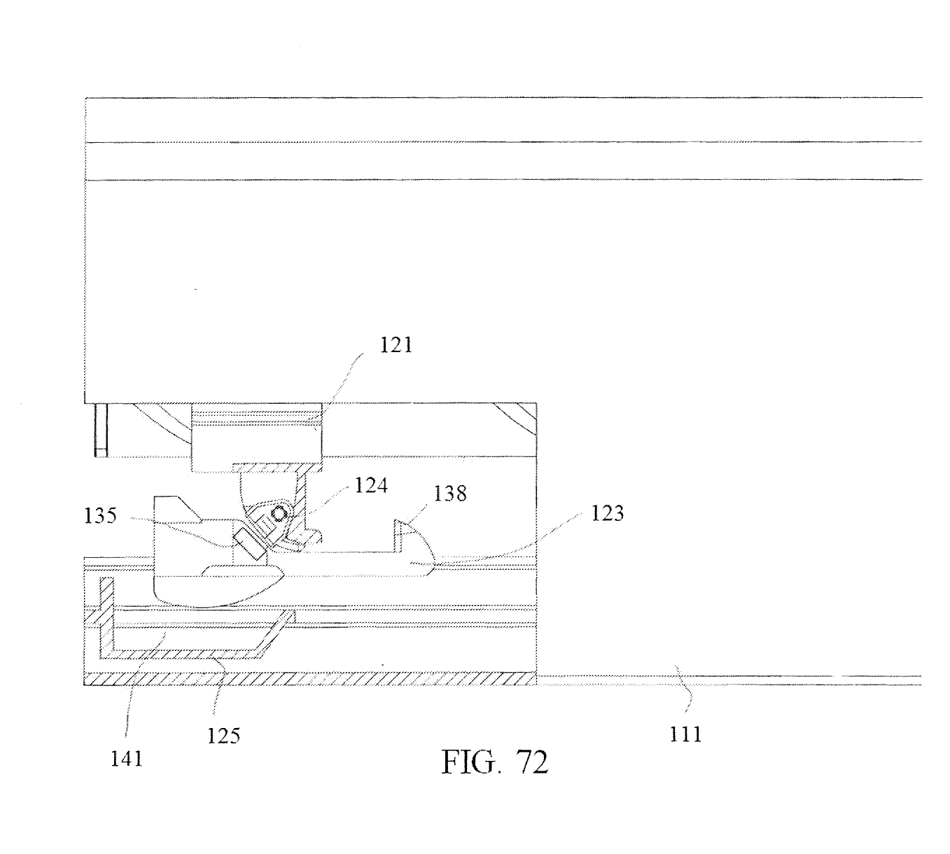

In this state, the outer driver 120 or 121 can either drive away quickly (above a critical speed and the magnets being in a repelling state) and leave the inner driver 122 or 123 behind (see FIG. 71), or drive back slowly (below a critical speed and the magnets being in an attraction state) and pick up the inner driver 122, 123 allowing the magnets 124 and 135 to align and attach (see FIG. 72). The magnets 124 and 135 will re-align depending on the speed with which the outer driver 120 or 121 moves with respect to the inner driver 122 or 123 and which relative orientation of the magnets are in.

In the embodiment shown in FIGS. 64-77, when the outer drapery is in the open position and the inner drapery is left closed, the inner drapery is free to be operated manually.

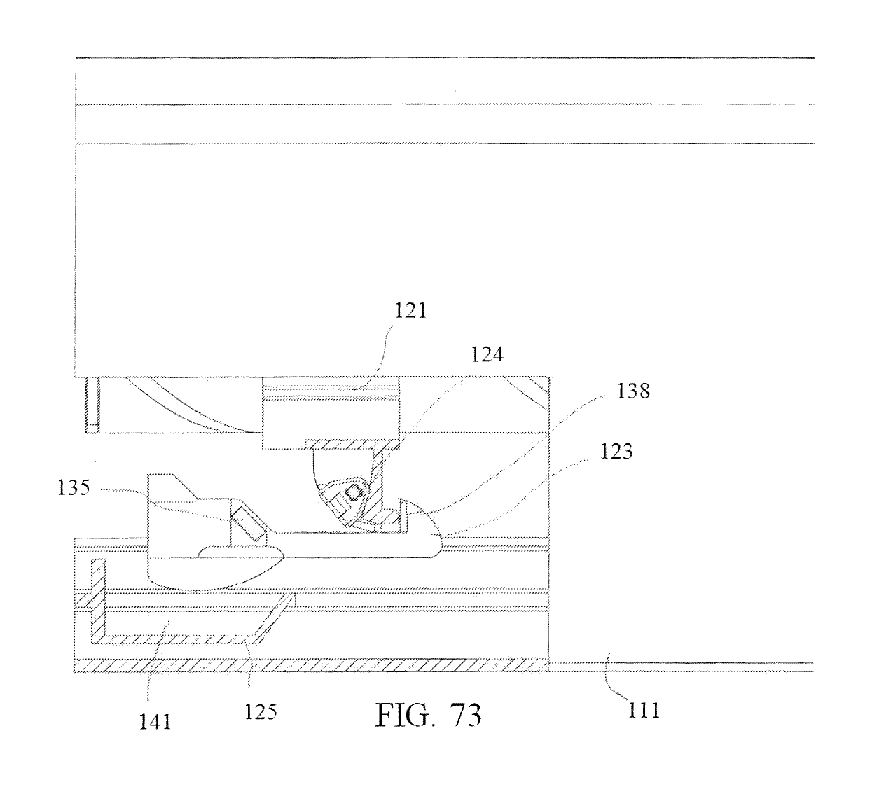

Magnets 124 and 135 are sufficiently weak such that as soon as the magnets start pulling the inner drapery to open, the force overcomes the magnetic attraction of the magnets, disengaging magnet 124 from magnet 135, such that the outer driver 120 or 121 slides forward a small distance and engages the inner driver hook 138 moving the inner driver 122 or 123 to travel the rest of the distance to open the inside drapery (see FIG. 73).

At the point when the user wants only the inner curtain closed, both the inner and outer curtains are moved back towards the center and the position where the curtains are fully closed and hard stopped (see FIG. 70). In this position the two magnets 124 and 135 are mechanically separated with the inner driver 122 or 123 pushed into the cutout in the track 141 and in the cup 125 or 126 with the swivel magnet 124 turned approximately 180 degrees from the stationary magnet 135. Also, in this position, as the inner driver 122 or 123 with the hook 138 and stationary magnet 135 are pushed into a plastic cup 125 or 126, the inner driver 122, 123 is shifted out of the pathway of the outer driver 120 or 121 that is holding the swiveling magnet 124. Accordingly, when it is desired to return the outer curtain to the open position and leave the inner curtain closed, the outer driver 120 or 121, which is attached to the outside curtain, can be moved fast enough with respect to the inner driver 122, 123 that the swiveling magnet 124 does not have enough time to attract the inner driver 122 or 123 with the stationary magnet 135, and, consequently, the magnet 124 and the magnet 135 does not get attached and the inner curtain is left behind in the closed position.

In another specific embodiment, the structure of the assembly shown in FIGS. 64-77 can be reconfigured such that the outer curtain is left in the closed position when the inner curtain driver is moved at a speed above the critical speed past the outer curtain driver to open the inner curtain and leave the outer curtain in the closed position. Such a modification can be applied to center open, right open, and left open curtain systems. Such an embodiment can have a sheer curtain as the outer curtain and a blackout curtain as the inner curtain, or other pairs of curtains, as known in the art. Having the sheer curtain as the outer curtain can allow the curtain system to take up less space, e.g. protrude away from the window a smaller distance, and also allow the sheer curtain to close with the blackout curtain and allow the blackout curtain to be closed with the sheer open.

The features described herein and the features illustrated in FIGS. 64-77 can be used to create one or more of the following:

A system for the horizontal movement of at least one set of at least two vertical curtains or draperies that have a common drive element driven by the rotation of a helix in the outer surface of a rotatable tube applying a horizontal movement force on at least one drive element attached to the drapery and guided by at least one guide rail, where there are at least one drive attachment element and magnets are used to select the draperies to move.

A system horizontal movement of at least one set of vertical curtains or draperies, where the drive element is a rod.

A system horizontal movement of at least one set of vertical curtains or draperies, where the drive element is a tube.

A system horizontal movement of at least one set of vertical curtains or draperies, where the drive element is motorized.

A horizontal moving set of curtains or draperies made from dissimilar materials and can be operated individually with a common rotating drive system.

A system for the horizontal movement of at least one set of vertical curtains or draperies, where the drive section of the rotational drive element has at least one helix formed into the outer surface.

A system of motorized horizontal movement of at least one set of vertical curtains or draperies, where the motorized unit is battery powered and has a wireless receiver on the control board.

A system for the horizontal movement of at least one set of vertical curtains or draperies, where a manual operation is provided with a pull cord that rotates the rotatable drive member.

A system of motorized horizontal movement of at least one set of vertical curtains or draperies, where the motor is positioned internal to the drive tube.

A system of motorized horizontal movement of at least one set of vertical curtains or draperies, where the power supply is positioned internal to the drive tube.

A system for the horizontal movement of at least two sets of vertical curtains or draperies by the rotation of a helix in the outer surface of a rotatable drive element applying a movement force on a toothed drive attachment element for moving the draperies, where there are at least one drive attachment element and multiple non-driving attachment elements that are guided by at least one guide rail and suspend the draperies.

A system for the horizontal movement of at least two sets of vertical curtains or draperies by the rotation of a pitch thread mentioned above where there are at least two pitch threads, one being formed clockwise and one being formed counter clockwise and the drive tooth in the drive attachment element and the lead attachment element is angled to maintain engagement with the drive tube.

A system of motorized horizontal movement of at least two vertical curtains or draperies, positioned on different portions of the drive element, by the rotation of a pitch threads, where a single motor moves curtains on a first portion of the drive element and curtains on a second portion of the drive element in opposite directions.

A system of motorized horizontal movement of at least two vertical curtains or draperies by the rotation of a tube with a formed pitched thread, where a power supply can be external to the tube and enters through at least one of the support shafts.

Aspects of the invention, such as controlling the motor, may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like may be included in or part of the motor controller. Any number of computer-systems and computer networks are acceptable for use with the present invention.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media.

Computer-readable media include both volatile and nonvolatile media, transient and non-transient media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, information-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

### REFERENCE NUMBERS

1 dual curtain assembly
3 outer driver carrier attachment post
4b first inner drive tooth
4a second inner drive tooth
5a first outer drive tooth
5b second outer drive tooth
6 outer carrier attachment post
7 motor control circuit board
9 inner drive element
10 drive element
11 support guide
12 outer curtain carrier track
13 rubber mounting disk
14 pin hook
15 inner driver stall area
17 S hooks
18 axles
20 curtain assembly
21 batteries
22 drive element
23 right outer curtain drive attachment element
24 helical guide structure
25 right inner curtain drive element
26 outer surface
27 motor drive adapter
28 slip ring
29 inter-curtain engager catch
30 pull cord
31 inner carrier attachment post
32 motor assembly
33 rotation assembly
34 window
35 motor end
36 driver attachment element
36A outer driver attachment element
36B inner driver attachment element
37 loop
38 clockwise helical groove
39 Loop
40 counter clockwise helical groove
42 Center
43 external power supply
44A outer curtain
44B inner curtain
45 wall bracket
46 center closing curtain
47 battery sleeve
48 left panel
49 intercurtain engager
50 right panel
51 end cap
52 Axles
53 motor housing
54 end brackets
55 aperture
56 outer diameter
57 bearing housing
58 motor end
59 bearings end
60 longitudinal axis
61 inner tube
62 driver tooth
63 sleeve/outer tube
64 non-driven end
65 fractal antenna
66 driven end
67 idler attachment element
67A outer curtain idler attachment element
68 attachment point
69 outer curtain carrier
70 draw rod
71 outer tooth drive
72 pull cord
73 inner tooth drive
74 left driver attachment element
75 o-ring
76 right driver attachment element
77 outer drive tube
78 left draw rod
80 right draw rod
81 inner curtain carrier track
82 motor
84 batteries
86 battery tube
87 motor output shaft
88 first lead tooth
90 second lead tooth
91 ball bearing
92 motor drive adapter
93 inner curtain carrier
94 bearings
95 finial
96 remote control
97 receiver for draw rod
98 button
99 receiver for hook
100 outer driver stall area
101 battery tube
102 battery
103 spring
104 battery tube end cap
105 o-ring
106 battery tube wall bracket
107 battery tube connector cap
108 s-hook
109 mounting bracket
110 bracket clip
111 cover track
112 track end plates
113 fasteners
114 tube CW
115 tube CCW
116 inner driver hanger clip
117 outer driver hanger clip
118 inner hanger clips
119 outer drapery clips
120 outer driver CW
121 outer driver CCW
122 inner driver w/magnet CW
123 inner driver w/magnet CCW
124 swivel magnet
125 inner driver cup CW
126 inner driver cup CCW
127 tube cap center bearing
128 center bearing
129 drive gears and shaft assembly
130 drive shafts
131 drive shaft retainers
132 end tube bearing housings
133 antenna assembly
134 end tube caps
135 stationary magnet
136 groove in tube
137 driver protrusion
138 inner driver hook
139 end bearing assembly
140 end plate extruded hole
141 cutout in track
150 inward idler attachment element
152 baton
154 outer ring
156 collar
157 accelerometer

What is claimed is:

1. A window covering assembly, comprising:
a drive element;
the drive element extending a length between a first end and a second end;
the drive element having an exterior surface;
the exterior surface having a guide structure;
a first drive attachment element operatively connected to the drive element and in communication with the guide structure;
a motor operatively connected to the drive element;
a sensor operatively connected to the drive element and the motor;
wherein when the sensor detects a disturbance the motor is activated; and
wherein when motor is activated the drive element is rotated and the first drive attachment element is driven along a length of the drive element.

2. The window covering assembly of claim 1 wherein the motor is positioned within the drive element.

3. The window covering assembly of claim 1 wherein the sensor is an accelerometer.

4. The window covering assembly of claim 1 wherein the sensor is selected from the group consisting of a sound detector, a vibration sensor, a strain sensor, a stress sensors, a length detector, a gyroscope, a load sensor and a motion sensor.

5. The window covering assembly of claim 1 wherein the disturbance is a vibration.

6. The window covering assembly of claim 1 further comprising a curtain connected to the drive element such that when the drive element is rotated the curtain is moved along a length of the drive element.

7. The window covering assembly of claim 1 wherein the sensor is tuned to detect a disturbance above a predetermined threshold.

8. The window covering assembly of claim 1 wherein the sensor is tuned to detect a disturbance within a predetermined frequency range.

9. The window covering assembly of claim 1 wherein the disturbance is generated from a tug on a curtain connected to the drive element or a baton connected to the drive element.

10. The window covering assembly of claim 1 wherein the disturbance is generated from a tap on the drive element.

11. The window covering assembly of claim 1 wherein the disturbance is generated from one or more idler attachment elements sliding a distance on the drive element.

12. The window covering assembly of claim 1 wherein when the sensor activates the motor, the motor drives in an opposite direction to a direction of a last movement.

13. The window covering assembly of claim 1 wherein the guide structure is a helical guide structure and the drive attachment element includes at least one tooth in communication with the helical guide structure.

14. A window covering assembly comprising:
a drive element extending a length;
the drive element having a guide structure;
a first drive attachment element connected to the drive element;
a curtain connected to the drive element;
a motor operatively connected to the drive element;
a motor controller operatively connected to the motor;
a sensor operatively connected to the motor controller;
wherein when the sensor detects a disturbance within predetermined parameters the sensor transmits a signal to the motor controller; and
wherein the motor controller activates the motor in response to receiving a signal from the sensor and the motor rotates the drive element thereby moving the curtain across a length of the drive element.

15. The window covering assembly of claim 14 wherein the disturbance is a tug on the curtain or a baton connected to drive element, a slide of an idler attachment element connected to the drive element or a tap on the drive element.

16. The window covering assembly of claim 14 wherein the sensor is an accelerometer.

17. A method of operating a window covering assembly comprising the steps of:
providing a drive element extending a length from a first end to a second end and having a guide structure;
connecting a first drive attachment element to the drive element;
connecting a motor to the drive element;
connecting a motor controller to the motor;
connecting a sensor to the drive element;
detecting a disturbance by the sensor;
transmitting a signal by the sensor to the motor controller in response to detecting a disturbance;
activating the motor by the motor controller in response to detecting a disturbance by the sensor; and
rotating the drive element in a direction opposite a direction of a last movement of the drive element.

18. The method of operating a window covering assembly of claim 17 further comprising the steps of;
connecting a curtain to the drive element; and
moving the curtain along a length of the drive element when the drive element rotates.

19. The method of operating a window covering assembly of claim 17 further comprising the step of: generating the disturbance by tugging on a curtain connected to the drive element or tugging on a baton connected to the drive element.

20. The method of operating a window covering assembly of claim 17 further comprising the step of: generating the disturbance by the drive element.

21. The method of operating a window covering assembly of claim 17 further comprising the step of: generating the disturbance by sliding an idler attachment element connected to the drive element along a length of the drive element.

22. The method of operating a window covering assembly of claim 17 further comprising the step of comparing the disturbance with predetermined parameters.

23. The method of operating a window covering assembly of claim 17 further comprising the step of tuning the sensor to detect disturbances above a predetermined threshold.

24. The window covering assembly of claim 17 wherein the sensor is an accelerometer.

25. A window covering assembly, comprising:
a drive element extending a length between a first end and a second end;
an accelerometer connected to the drive element;
a motor connected to the drive element;
a guide structure connected to or positioned in the drive element;
a plurality of attachment elements positioned around the drive element;
a curtain connected to the plurality of attachment elements; and
wherein when a vibration is detected by the accelerometer the motor is activated which rotates the drive element thereby opening or closing the curtain.
